(19) United States
(12) Patent Application Publication
(10) Pub. No.: US 2009/0076840 A1
(43) Pub. Date: Mar. 19, 2009

(54) Wireless ICU

(76) Inventors: Edward S. Boyden, Cambridge, MA (US); Roderick A. Hyde, Redmond, WA (US); Muriel Y. Ishikawa, Livermore, CA (US); Eric C. Leuthardt, St. Louis, MO (US); Royce A. Levien, Lexington, MA (US); Robert W. Lord, Seattle, WA (US); Cameron A. Myhrvold, Medina, WA (US); Nathan P. Myhrvold, Medina, WA (US); Dennis J. Rivet, Portsmouth, VA (US); Michael A. Smith, Phoenix, AZ (US); Clarence T. Tegreene, Bellevue, WA (US); Thomas A. Weaver, San Mateo, CA (US); Lowell L. Wood, JR., Bellevue, WA (US); Victoria Y.H. Wood, Livermore, CA (US)

Correspondence Address: VIKSINS HARRIS & PADYS PLLP, P.O. BOX 111098, ST. PAUL, MN, 55111-1098, US

(21) Appl. No.: 11/901,732

(22) Filed: Sep. 18, 2007

(51) Int. Cl. G06Q 50/00

(52) U.S. Cl. 705/2

(57) ABSTRACT

A method may include receiving information from two or more wireless sensors and identifying patient identification information included in the information.

### FIELD

The subject matter is related to sensing, receiving, transmitting, and processing information wirelessly.

### BACKGROUND

Information processing environments, such as hospitals, include information acquisition and processing systems that require numerous cables and wires for acquiring, transmitting, and processing information. Cables and wires can interfere with the primary function of the environment. For example, in hospitals, cables and wires attached to patients may interfere with caring for the patients. The wires may interfere with hospital staff efforts to move patients. Patients may find the cables and wires uncomfortable and often remove them prematurely. The additional work of attaching and removing wires and cables from patients sometimes slows the delivery and increases the cost of providing medical services. For these and other reasons apparatuses and methods for managing information without wires and cables may prove useful.

### SUMMARY

In one aspect, a method includes but is not limited to receiving information from two or more wireless sensors and identifying patient identification information included in the information. In addition to the foregoing, other method aspects are described in the claims, drawings, and text forming a part of the present disclosure.

In one aspect, a method includes but is not limited to associating two or more wireless sensors with a patient; sensing physiological information with one or more of the two or more wireless sensors; and transmitting the physiological information. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware configured to effect the herein referenced method aspects depending upon the design choices of the system designer.

In one aspect, an apparatus includes but is not limited to hardware/software/firmware for associating two or more wireless sensors with a patient, hardware/software/firmware for sensing physiological information with one or more of the two or more wireless sensors, and hardware/software/firmware for transmitting the physiological information. In addition to the foregoing, other apparatus aspects are described in the claims, drawings, and text forming a part of the present disclosure.

In one aspect, an apparatus includes but is not limited to: hardware/software/firmware for receiving information from two or more wireless sensors; and hardware/software/firmware for identifying patient identification information included in the information. In addition to the foregoing, other apparatus aspects are described in the claims, drawings, and text forming a part of the present disclosure.

In addition to the foregoing, various other method and/or system and/or program product aspects are set forth and described in the teachings such as text (e.g., claims and/or detailed description) and/or drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE DRAWINGS

FIG. 1(a)(1), FIG. 1(a)(2), FIG. 1(a)(3), FIG. 1(a)(4), FIG. 1(a)(5), and FIG. 1(a)(6) show block diagrams of sensing and processing apparatus in accordance with some embodiments.

FIG. 1(a)(7) shows a block diagram of two or more sensing apparatus in accordance with some embodiments.

FIG. 2(a)(1), FIG. 2(a)(2), FIG. 2(a)(3), FIG. 2(a)(4), FIG. 2(a)(5), FIG. 2(a)(6), FIG. 2(a)(7), and FIG. 2(a)(8) show flow diagrams of methods for transmitting physiological information in accordance with some embodiments.

FIG. 2(a)(9), FIG. 2(a)(10), FIG. 2(a)(11), and FIG. 2(a)(12)(A) and FIG. 2(a)(12)(B) show flow diagrams of methods for transmitting patient information in accordance with some embodiments.

FIG. 2(a)(13), FIG. 2(a)(14), and FIG. 2(a)(15) show flow diagrams of methods for transmitting location information in accordance with some embodiments.

FIG. 2(a)(16) shows a flow diagram of a method for transmitting sensor information in accordance with some embodiments.

FIG. 3(a)(1) shows a flow diagram of a method for receiving patient information in accordance with some embodiments.

FIG. 3(b)(1), FIG. 3(b)(2), FIG. 3(b)(3), FIG. 3(b)(4), and FIG. 3(b)(5) show flow diagrams of methods for identifying patient information from more than one patient in accordance with some embodiments.

FIG. 3(c)(1), FIG. 3(c)(2), FIG. 3(c)(3), FIG. 3(c)(4), FIG. 3(c)(5), FIG. 3(c)(6), FIG. 3(c)(7), FIG. 3(c)(8), FIG. 3(c)(9), FIG. 3(c)(10), FIG. 3(c)(11), and FIG. 3(c)(12) show flow diagrams of methods for associating physiological information with patient identifying information in accordance with some embodiments.

FIG. 3(d)(1), FIG. 3(d)(2), FIG. 3(d)(3), and FIG. 3(d)(4) show flow diagrams of methods for identifying nurse information in accordance with some embodiments.

FIG. 3(e)(1), FIG. 3(e)(2), FIG. 3(e)(3), and FIG. 3(e)(4) show flow diagrams of methods for identifying security information in accordance with some embodiments.

FIG. 3(f)(1), FIG. 3(f)(2), FIG. 3(f)(3), and FIG. 3(f)(4) show flow diagrams of methods for identifying accounting information in accordance with some embodiments.

FIG. 3(g)(1), FIG. 3(g)(2), FIG. 3(g)(3), FIG. 3(g)(4), FIG. 3(g)(5), FIG. 3(g)(6), FIG. 3(g)(7), FIG. 3(g)(8), FIG. 3(g)(9), FIG. 3(g)(10), FIG. 3(g)(11), FIG. 3(g)(12), FIG. 3(g)(13), FIG. 3(g)(14), FIG. 3(g)(15), FIG. 3(g)(16), FIG. 3(g)(17), FIG. 3(g)(18), FIG. 3(g)(19), FIG. 3(g)(20), FIG. 3(g)(21), and FIG. 3(g)(22) show flow diagrams of methods for identifying location information in accordance with some embodiments.

FIG. 3(h)(1), FIG. 3(h)(2), FIG. 3(h)(3), and FIG. 3(h)(4) show flow diagrams of methods for identifying contact information in accordance with some embodiments.

FIG. 3(i)(1), FIG. 3(i)(2), FIG. 3(i)(3), FIG. 3(i)(4), and FIG. 3(i)(5) show flow diagrams of methods for filtering information in accordance with some embodiments.

FIG. 3(j)(1), FIG. 3(j)(2), and FIG. 3(j)(3) show flow diagrams of methods for receiving patient information in accordance with some embodiments.

FIG. 3(k)(1) and FIG. 3(k)(2) show flow diagrams of methods for receiving hospital information in accordance with some embodiments.

FIG. 3(l)(1), FIG. 3(l)(2), FIG. 3(l)(3), and FIG. 3(l)(4) show flow diagrams of methods for receiving sensor information in accordance with some embodiments.

FIG. 3(m)(1) shows a flow diagram of a method for associating sensors in accordance with some embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments, may be utilized, and other changes may be made, without departing from the spirit or scope of the subject matter presented here.

### Sensing and Processing Apparatus

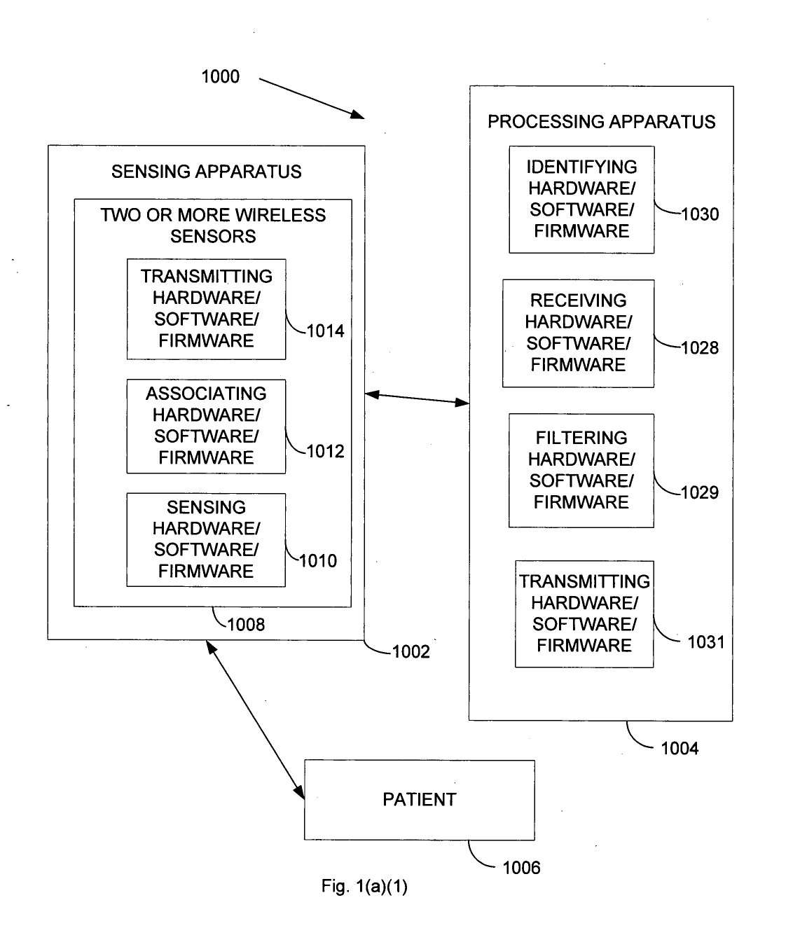

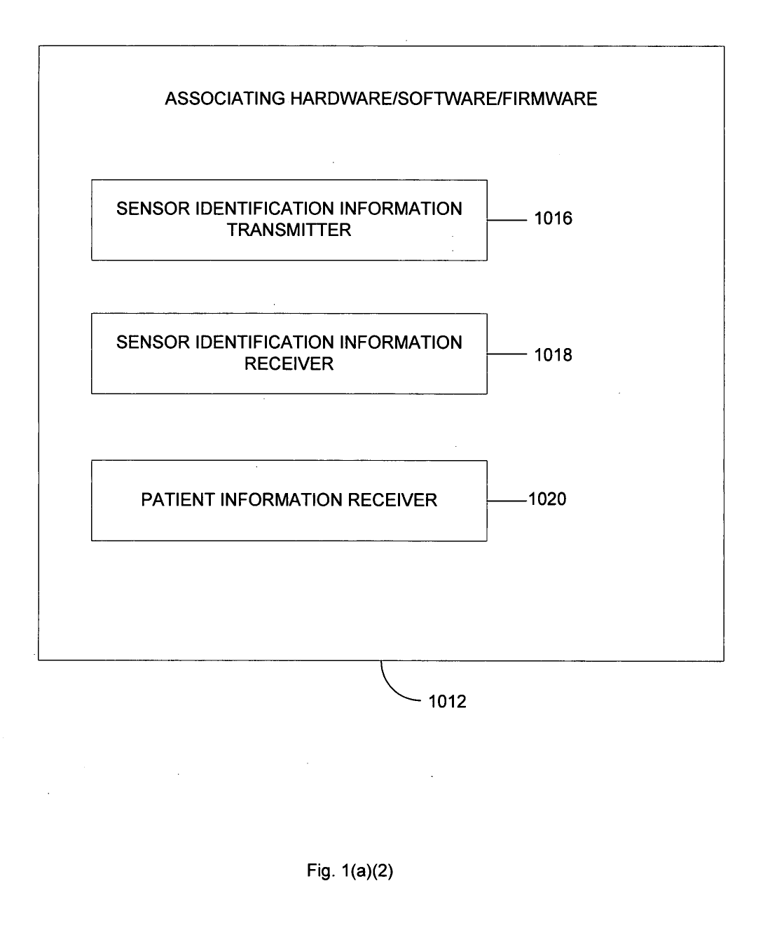

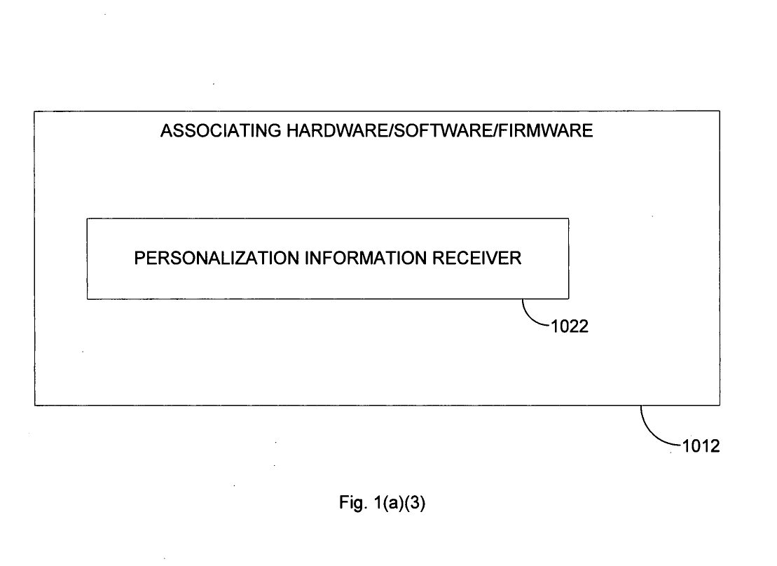

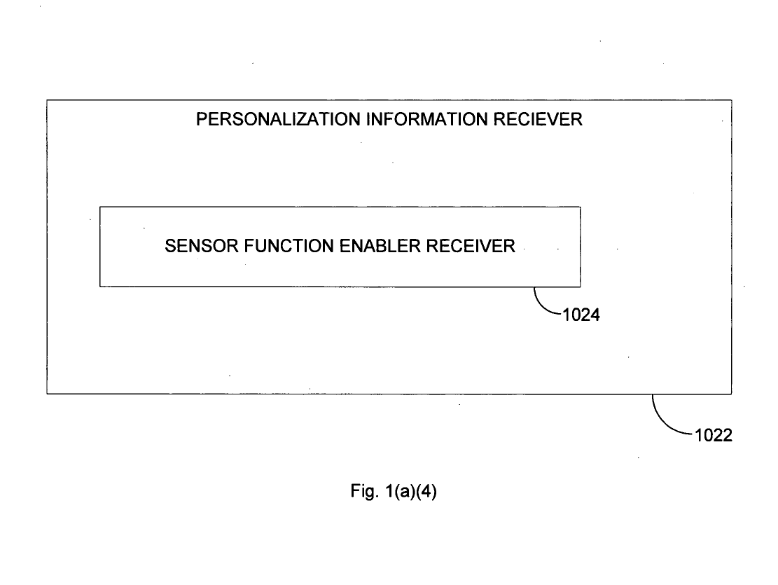

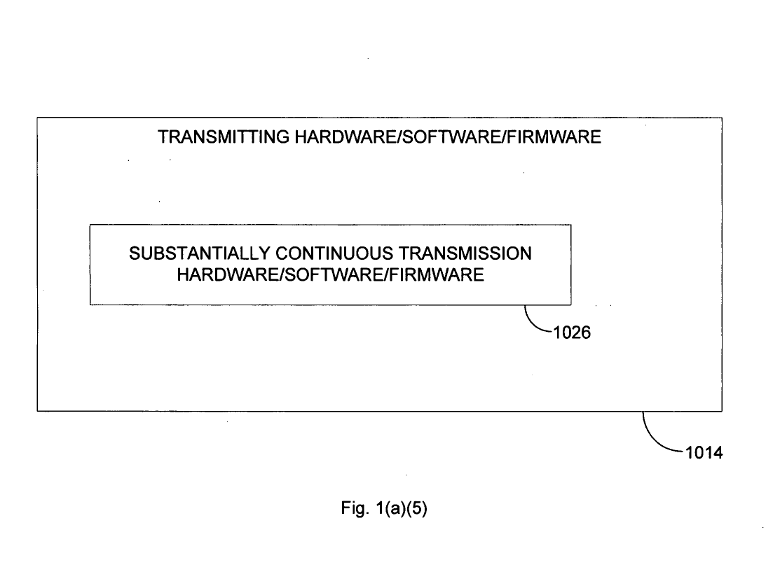

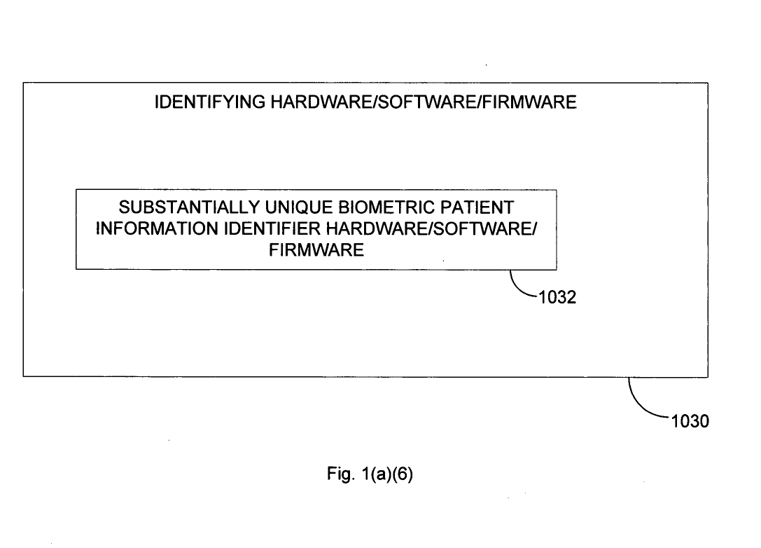

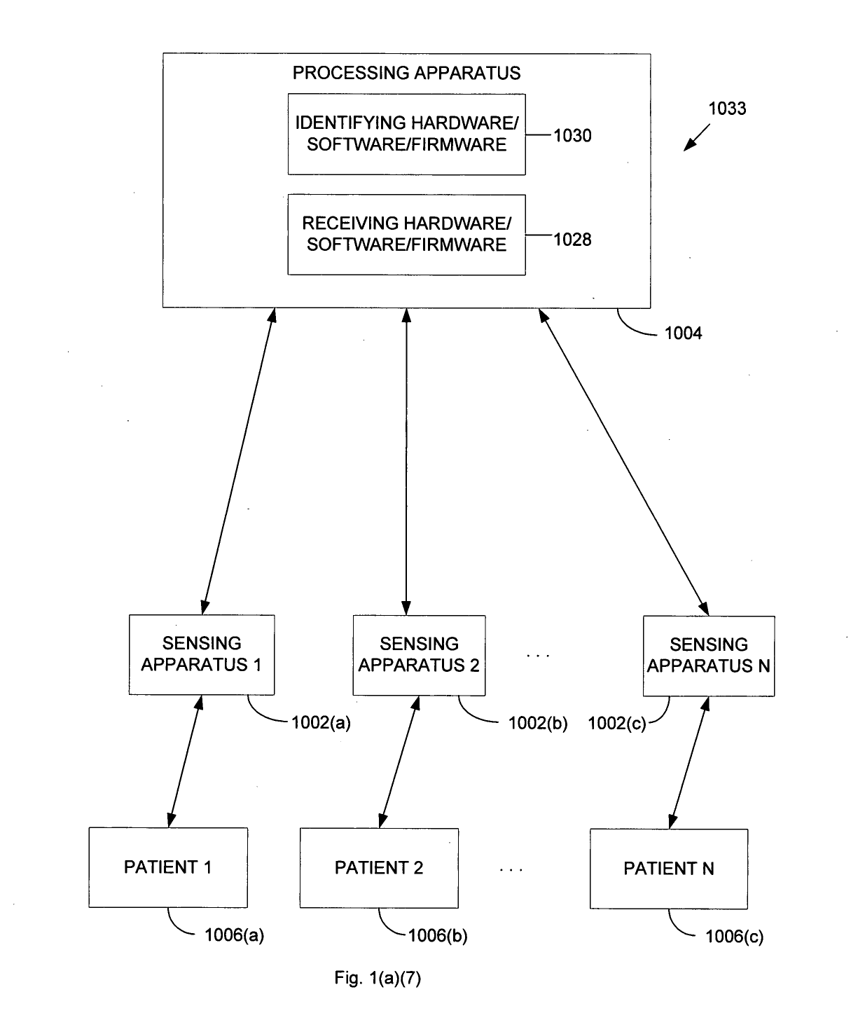

FIG. 1(a)(1) shows a block diagram of an apparatus 1000 including a sensing apparatus 1002 to communicate with a processing apparatus 1004 and a patient 1006 in accordance with some embodiments. The sensing apparatus 1002 provides hardware, software, and/or firmware (hereafter “hardware/software/firmware”) configured to provide sensing information, such as physiological information, at the patient 1006, and to communicate with the processing apparatus 1004. The patient 1006 may include animals such as mammals including humans. Exemplary physiological information sensed by the sensing apparatus 1002 may include hemodynamic information, pulse rate information, blood gas information, and temperature information. In some embodiments, the means for sensing information may include two or more wireless sensors 1008 for sensing the information at the patient 1006. The two or more wireless sensors 1008 can communicate through free space. Free space may include space in which energy can be propagated substantially unimpeded in any direction. For example, the atmosphere of Earth is free space for the transmission of electromagnetic radiation. In some embodiments, the two or more wireless sensors 1008 communicate by transmission of electromagnetic radiation at radio frequencies. In some embodiments, the two or more wireless sensors 1008 communicate through transmission of electromagnetic radiation at optical frequencies. Exemplary sensors suitable for use in connection with the sensing apparatus 1002 may include sensors of hemodynamic information, such as blood pressure sensors, pulse rate sensors, blood gas sensors, such as oxygen sensors or blood oxygen sensors, and temperature sensors.

The two or more wireless sensors 1008 include a sensing hardware, software, and/or firmware (hereinafter “hardware/software/firmware”) 1010, an associating hardware/software/firmware 1012, and a transmitting hardware/software/firmware 1014. The sensing hardware/software/firmware 1010 provides hardware/software/firmware configured to provide sensing physiological information with one or more of the two or more wireless sensors 1008 at the patient 1006. In some embodiments, the sensing hardware/software/firmware 1010 may include a sensor, such as a sensor of hemodynamic information, a pulse rate sensor, a blood gas sensor, and a temperature sensor. A blood pressure sensor is an exemplary sensor of hemodynamic information. An oxygen sensor is an exemplary blood gas sensor. In some embodiments, the transmitting hardware/software/firmware 1014 functions as a transceiver capable of both transmitting and receiving information

The associating hardware/software/firmware 1012 provides hardware/software/firmware configured to provide associating the two or more wireless sensors 1008 with the patient 1006. FIG. 1(a)(2) shows a block diagram of one exemplary embodiment of the associating hardware/software/firmware 1012, shown in FIG. 1(a)(1), in accordance with some embodiments. The associating hardware/software/firmware 1012, as shown in FIG. 1(a)(2), may include a sensor identification information transmitter 1016, a sensor identification information receiver 1018, and a patient information receiver 1020. The sensor identification information transmitter 1016 provides hardware/software/firmware configured to provide transmitting sensor identification information. The sensor identification information receiver 1018 provides hardware/software/firmware configured to provide receiving sensor identification information. The patient information receiver 1020 provides hardware/software/firmware configured to provide receiving patient information.

FIG. 1(a)(3) shows a block diagram of another exemplary embodiment of the associating hardware/software/firmware 1012, shown in FIG. 1(a)(1), in accordance with some embodiments. The associating hardware/software/firmware 1012, as shown in FIG. 1(a)(3), may include a personalization information receiver 1022. The personalization information receiver 1022 provides hardware/software/firmware configured to provide receiving information to personalize the one or more of the two or more wireless sensors 1008.

FIG. 1(a)(4) shows a block diagram of an exemplary embodiment of the personalization information receiver shown in FIG. 1(a)(3). The personalization information receiver hardware/software/firmware 1022 may include a sensor function enabler receiver 1024. The sensor function enabler receiver receives a signal that enables a particular sensor, such as a blood gas sensor, a cardiac sensor, such as a heart rate sensor, a blood gas sensor, such as an oxygen sensor, or a temperature sensor.

Referring again to FIG. 1(a)(1), the transmitting hardware/software/firmware 1014 provides hardware/software/firmware configured to provide transmitting information. In some embodiments, the transmitting hardware/software/firmware 1014 transmits information, such as physiological information, at radio frequencies.

FIG. 1(a)(5) shows a block diagram of the transmitting hardware/software/firmware 1014 in accordance with some embodiments. The transmitting hardware/software/firmware 1014 may include a substantially continuous transmission hardware/software/firmware 1026. The substantially continuous transmission hardware/software/firmware 1026 provides for substantially continuous transmission of information. Substantially continuous transmission of information may include both analog and digital transmission. Further, substantially continuous transmission of information is not limited to a particular transmission rate. Substantially continuous means transmission of information at a rate suitable for the intended use of the information. For example, patient temperature information transmitted at a rate of one measurement per second is sufficient for real time monitoring of a patient's core temperature and is therefore substantially continuous.

Referring again to FIG. 1(a)(1), the apparatus 1000 may include the processing apparatus 1004. The processing apparatus 1004 may include receiving hardware/software/firmware 1028, filtering hardware/software/firmware 1029, identifying hardware/software/firmware 1030, and transmitting hardware/software firmware 1031. The receiving hardware/software/firmware 1028 provides hardware/software/firmware receiving information from the two or more wireless sensors 1008. In some embodiment, the receiving hardware/software/firmware 1028 may include a radio frequency receiver or transceiver. In some embodiments, the receiving hardware/software/firmware 1028 may include an optical receiver or transceiver. A transceiver both transmits and receives information. The transmitting hardware/software/firmware 1031 provides hardware/software/firmware—transmitting information from the processing apparatus 1004. In some embodiments, the transmitting hardware/software/firmware 1031 may include a radio frequency transmitter or transceiver. In some embodiments, the transmitting hardware/software/firmware 1031 may include an optical transmitter or transceiver.

Referring again to FIG. 1(a)(1), the apparatus 1000, may include the filtering hardware/software/firmware 1029. The filtering hardware/software/firmware 1029 provides hardware/software/firmware to pass or reject information, such as information provided by the sensing apparatus 1002.

Referring again to FIG. 1(a)(1), the apparatus 1000 may include the identifying hardware/software/firmware 1030. The identifying hardware/software/firmware 1030 provides hardware/software/firmware identifying patient identification information included in the information.

FIG. 1(a)(6) shows a block diagram of an exemplary embodiment of the identifying hardware/software/firmware 1030, shown in FIG. 1(a)(1), in accordance with some embodiments. The identifying hardware/software/firmware 1030 may include a substantially unique biometric patient information identifying hardware/software/firmware 1032. Exemplary substantially unique biometric patient information may include retina information, fingerprint information, face information, genetic expression information, genetic content information, unique heart rhythm information, unique blood count information, and/or chemistry information, such as provided by laboratory tests on patient tissue or fluids.

### Two or More Sensing Apparatus

FIG. 1(a)(7) shows a block diagram of an apparatus 1033 including a first sensing apparatus 1002(a), such as sensing apparatus 1, to communicate with a first patient 1006(a), such as patient 1, and the processing apparatus 1004 and a second sensing apparatus 1002(b), such as sensing apparatus 2, to communicate with the second patient 1006(b), such as patient 2, and the processing apparatus 104 in accordance with some embodiments. The apparatus 1033 is not limited to a particular number of sensing apparatus or patients. As can be seen in FIG. 1(a)(7), the apparatus 1033 can be extended to any number of sensing apparatus as shown by sensing apparatus number n 1002(c) and any number of patients as show by patient number n 1006(c). To extend the operation, a sensing apparatus can be added for each additional patient.

### Transmitting Physiological Information

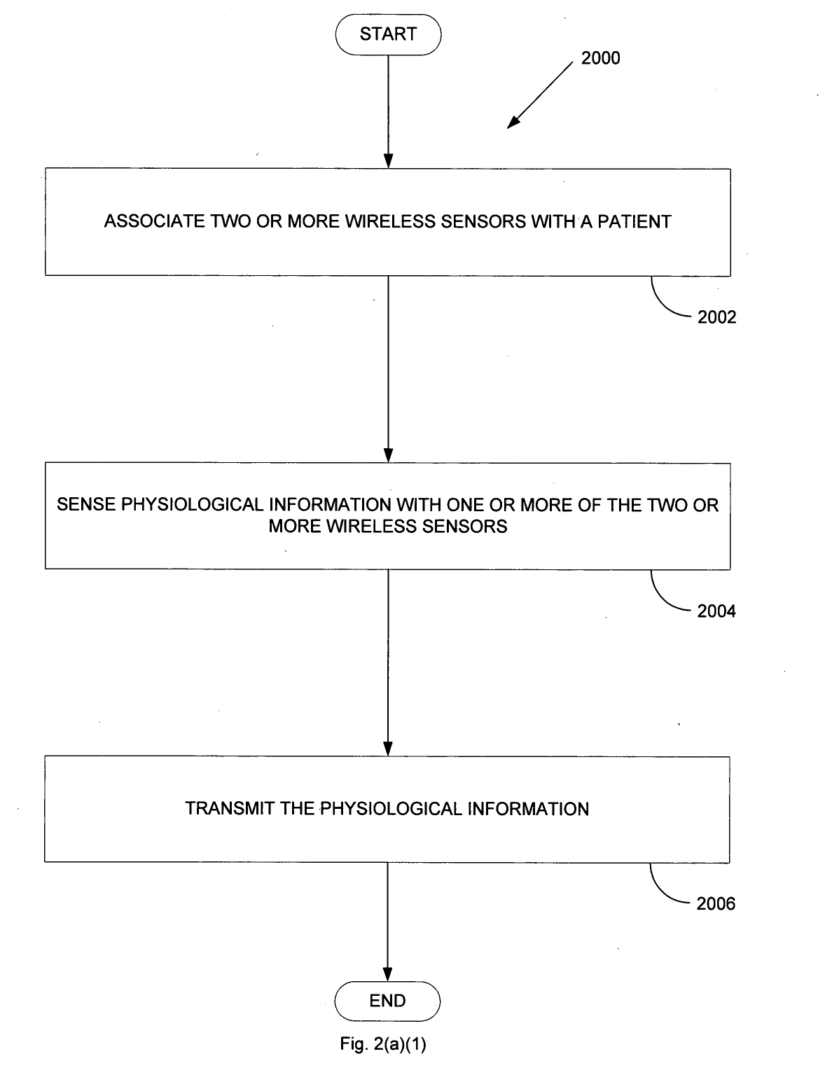

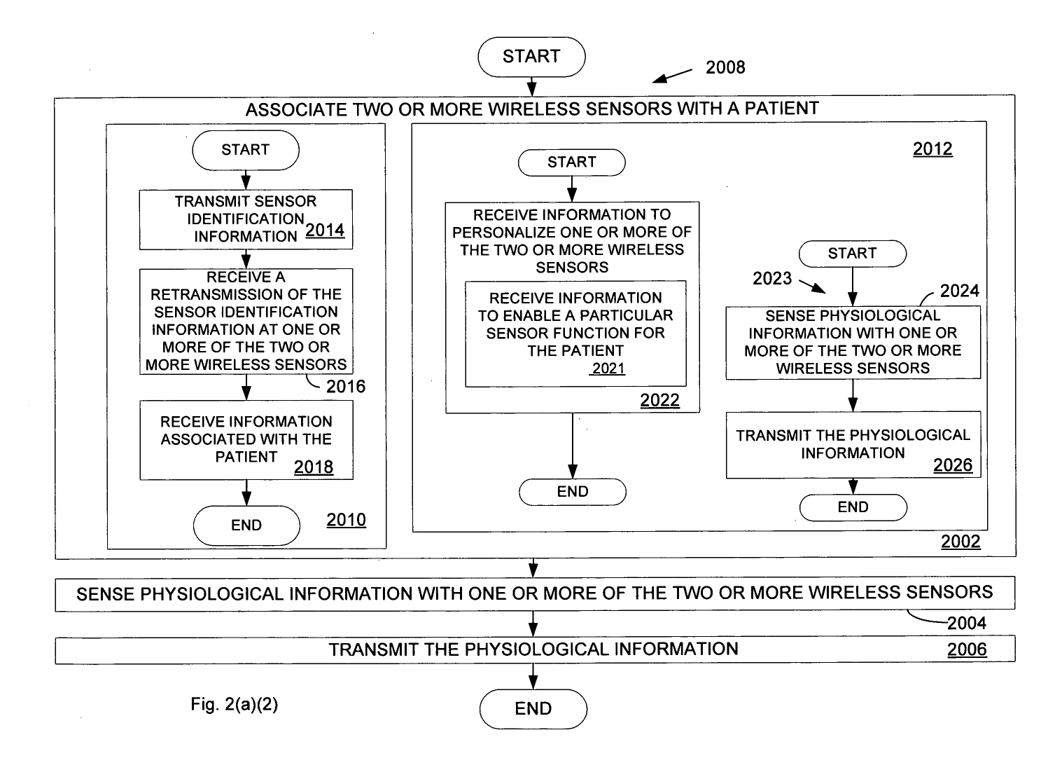

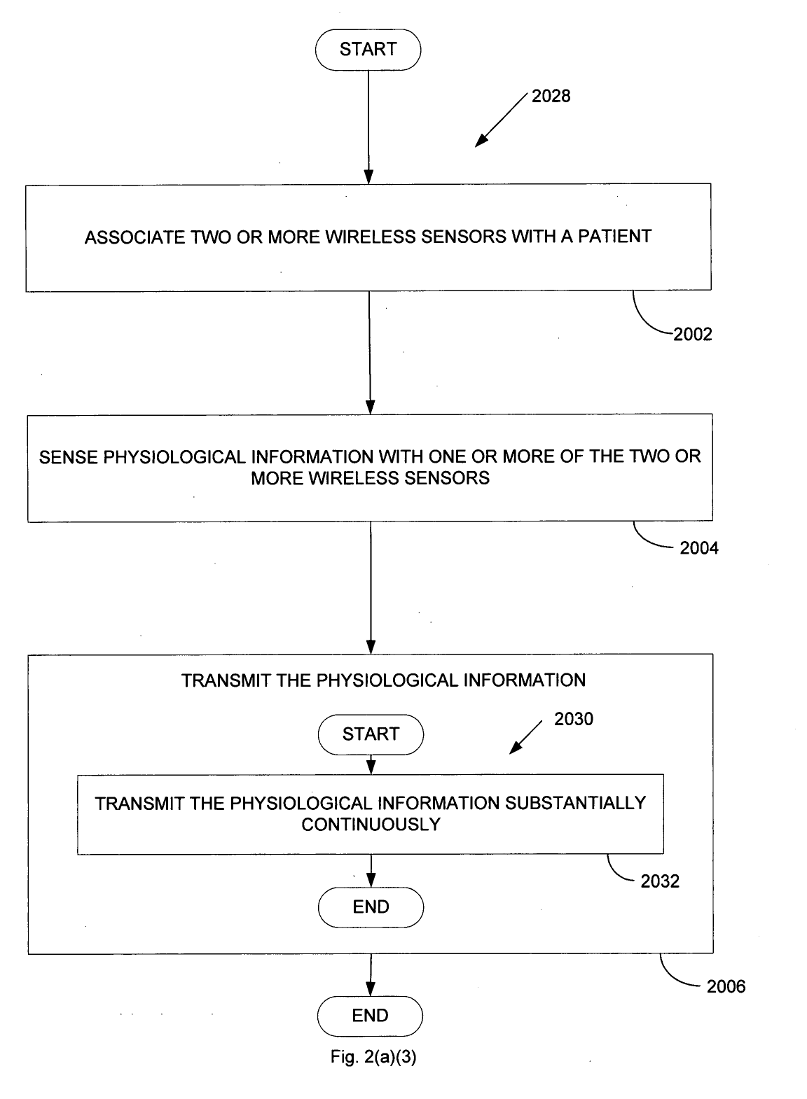

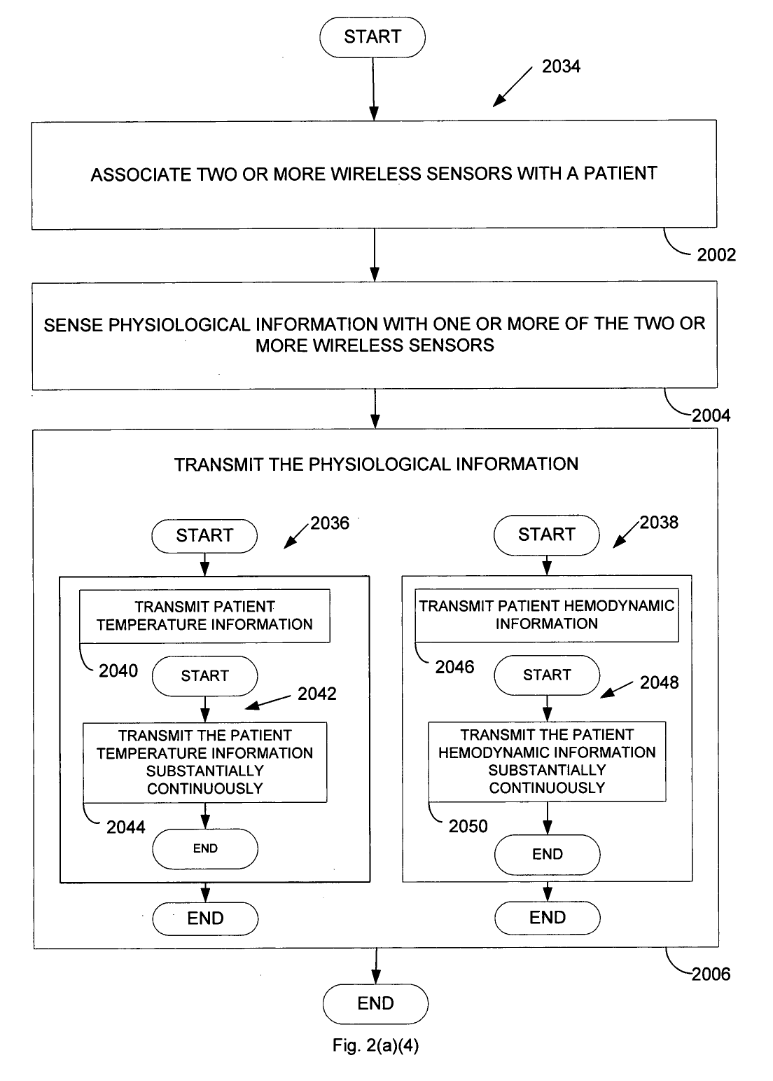

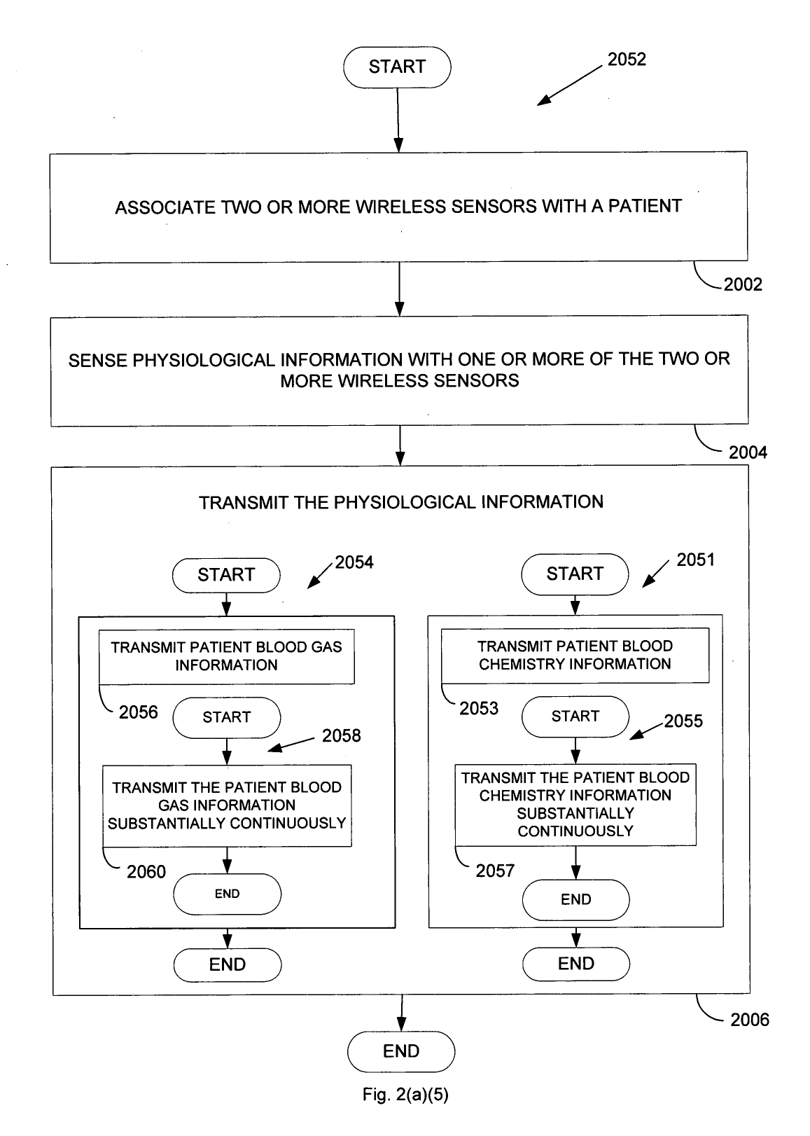

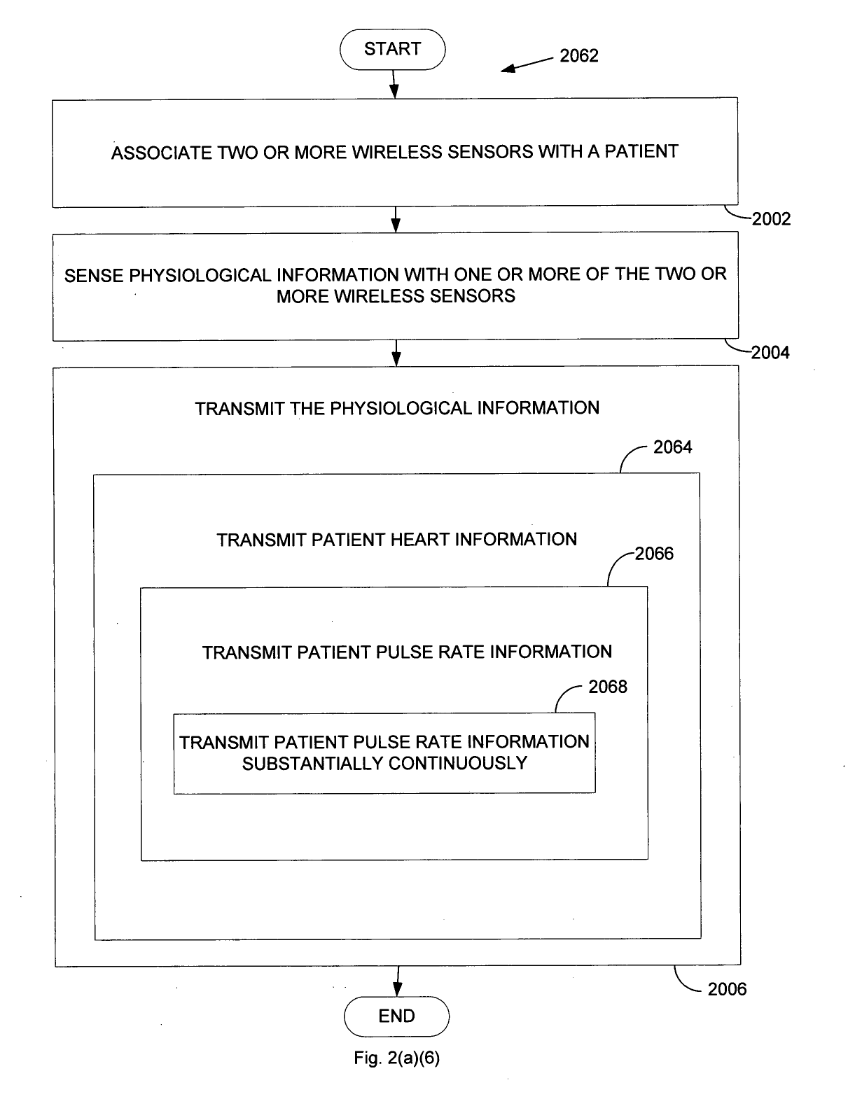

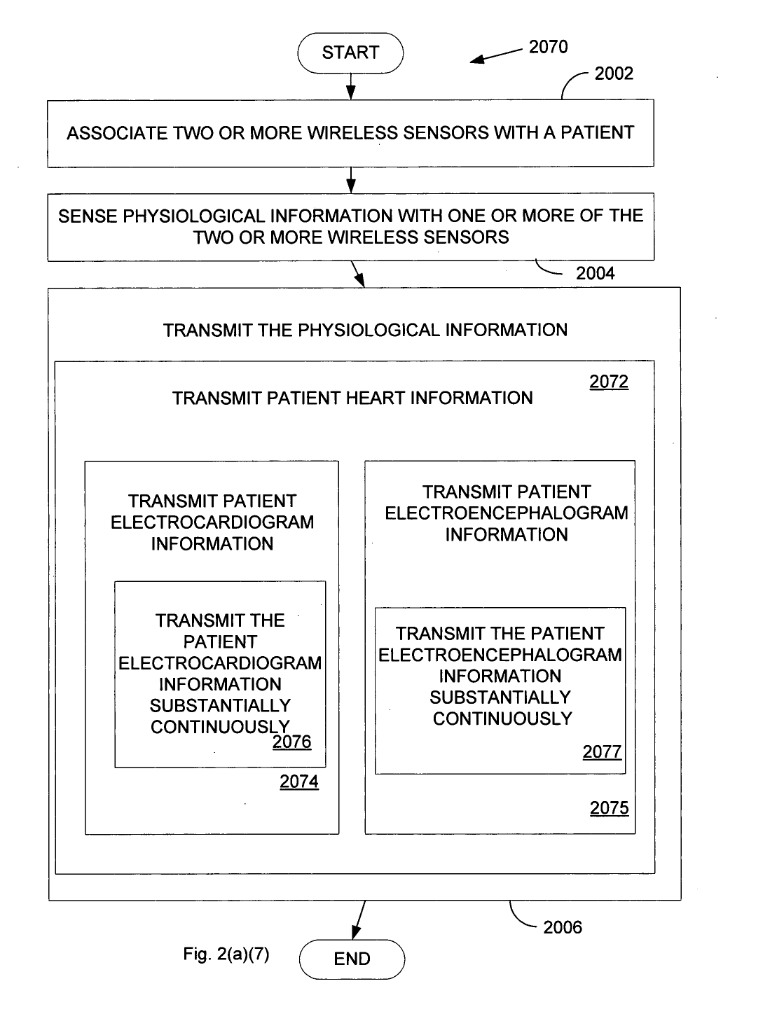

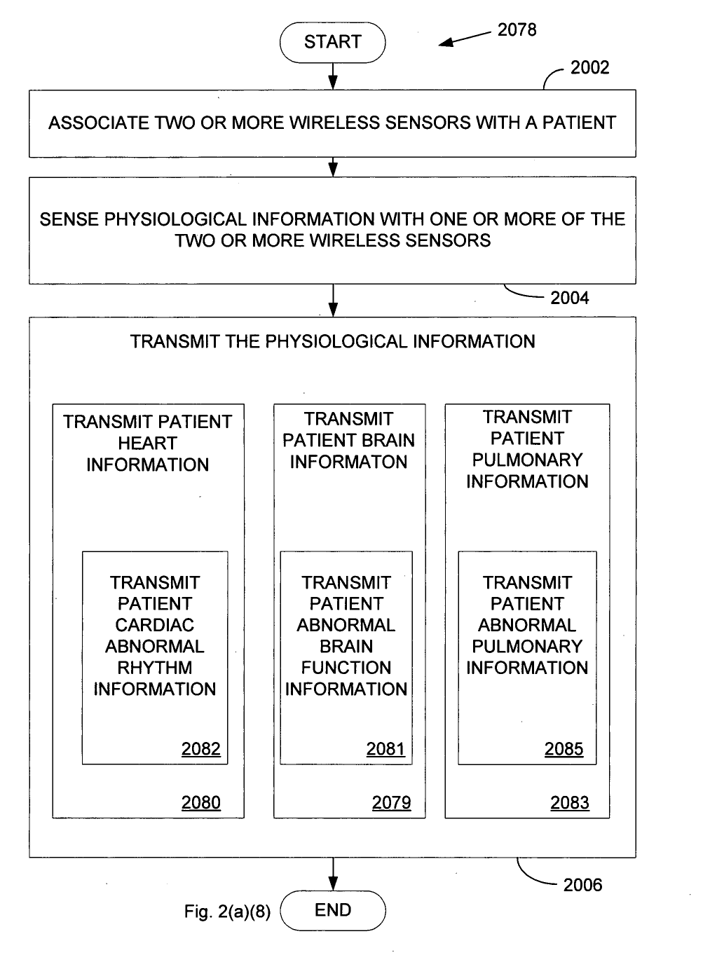

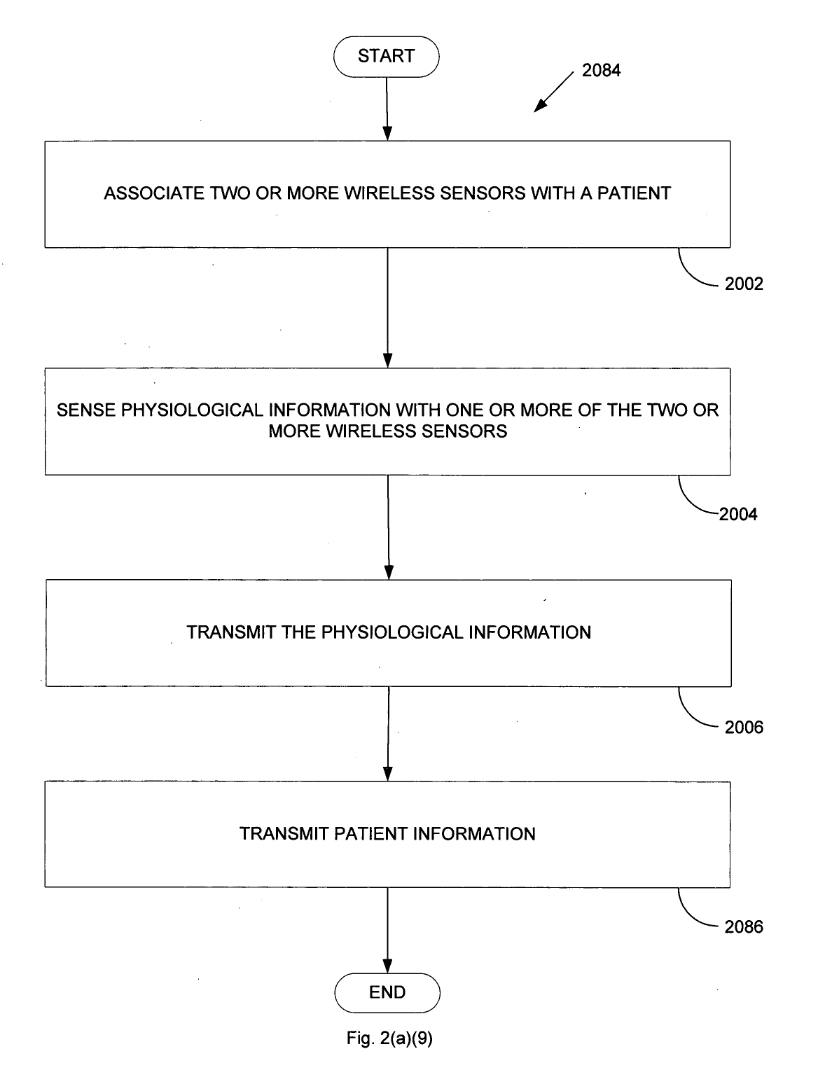

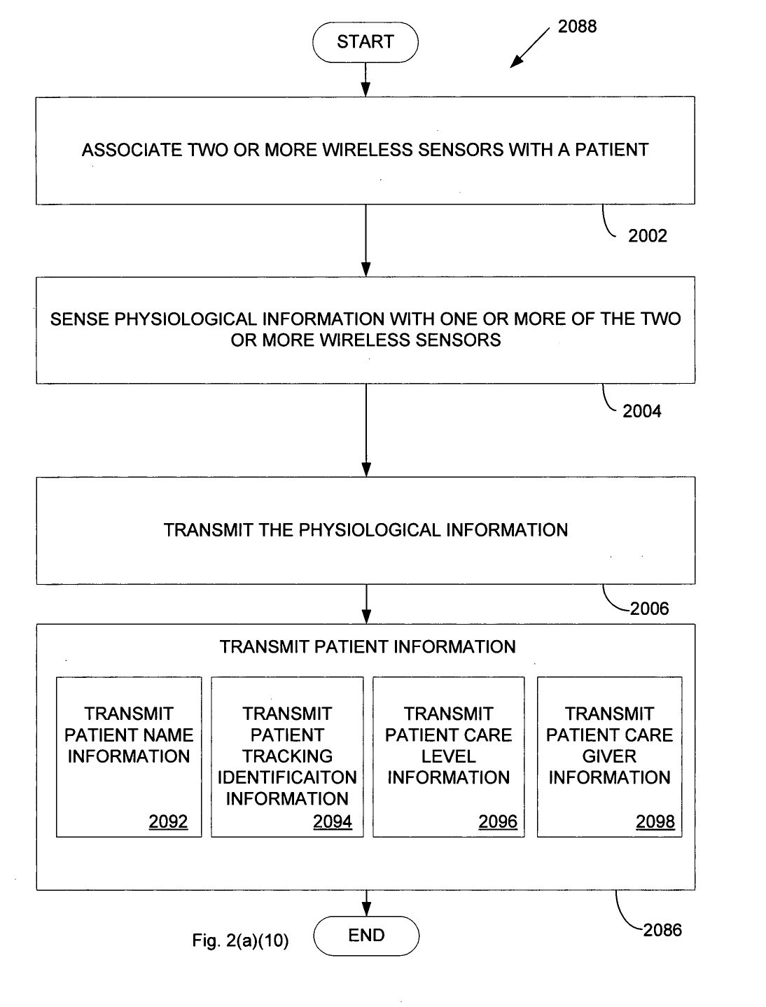

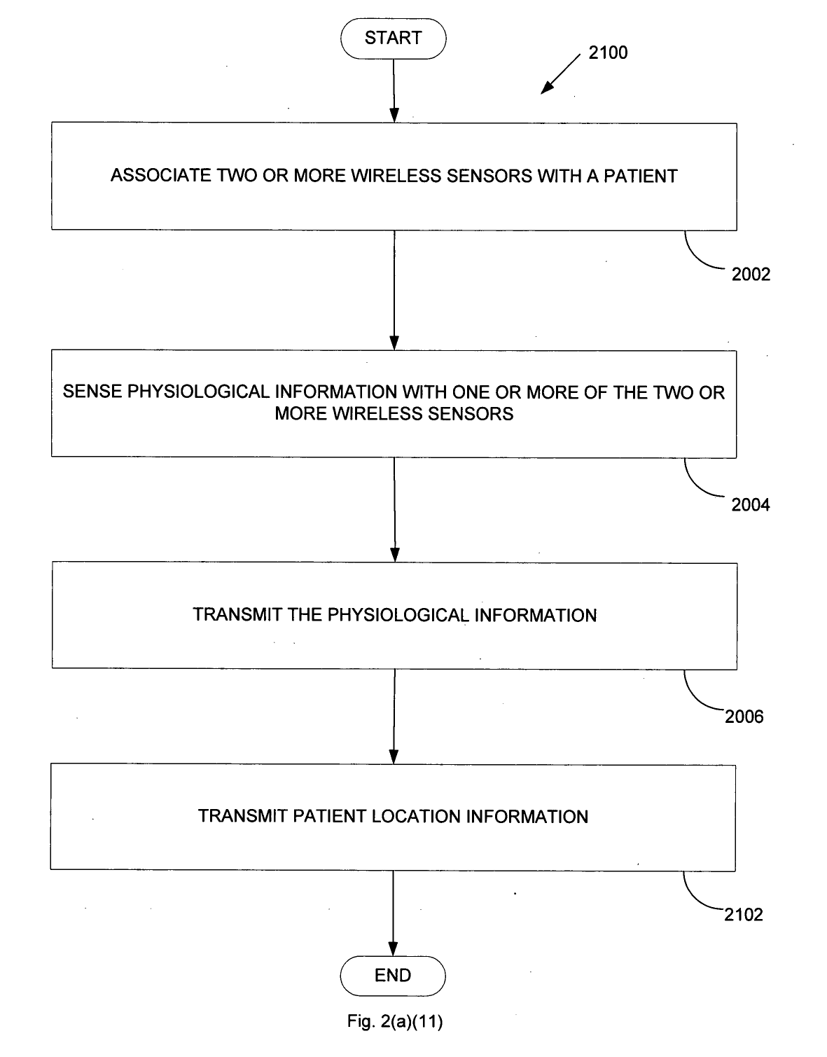

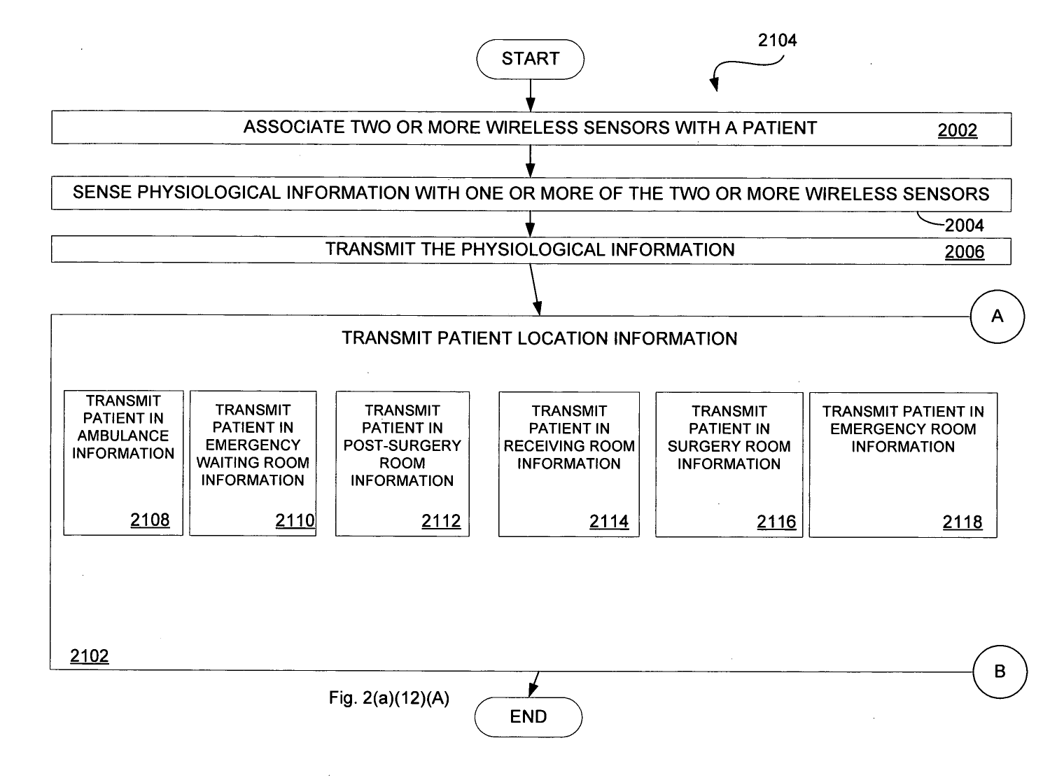

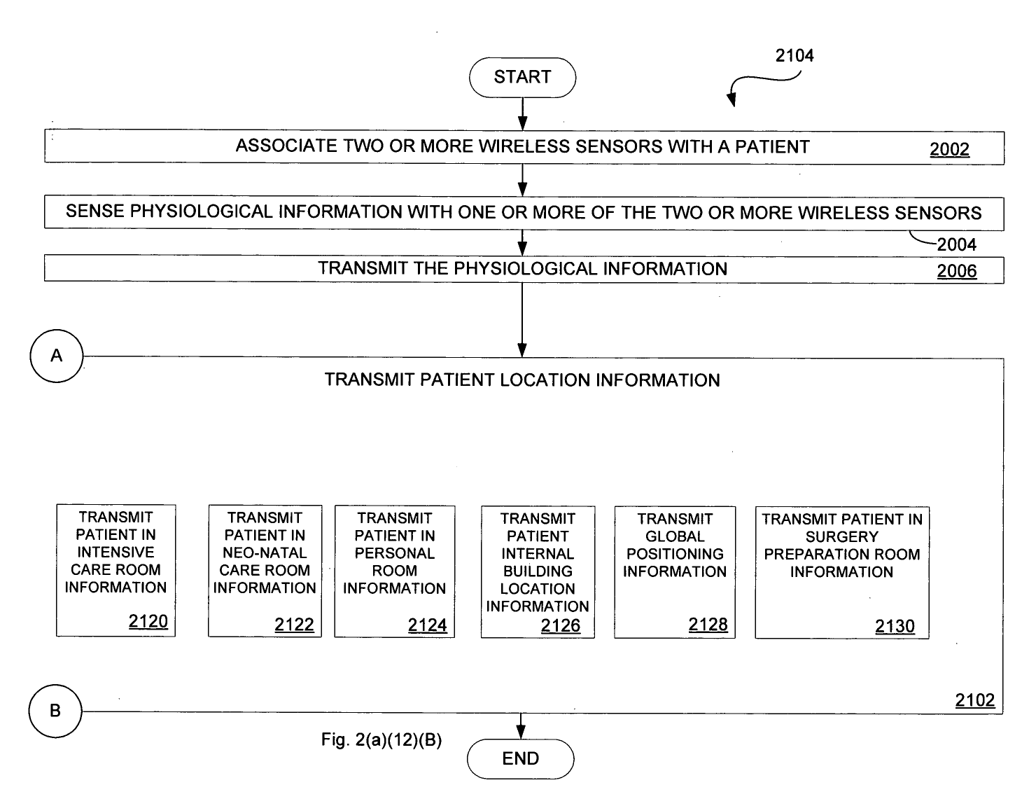

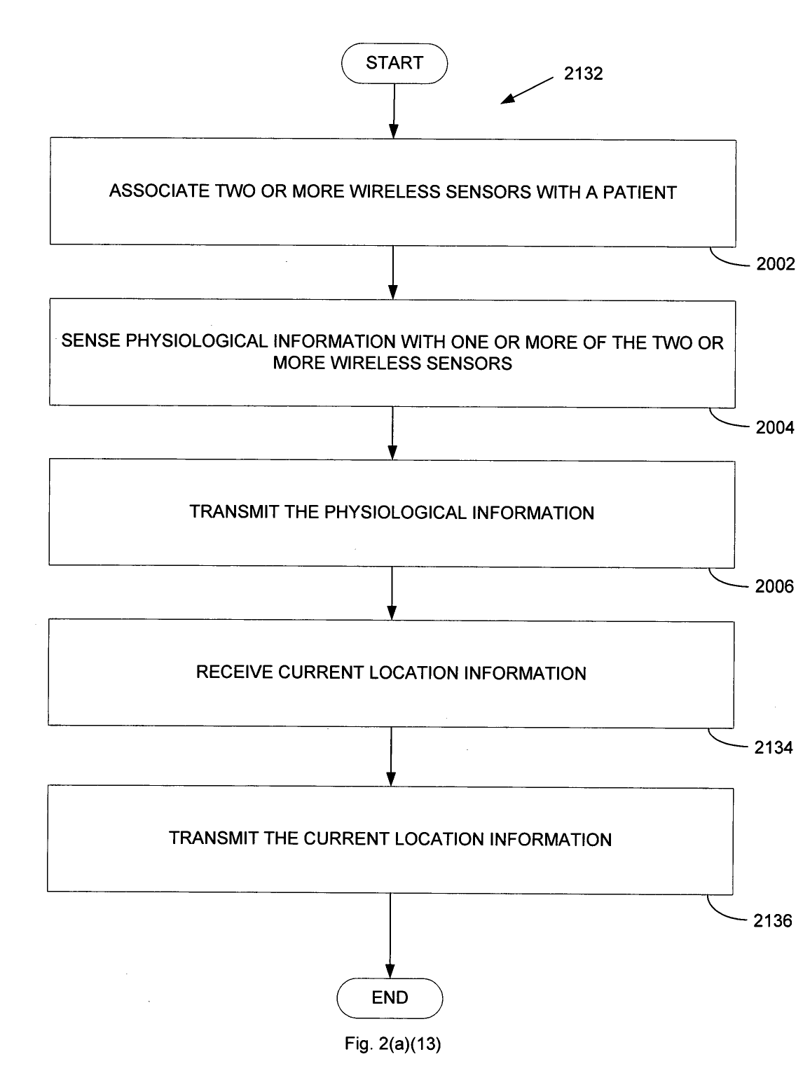

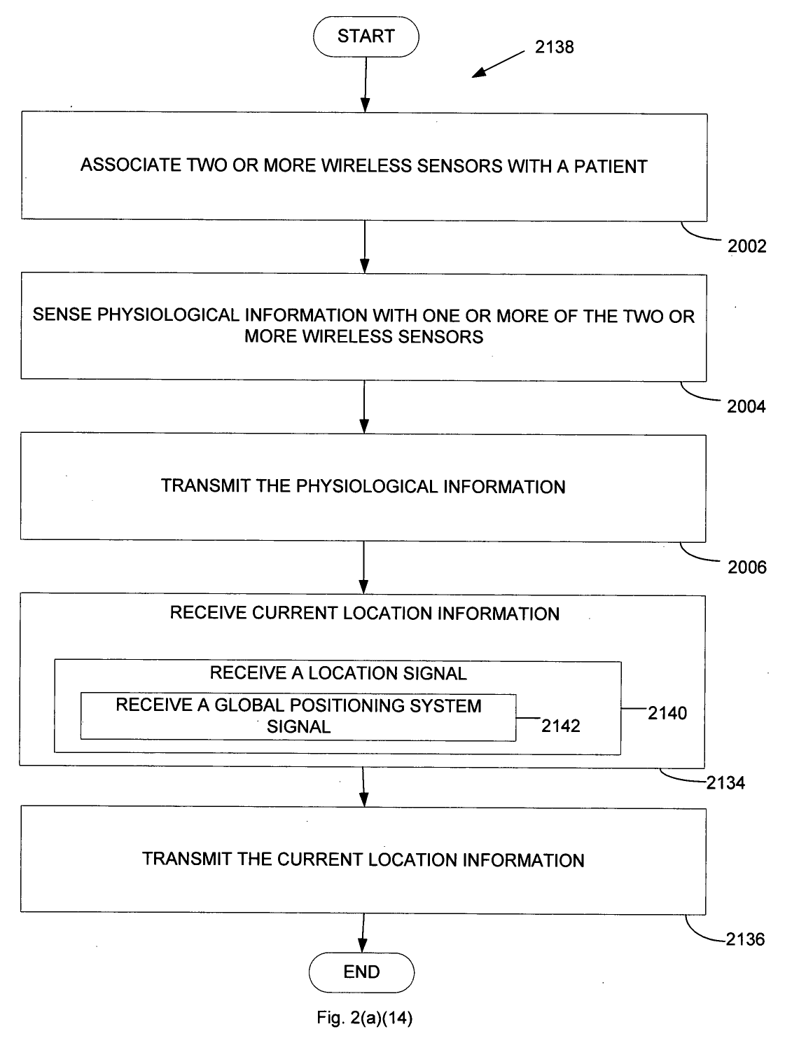

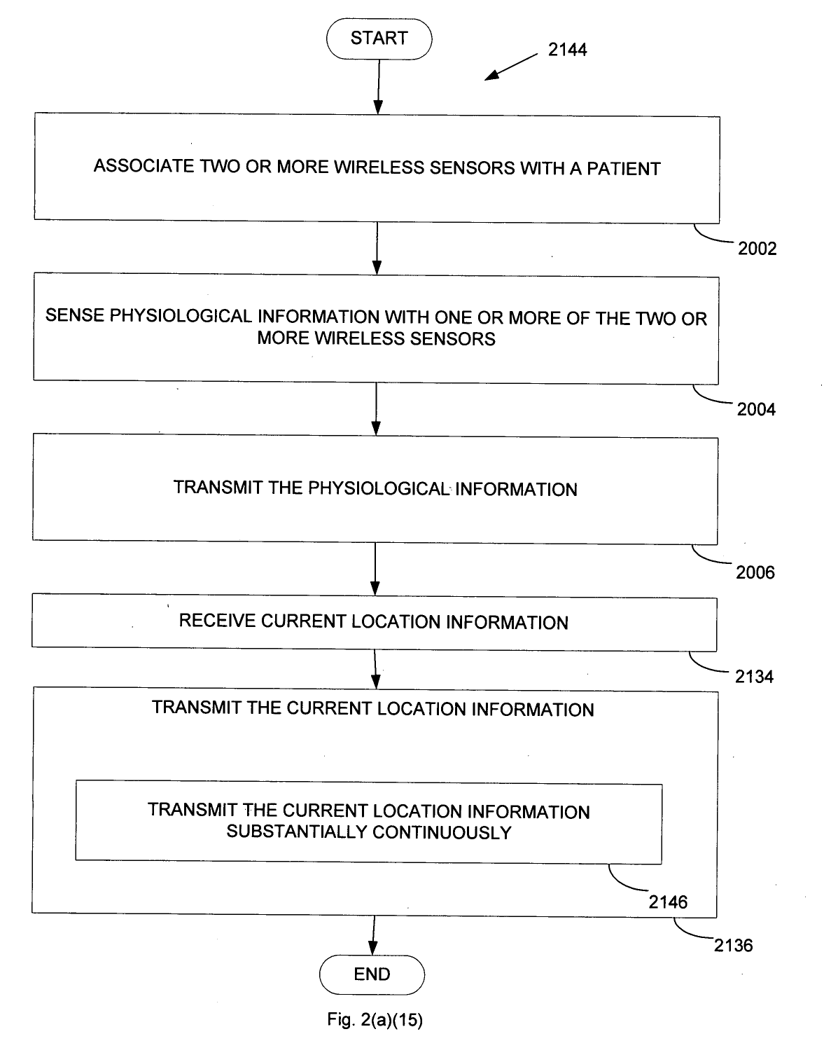

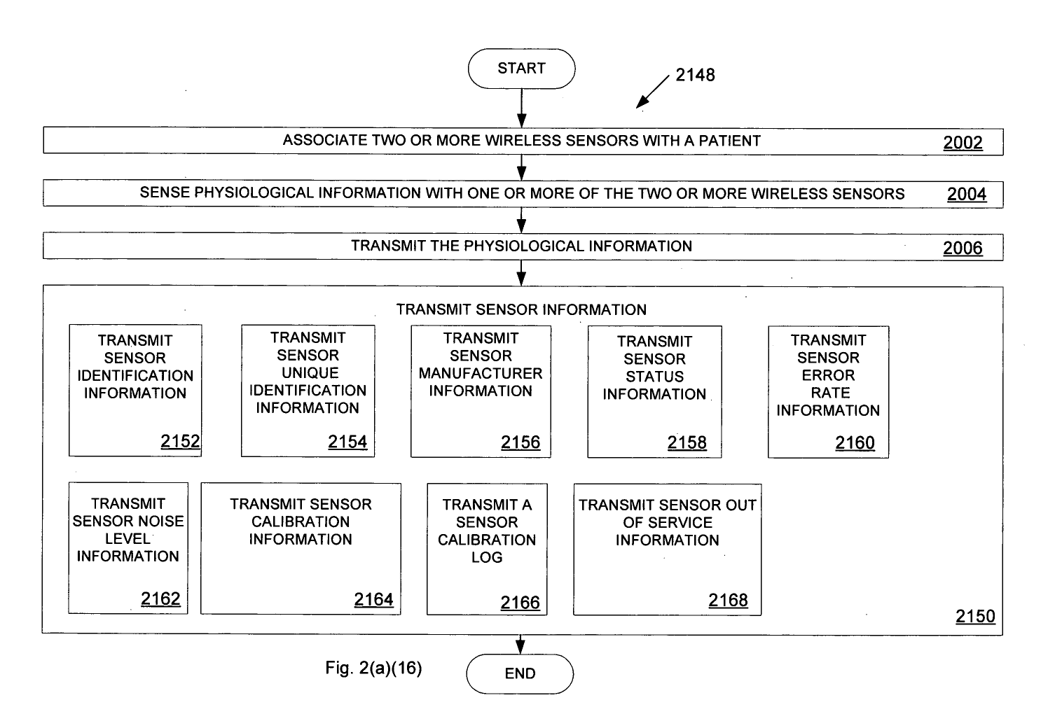

FIG. 2(a)(1) shows a flow diagram of a method 2000 suitable for use in connection with the sensing apparatus 1002, shown in FIG. 1(a), and the patient 1006, shown in FIG. 1(a), in accordance with some embodiments. The method 2000 may include associating two or more wireless sensors with a patient (operation 2002), sensing physiological information with one or more of the two or more wireless sensors (operation 2004), and transmitting the physiological information (operation 2006). Referring to FIG. 1(a)(1), in some embodiments, the associating hardware/software/firmware 1012 may associate two or more wireless sensors with a patient (operation 2002), as shown in FIG. 2(a)(1). Referring to FIG. 1(a)(1), in some embodiments, the sensing hardware/software/firmware 1010 may sense physiological information with one or more of the two or more wireless sensors (operation 2004), as shown in FIG. 2(a)(1). Referring to FIG. 1(a)(1), in some embodiments, the transmitting hardware/software/firmware 1014 may transmit the physiological information (operation 2006), as shown in FIG. 2(a)(1).

FIG. 2(a)(2) shows a flow diagram of a method 2008, illustrated within the context of method 2000 as shown in FIG. 2(a)(1), wherein the operation 2002, associating two or more wireless sensors with a patient, shown in FIG. 2(a), may include methods 2010 and 2012 in accordance with some embodiments. The method 2010 may include transmitting sensor identification information (operation 2014), receiving a retransmission of the sensor identification information at one or more of the two or more wireless sensors (operation 2016), and receiving information associated with the patient (operation 2018). Referring again to FIG. 1(a)(1), in some embodiments, the transmitting hardware/software/firmware 1014 may transmit sensor identification information (operation 2014), receive a retransmission of the sensor identification information at one or more of the two or more wireless sensors (operation 2016), and receive information associated with the patient (operation 2018), as shown in FIG. 2(a)(2).

The method 2012 may include a method 2020 that may include receiving information to personalize one or more of the two or more wireless sensors (operation 2022). Referring to FIG. 1(a)(1), in some embodiments, the transmitting hardware/software/firmware 1014, may receive information to personalize one or more of the two or more wireless sensors (operation 2022), as shown in FIG. 2(a)(2). Referring to FIG. 1(a)(3), in some embodiments, the personalization information receiver 1022 may receive personalization information to personalize one or more of the two or more wireless sensors. Personalization may include operations such as selecting a particular sensor, such as a cardiac sensor or blood gas sensor, and setting a time for reporting information back to the processing apparatus 1004.

Referring again to FIG. 2(a)(2), the method 2012 may include a method 2023 that may include sensing physiological information with one or more of the two or more wireless sensors (operation 2024) and transmitting the physiological information (operation 2026). Referring to FIG. 1(a)(1), in some embodiments, the sensing apparatus 1002 may sense physiological information with one or more of the two or more wireless sensors (operation 2024), and the transmitting hardware software firmware 1014 may transmit the physiological information (operation 2026), as shown in FIG. 2(a)(2). Referring again to FIG. 2(a)(1), in some embodiments, the sensing apparatus 1002, may sense physiological information at the patient 1006, and may transmit the physiological information to the processing apparatus 1004.

FIG. 2(a)(3) shows a flow diagram of a method 2028, illustrated within the context of method 2000 as shown in FIG. 2(a)(1), wherein the operation 2006, transmitting the physiological information, may include a method 2030 that may include transmitting the physiological information substantially continuously (operation 2032) in accordance with some embodiments. Referring to FIG. 1(a)(5), in some embodiments, the substantially continuous transmission hardware/software/firmware 1026 may transmit the physiological information substantially continuously (operation 2032), as shown in FIG. 2(a)(3). Substantially continuously means transmitting information using analog or digital signals at a rate suitable for the intended use of the information. For example, a patient core temperature measurement transmitted at one measurement per second is substantially continuous for the purpose of tracking the core temperature of a human patient.

FIG. 2(a)(4) shows a flow diagram of a method 2034, illustrated within the context of method 2000 as shown in FIG. 2(a)(1), wherein the operation 2006, transmitting the physiological information, may include methods 2036 and 2038 in accordance with some embodiments. The method 2036 may include transmitting patient temperature information (operation 2040). Exemplary patient temperature information includes information related to the degree of heat in an organism, such as a human patient. Referring again to FIG. 1(a)(1), in some embodiments, the transmitting hardware software firmware 1014 may transmit patient temperature information (operation 2040), as shown in FIG. 2(a)(4). The method 2036 may include the method 2042 that may include transmitting the patient temperature information substantially continuously (operation 2044). Referring to FIG. 1(a)(5), in some embodiments, the substantially continuous transmission hardware/software/firmware 1026 may transmit the patient temperature information substantially continuously (operation 2044), as shown in FIG. 2(a)(4). The method 2038 may include transmitting patient hemodynamic information (operation 2046). Patient hemodynamic information may include forces related to blood circulation including pressure, flow rate, stroke volume, and resistance. Referring again to FIG. 1(a)(1), in some embodiments, the transmitting hardware software firmware 1014 may transmit patient hemodynamic information (operation 2046), as shown in FIG. 2(a)(4). The method 2038 may include the method 2048 that may include transmitting the patient hemodynamic information substantially continuously (operation 2050). Referring again to FIG. 1(a)(5), in some embodiments, the substantially continuous transmission hardware/software/firmware 1026 may transmit the patient hemodynamic information substantially continuously (operation 2050), as shown in FIG. 2(a)(4).

FIG. 2(a)(5) shows a flow diagram of a method 2052, illustrated within the context of method 2000 as shown in FIG. 2(a)(1), wherein the operation 2006, transmitting the physiological information, may include a method 2054 and a method 2051 in accordance with some embodiments. The method 2054 may include transmitting patient blood gas information (operation 2056). Referring again to FIG. 1(a)(1), in some embodiments, the transmitting hardware software firmware 1014 may transmit patient blood gas information (operation 2056), as shown in FIG. 2(a)(5). Patient blood gas information may include information related to gases in the blood, such as oxygen, carbon dioxide, nitrogen, and anesthetic agents, such as inhaled anesthetic agents. The method 2054 may include a method 2058 that may include transmitting the patient blood gas information substantially continuously (operation 2060). Referring again to FIG. 1(a)(5), in some embodiments, the substantially continuous transmission hardware/software/firmware 1026 may transmit patient blood gas information substantially continuously (operation 2060), as shown in FIG. 2(a)(5). The method 2051 may include transmitting patient blood chemistry information (operation 2053). Referring again to FIG. 1(a)(1), in some embodiments, the transmitting hardware software firmware 1014 may transmit patient blood chemistry information (operation 2053), as shown in FIG. 2(a)(5). Patient blood chemistry information may include information related to concentrations of chemicals or other materials in the blood. Glucose is an exemplary chemical included in patient blood chemistry. The method 2051 may include a method 2055 that may include transmitting the patient blood chemistry information substantially continuously (operation 2057). Referring again to FIG. 1(a)(5), in some embodiments, the substantially continuous transmission hardware/software/firmware 1026 may transmit patient blood chemistry information substantially continuously (operation 2057), as shown in FIG. 2(a)(5).

FIG. 2(a)(6) shows a flow diagram of a method 2062, illustrated within the context of method 2000 as shown in FIG. 2(a)(1), wherein the operation 2006, transmitting the physiological information, may include transmitting patient heart information (operation 2064) in accordance with some embodiments. Referring again to FIG. 1(a)(1), in some embodiments, the transmitting hardware software firmware 1014 may transmit patient heart information (operation 2064), as shown in FIG. 2(a)(6). Heart information, for example, may include pulse rate information. The operation 2064 may include transmitting patient pulse rate information (operation 2066). Referring again to FIG. 1(a)(1), in some embodiments, the transmitting hardware software firmware 1014 may transmit patient pulse rate information (operation 2066), as shown in FIG. 2(a)(6). The operation 2066 may include transmitting the patient pulse rate information substantially continuously (operation 2068). Referring again to FIG. 1(a)(5), in some embodiments, the substantially continuous transmission hardware/software/firmware 1026 may transmit the patient pulse rate information substantially continuously (operation 2068), as shown in FIG. 2(a)(6).

FIG. 2(a)(7) shows a flow diagram of a method 2070, illustrated within the context of method 2000 as shown in FIG. 2(a)(1), wherein the operation 2006, transmitting the physiological information, may include transmitting patient heart information (operation 2072) or patient electroencephalogram information (operation 2075) in accordance with some embodiments. The operation 2072 may include transmitting patient electrocardiogram information (operation 2074). Referring again to FIG. 1(a)(1), in some embodiments, the transmitting hardware software firmware 1014 may transmit patient electrocardiogram information (operation 2074), as shown in FIG. 2(a)(7). Electrocardiogram information may include information related to electrical signals in the heart. The operation 2074 may include transmitting the patient electrocardiogram information substantially continuously (operation 2076). Referring again to FIG. 1(a)(5), in some embodiments, the substantially continuous transmission hardware/software/firmware 1026 may transmit the patient electrocardiogram information substantially continuously (operation 2076), as shown in FIG. 2(a)(6). The operation 2072 may include transmitting patient electroencephalogram information (operation 2075). Referring again to FIG. 1(a)(1), in some embodiments, the transmitting hardware software firmware 1014 may transmit patient electroencephalogram information (operation 2075), as shown in FIG. 2(a)(7). Electroencephalogram information may include information related to electrical signals in the brain. The operation 2074 may include transmitting the patient electroencephalogram information substantially continuously (operation 2077). Referring again to FIG. 1(a)(5), in some embodiments, the substantially continuous transmission hardware/software/firmware 1026 may transmit the patient electroencephalogram information substantially continuously (operation 2077), as shown in FIG. 2(a)(7).

FIG. 2(a)(8) shows a flow diagram of a method 2078, illustrated within the context of method 2000 as shown in FIG. 2(a)(1), wherein the operation 2006, transmitting the physiological information (2006), may include transmitting patient heart information (operation 2080), transmitting patient brain information (operation 2079), and transmitting patient pulmonary information (operation 2083) in accordance with some embodiments. The operation 2080 may include transmitting patient cardiac abnormal rhythm information (operation 2082). Referring again to FIG. 1(a)(1), in some embodiments, the transmitting hardware software firmware 1014 may transmit patient cardiac abnormal rhythm information (operation 2082), as shown in FIG. 2(a)(8). Exemplary information provided by cardiac abnormal rhythm information may include information related to atrial fibrillation, atrial tachycardia, and asystole. Identifying a cardiac abnormal rhythm provides information that is useful in identifying a need for real time patient monitoring by a nurse or physician. The operation 2079 may include transmitting patient abnormal brain function information (operation 2081). Referring again to FIG. 1(a)(1), in some embodiments, the transmitting hardware software firmware 1014 may transmit patient abnormal brain function information (operation 2081), as shown in FIG. 2(a)(8). The operation 2083 may include transmitting patient abnormal pulmonary information (operation 2085). Referring again to FIG. 1(a)(1), in some embodiments, the transmitting hardware software firmware 1014 may transmit patient abnormal pulmonary information (operation 2085), as shown in FIG. 2(a)(8).

### Transmitting Patient Information

FIG. 2(a)(9) shows a flow diagram of a method 2084 illustrated within the context of method 2000, shown in FIG. 2(a)(1), and further including transmitting patient information (operation 2086) in accordance with some embodiments. Referring again to FIG. 1(a)(1), in some embodiments, the sensing apparatus 1002 transmits patient information, as shown in FIG. 2(a)(10), FIG. 2(a)(11), and FIG. 2(a)(12)(A) and 2(a)(12)(B) and described below. Exemplary patient information may include patient name information, patient tracking identification information, patient care level information, and/or patient care giver information. Exemplary patient name information may include the patient's name. Exemplary patient tracking identification information may include a unique patient identifier, such as a sequence of letters and numbers, used to track the patient. Exemplary patient care level information may include the level of care, such as intensive care, being provided to the patient. Exemplary patient care giver information includes the names of physicians or nurses associated with the patient.

FIG. 2(a)(10) shows a flow diagram of a method 2088, illustrated within the context of method 2084 as shown in FIG. 2(a)(9), wherein transmitting patient information (operation 2086) may include transmitting patient name information (operation 2092), transmitting patient tracking identification information (operation 2094), transmitting patient care level information (operation 2096), and transmitting patient care giver information (operation 2098) in accordance with some embodiments. Referring again to FIG. 1(a)(1), in some embodiments, the transmitting hardware software firmware 1014 may transmit patient name information (operation 2092), transmit patient tracking identification information (operation 2094), transmit patient care level information (operation 2096), and transmit patient care giver information (operation 2098), as shown in FIG. 2(a)(10). Exemplary patient tracking information may include information such as a patient medical record number or other unique patient identifying information. In some embodiments, the patient medical record number or other unique identifying information is encrypted to protect the privacy of the patient. Exemplary patient care givers include attendants, nurses, and physicians.

FIG. 2(a)(11) shows a flow diagram of a method 2100, illustrated within the context of operations shown in method 2084, associating two or more wireless sensors with a patient (operation 2002), sensing physiological information with one or more of the two or more wireless sensors (operation 2004), and transmitting the physiological information (operation 2006), as shown in FIG. 2(a)(9), and further including transmitting patient location information (operation 2102) in accordance with some embodiments. Referring again to FIG. 1(a)(1), in some embodiments, the sensing apparatus 1002 may transmit the location of the patient 1006 to the processing apparatus 1004. Exemplary locations may include the emergency room and intensive care.

FIG. 2(a)(12)(A) and 2(a)(12)(B) show a flow diagram of a method 2104 illustrated within the context of method 2100, shown in FIG. 2(a)(1), wherein transmitting patient location information (operation 2102) may include transmitting patient locations from inside a hospital facility and outside a hospital facility in accordance with some embodiments. Exemplary transmissions of patient location information may include transmitting patient in ambulance information (operation 2108), transmitting patient in emergency waiting room information (operation 2110), transmitting patient in post-surgery room information (operation 2112), transmitting patient in receiving room information (operation 2114), transmitting patient in surgery room information (operation 2116), transmitting patient in emergency room information (operation 2118), transmitting patient in intensive care room information (operation 2120), transmitting patient in neo-natal care room information (operation 2122), transmitting patient in personal room information (operation 2124), transmitting patient internal building location information (operation 2126), transmitting global positioning information, (operation 2128), and transmitting patient in surgery preparation room information (operation 2130). Referring again to FIG. 1(a)(1), in some embodiments, the transmitting hardware software firmware 1014 may transmit patient in ambulance information (operation 2108), may transmit patient in emergency waiting room information (operation 2110), may transmit patient in post-surgery room information (operation 2112), may transmit patient in receiving room information (operation 2114), may transmit patient in surgery room information (operation 2116), may transmit patient in emergency room information (operation 2118), may transmit patient in intensive care room information (operation 2120), may transmit patient in neo-natal care room information (operation 2122), may transmit patient in personal room information (operation 2124), may transmit patient internal building location information (operation 2126), may transmit global positioning information, (operation 2128), and may transmit patient in surgery preparation room information (operation 2130), as shown in FIG. 2(a)(12)(A) AND 2(a)(12)(B).

### Transmitting Location Information

FIG. 2(a)(13) shows a flow diagram of a method 2132 illustrated within the context of method 2000, show in FIG. 2(a)(1), and further including receiving current location information (operation 2134), and transmitting the current location information (operation 2136) in accordance with some embodiments. Referring again to FIG. 1(a)(1), the sensing apparatus 1002, in some embodiments, may transmit and receive current location information (operation 2134 and operation 2136) at the transmitting hardware/software/firmware 1014, which as described above is capable of transmitting and receiving information. Current location information may include the location of a patient in a hospital. Exemplary locations may include emergency room, waiting room, and corridor locations, such as left side of the corridor, right side of the corridor or at the end of the corridor.

FIG. 2(a)(14) shows a flow diagram of a method 2138 illustrated within the context of method 2132, shown in FIG. 2(a)(13), wherein receiving current location information (operation 2134) may include receiving a location signal (operation 2140) in accordance with some embodiments. Referring again to FIG. 1(a)(1), the sensing apparatus 1002, in some embodiments, may include receiving a location signal (operation 2140), as shown in FIG. 2(a)(14), through the transmitting hardware/software/firmware 1014, which as described above is capable of transmitting and receiving information. A current location signal may include information related to a location in a hospital, such as the emergency room, where a patient is presently located.

The method 2138 may include receiving a global positing system signal (operation 2142). Referring again to FIG. 1(a)(1), the sensing apparatus 1008, in some embodiments, may receive a global positioning system signal (operation 2142) at the transmitting hardware/software/firmware 1014, which as described above is capable of transmitting and receiving information.

FIG. 2(a)(15) shows a flow diagram of a method 2144 illustrated within the context of method 2132, shown in FIG. 2(a)(13), wherein transmitting the current location information may include transmitting the current location information substantially continuously (operation 2146). Referring again to FIG. 1(a)(5), in some embodiments, the substantially continuous transmission hardware/software/firmware 1026 may transmit the current location information substantially continuously (operation 2146), as shown in FIG. 2(a)(15). An exemplary current location may include the emergency room.

### Transmitting Sensor Information

FIG. 2(a)(16) shows a flow diagram of a method 2148 illustrated within the context of method 2000, shown in FIG. 2(a)(1), and further including transmitting sensor information (operation 2150) in accordance with some embodiments. The method 2148 may include transmitting sensor identification information (operation 2152), transmitting sensor unique identification information (operation 2154), transmitting sensor manufacturer information (operation 2156), transmitting sensor status information (operation 2158), transmitting sensor error rate information (operation 2160), transmitting sensor noise level information (operation 2162), transmitting sensor calibration information (operation 2164), transmitting a sensor calibration log (operation 2166), and transmitting sensor out of service information (2168). Referring again to FIG. 1(a)(1), in some embodiments, the transmitting hardware/software/firmware 1014 may be included in the sensing apparatus 1002, and may transmit sensor identification information (operation 2152), may transmit sensor unique identification information (operation 2154), may transmit sensor manufacturer information (operation 2156), may transmit sensor status information (operation 2158), may transmit sensor error rate information (operation 2160), may transmit sensor noise level information (operation 2162), may transmit sensor calibration information (operation 2164), may transmit a sensor calibration log (operation 2166), and may transmit sensor out of service information (2168), as shown in FIG. 2(a)(16). The transmission of sensor information enables sensor maintenance. For example, the transmission of sensor error rate information enables the prediction sensor failures which permits the replacement of sensors before they fail. Exemplary sensor identification information may include a sensor's type. Exemplary sensor unique identification information may include a sensor's manufacturer's identification number. Exemplary sensor manufacturer information may include a manufacturer's lot number. Exemplary sensor status information may include an indication of whether a sensor is receiving power. Exemplary sensor error rate information may include the number of resends during a period of time. Exemplary sensor noise level information may include a measure of the root-mean-squared noise signal. Exemplary sensor calibration information may include the date of last sensor calibration. Exemplary sensor out of service information may include a log of all out of service time.

### Receiving Patient Information

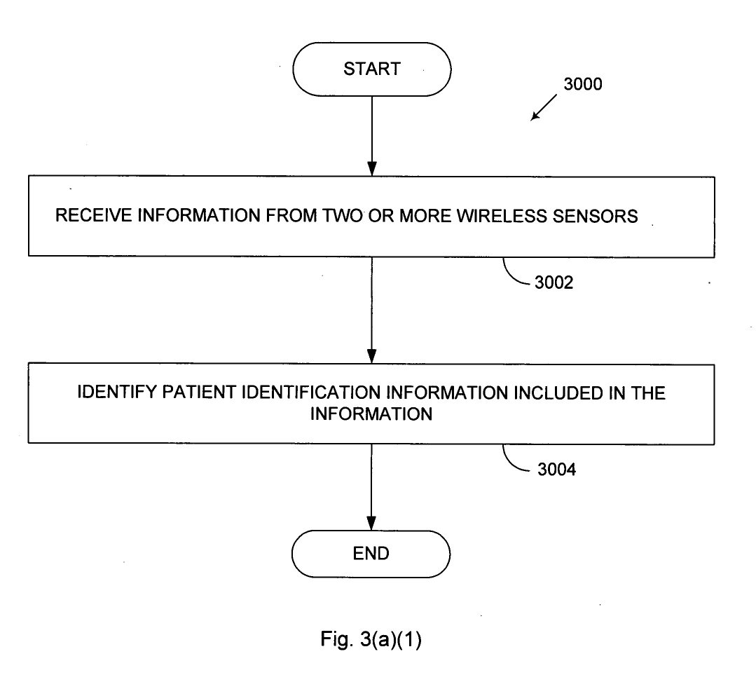

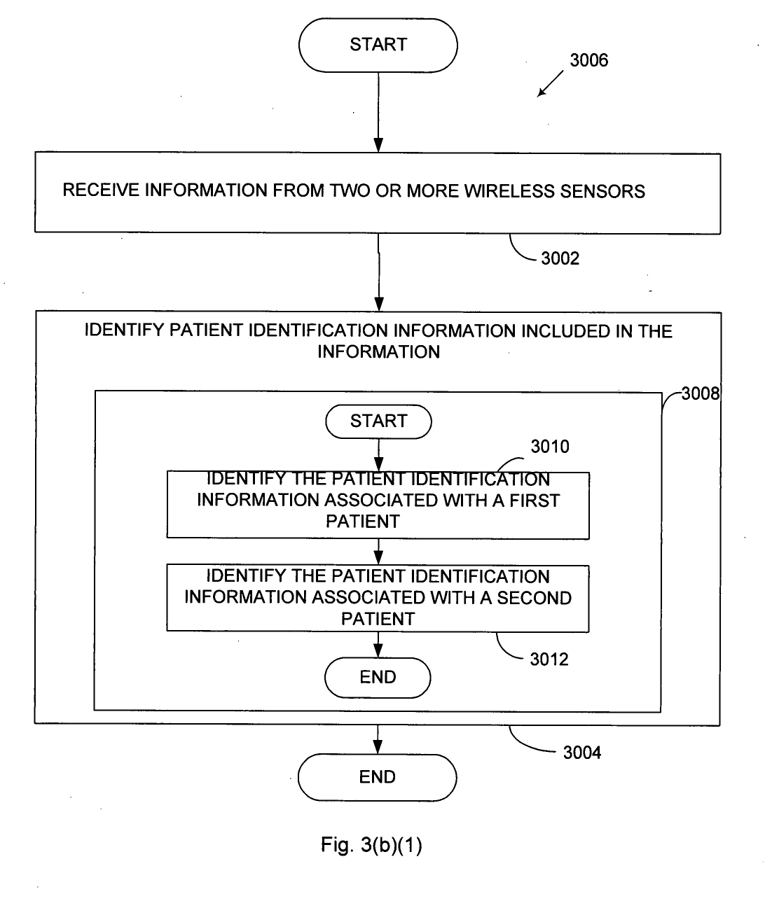

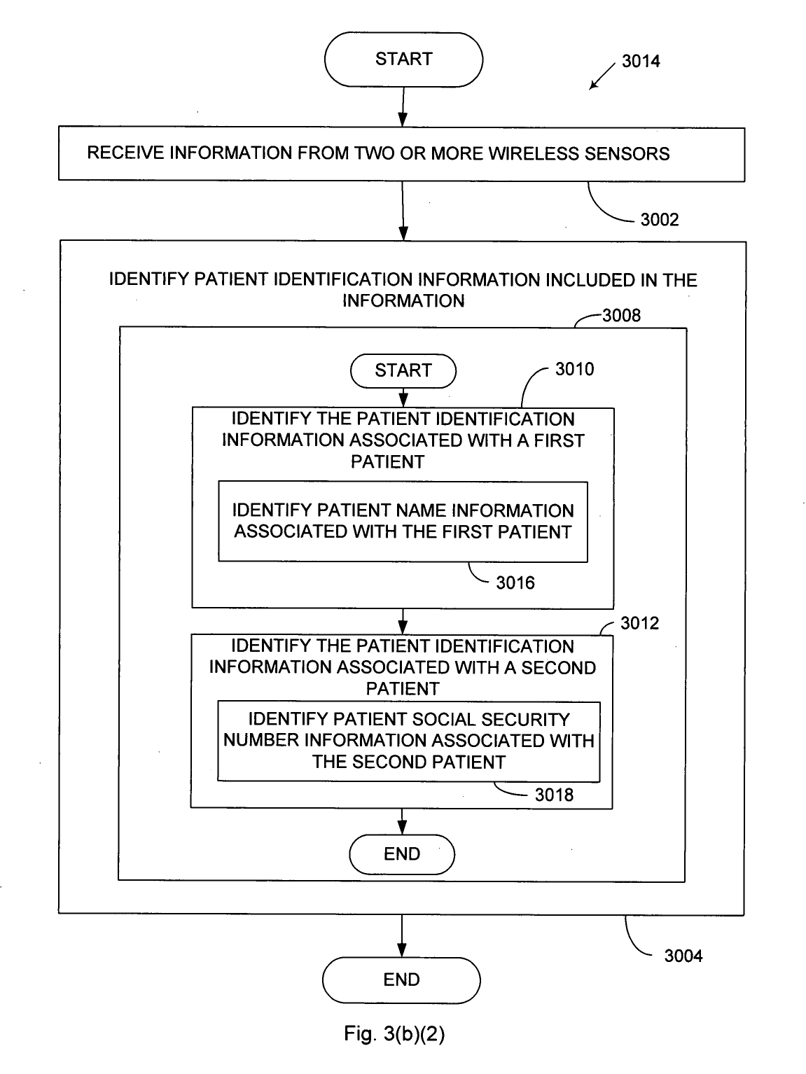

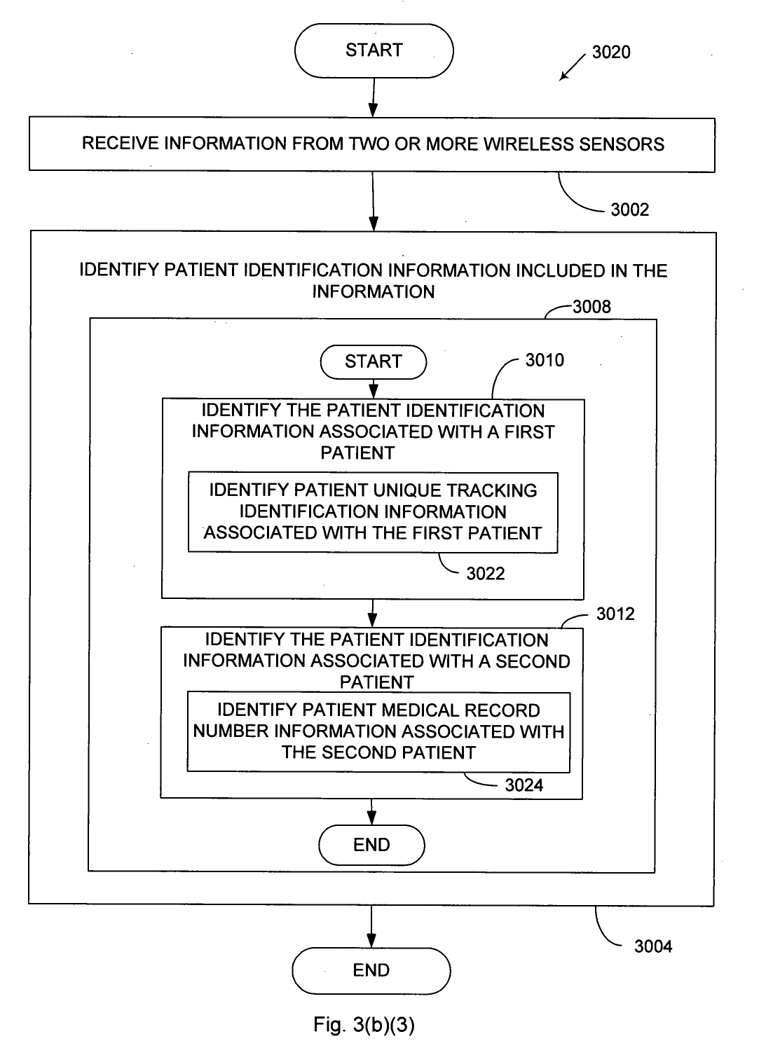

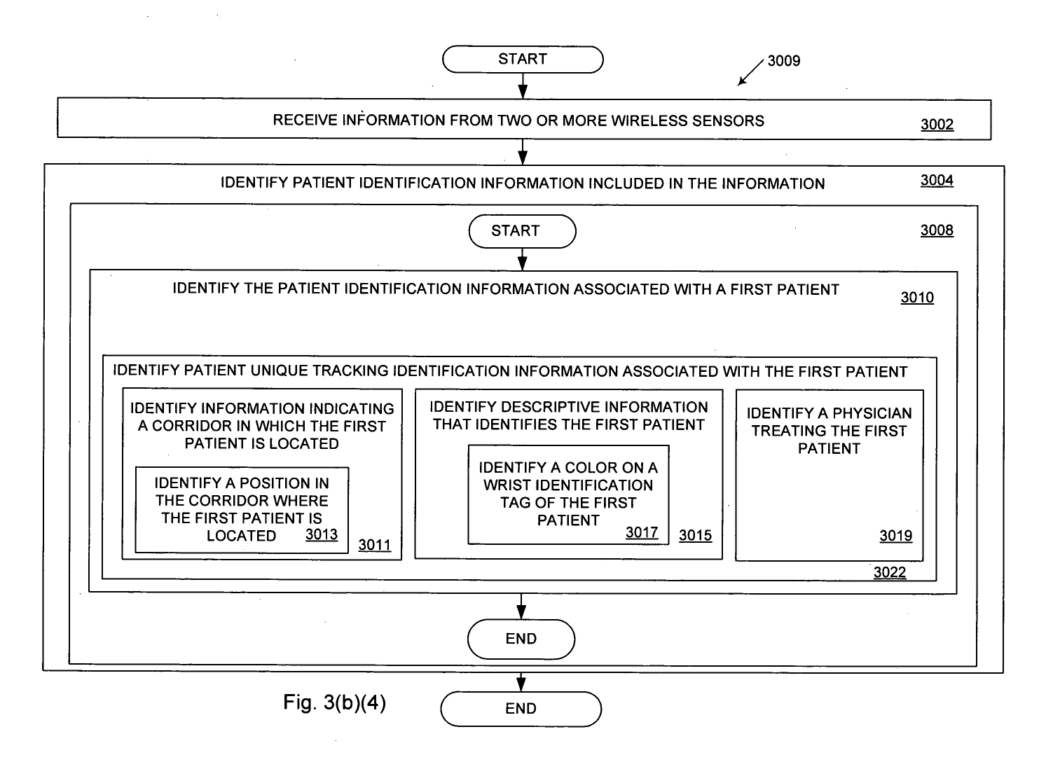

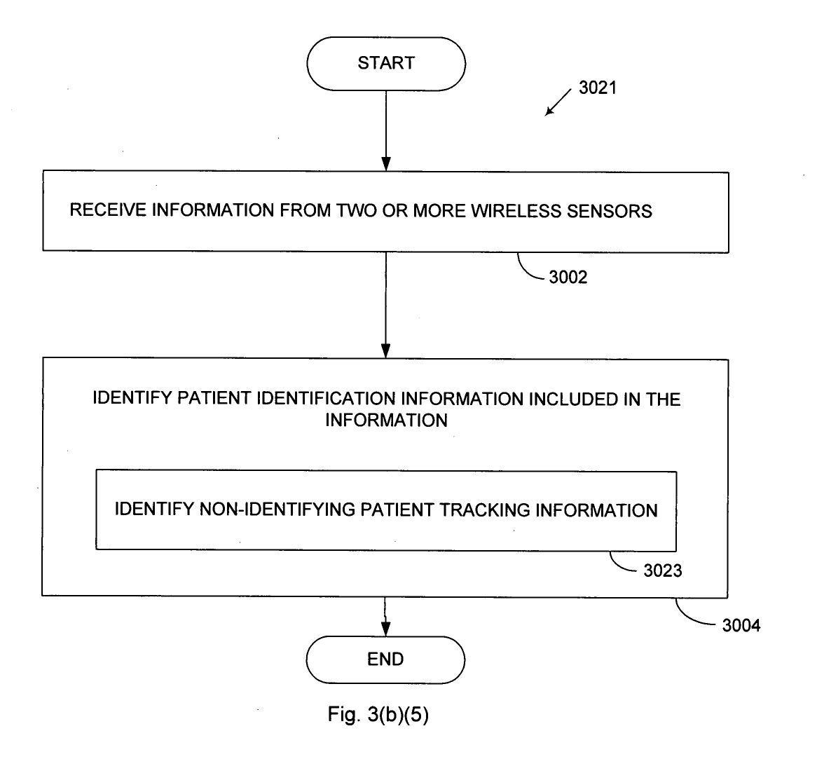

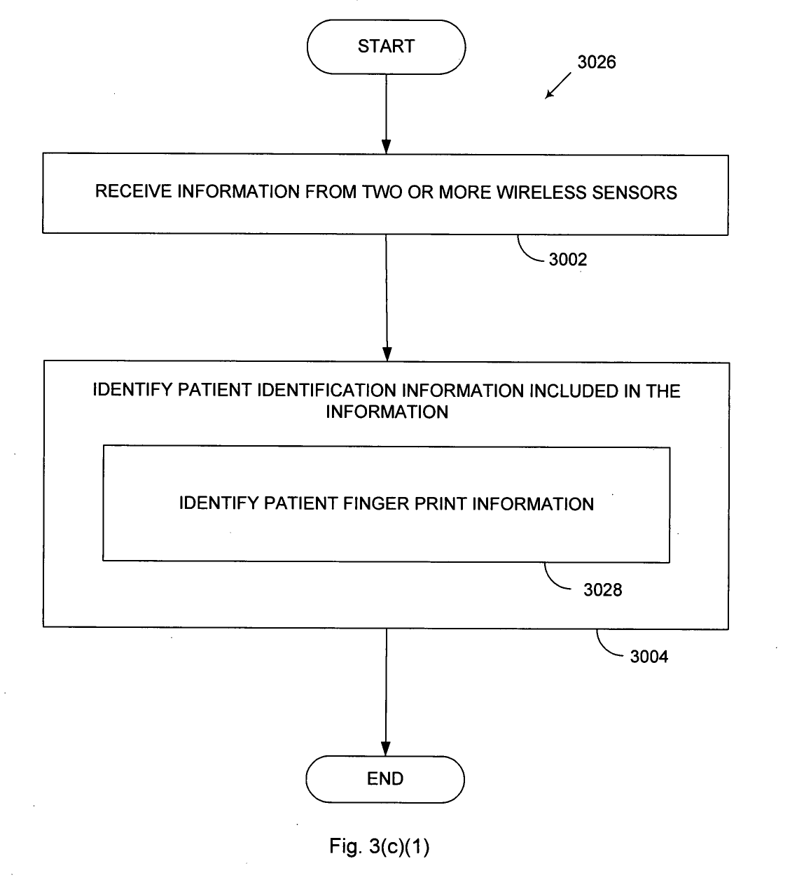

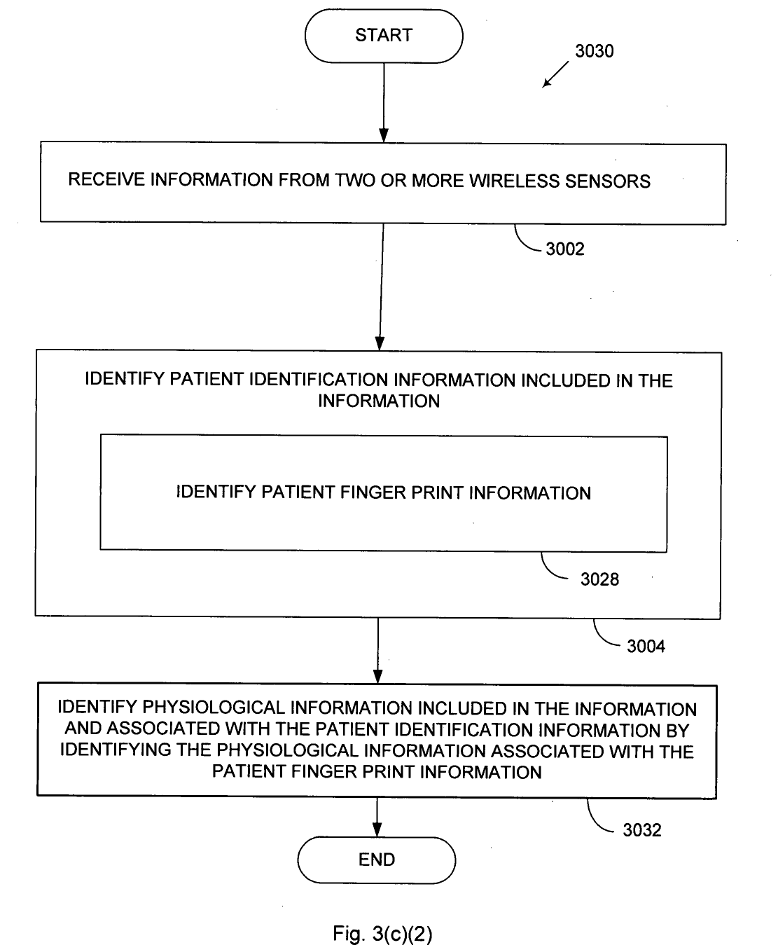

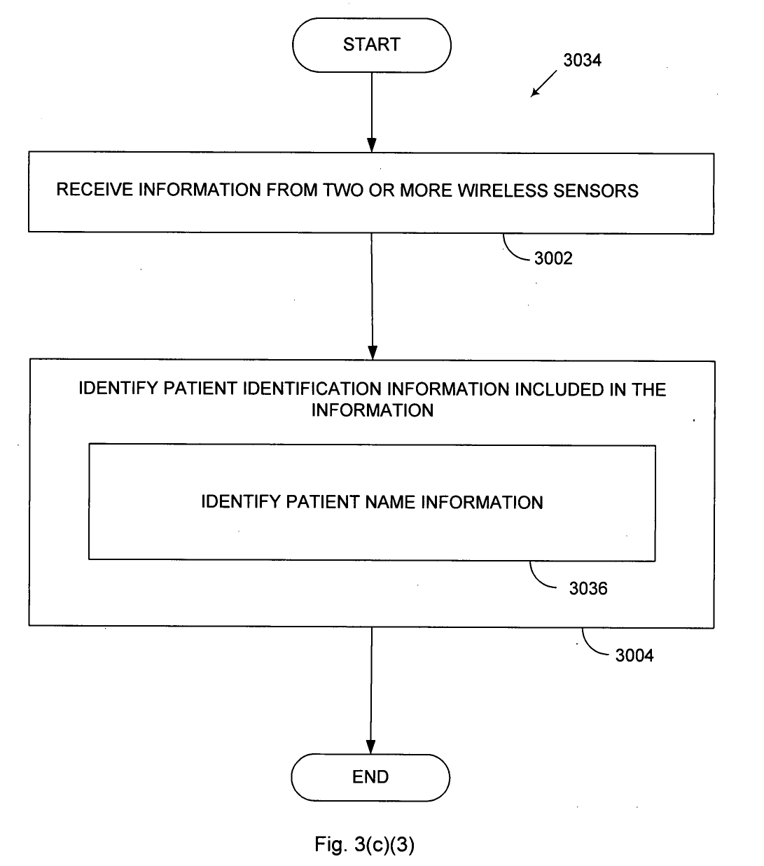

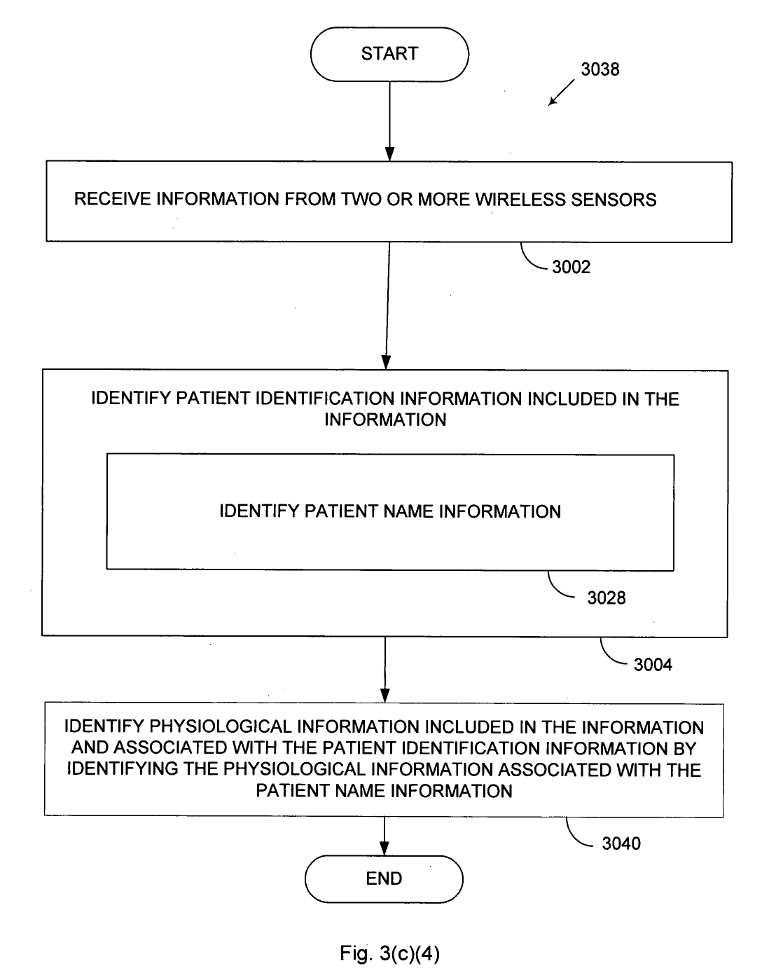

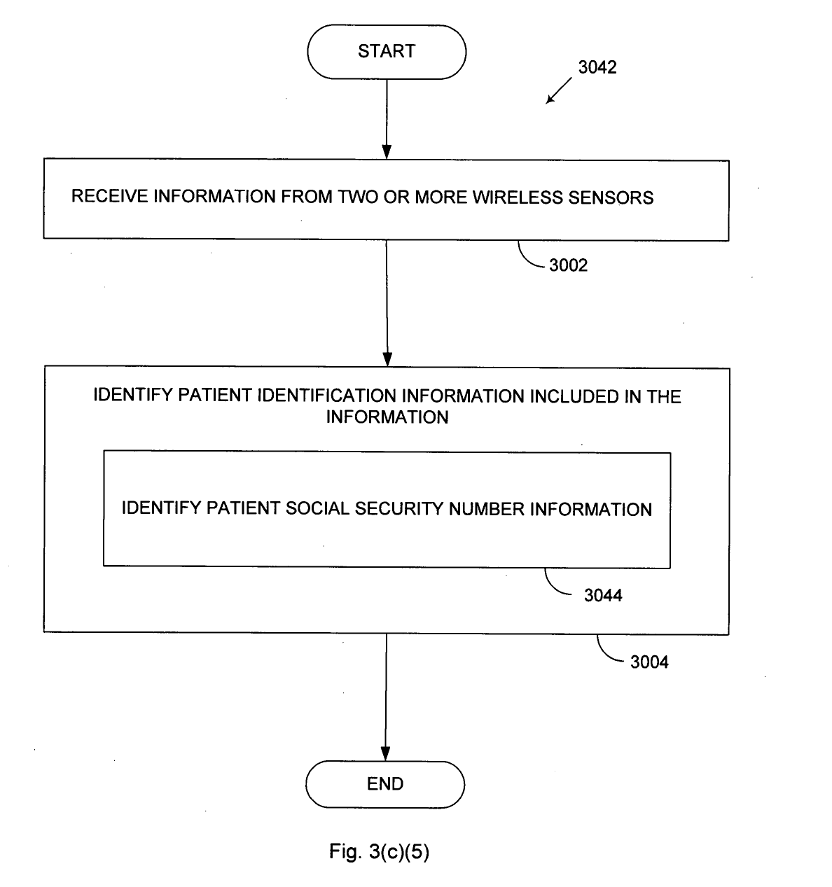

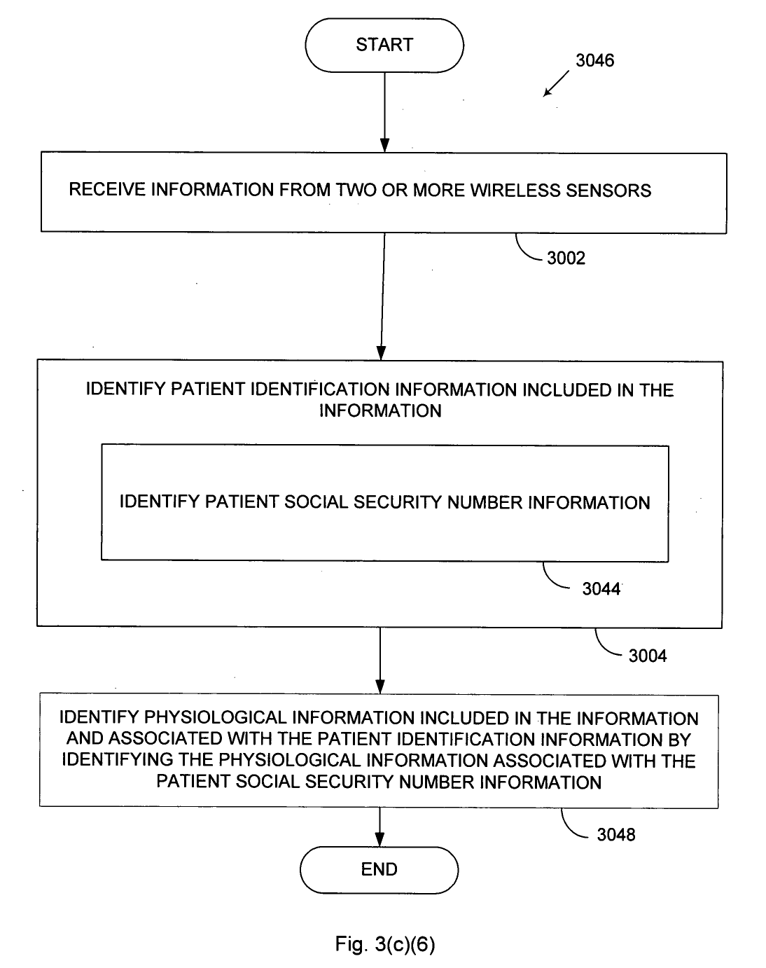

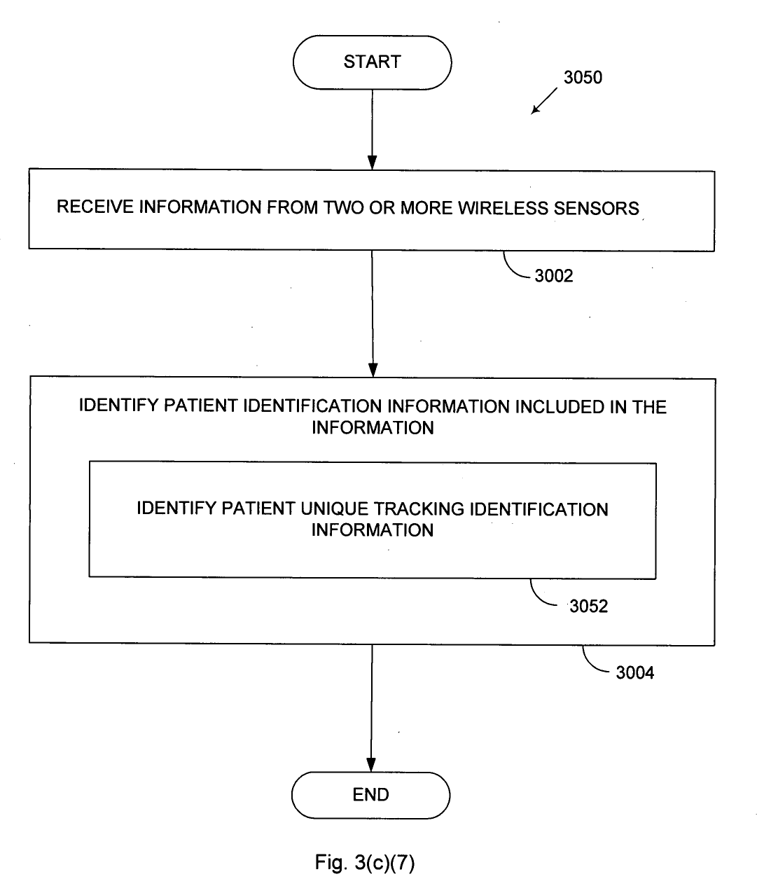

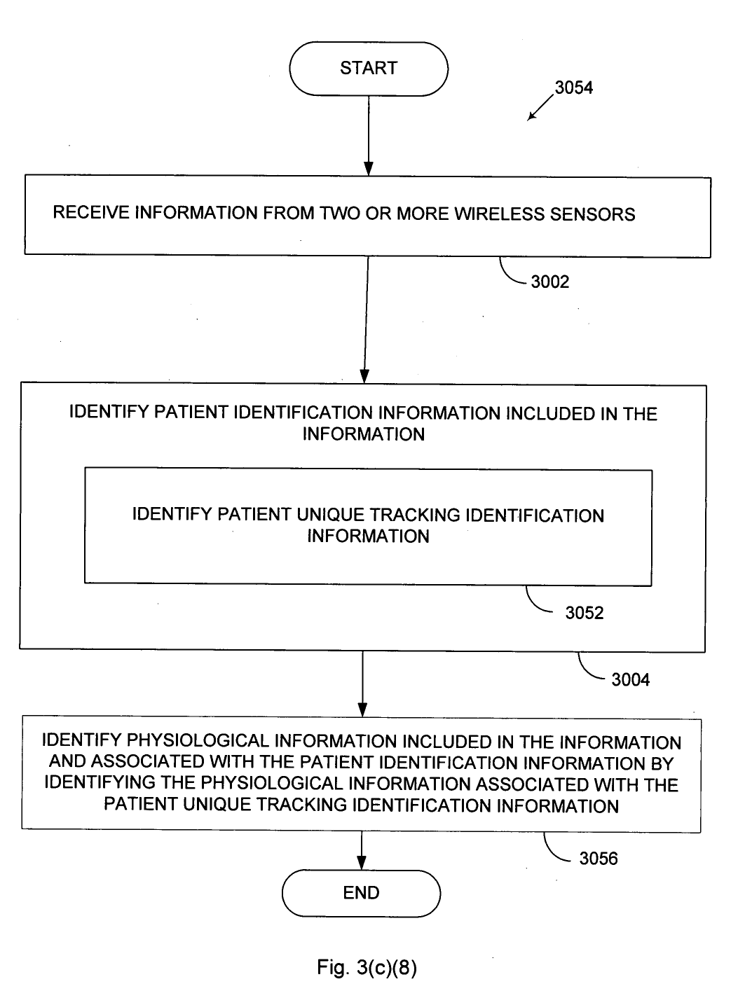

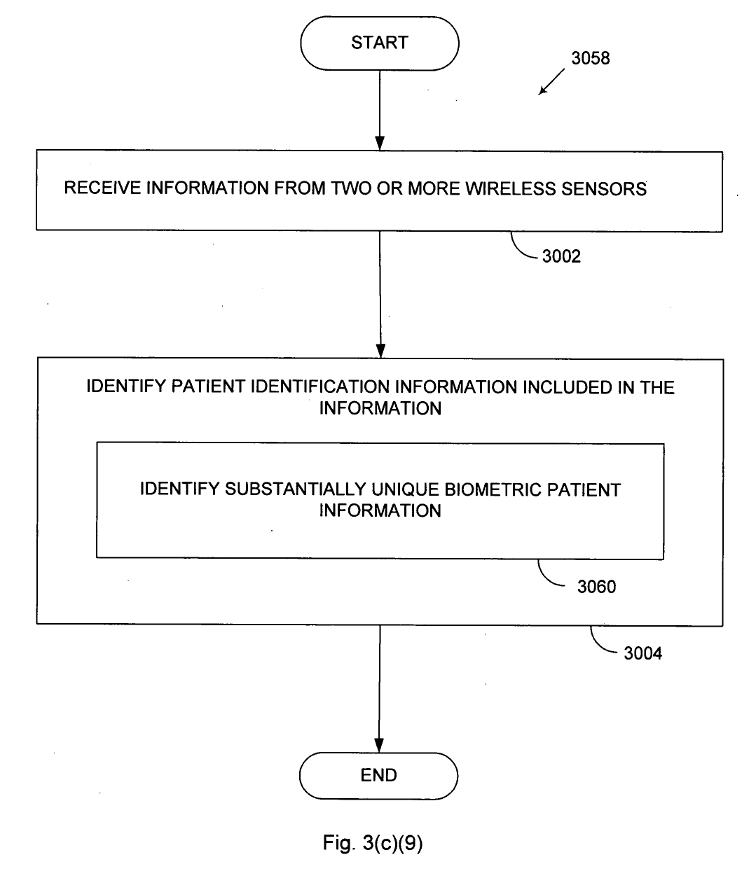

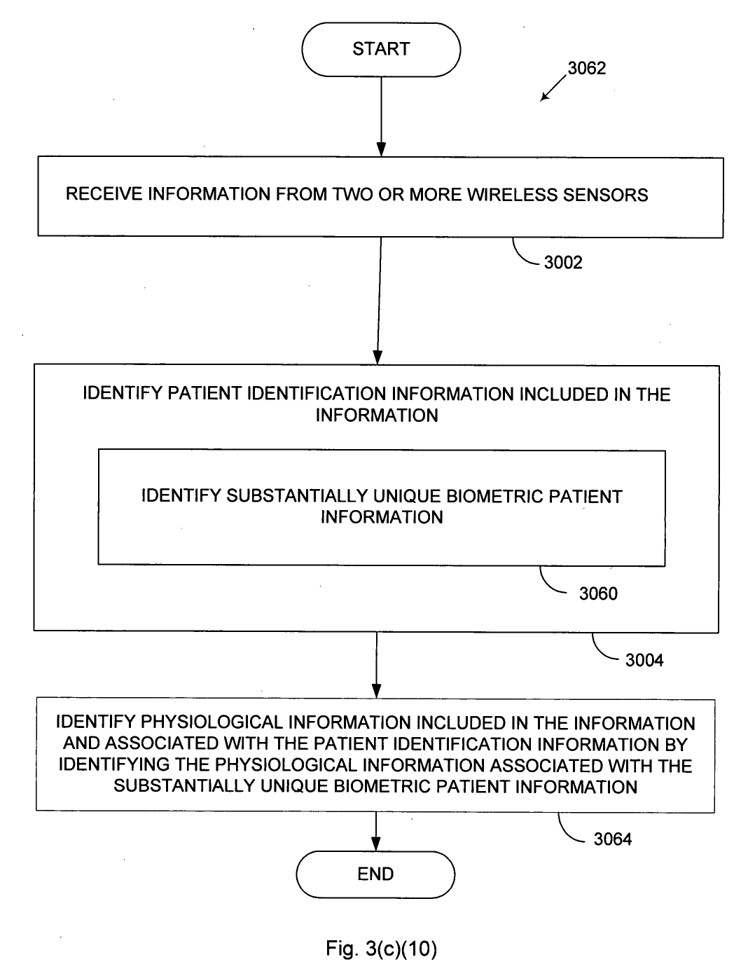

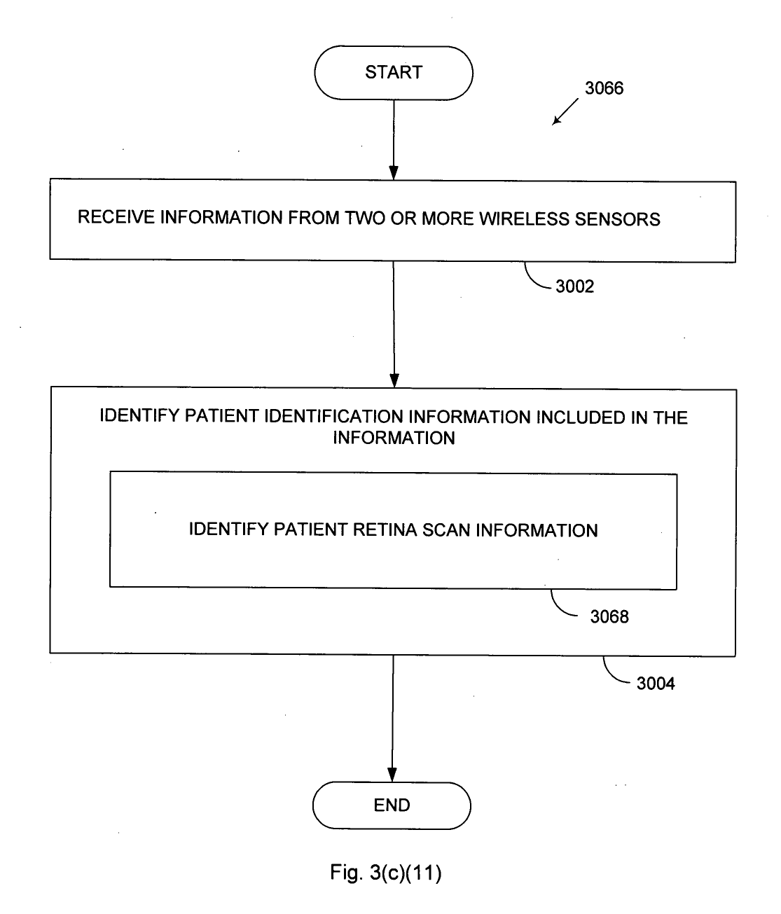

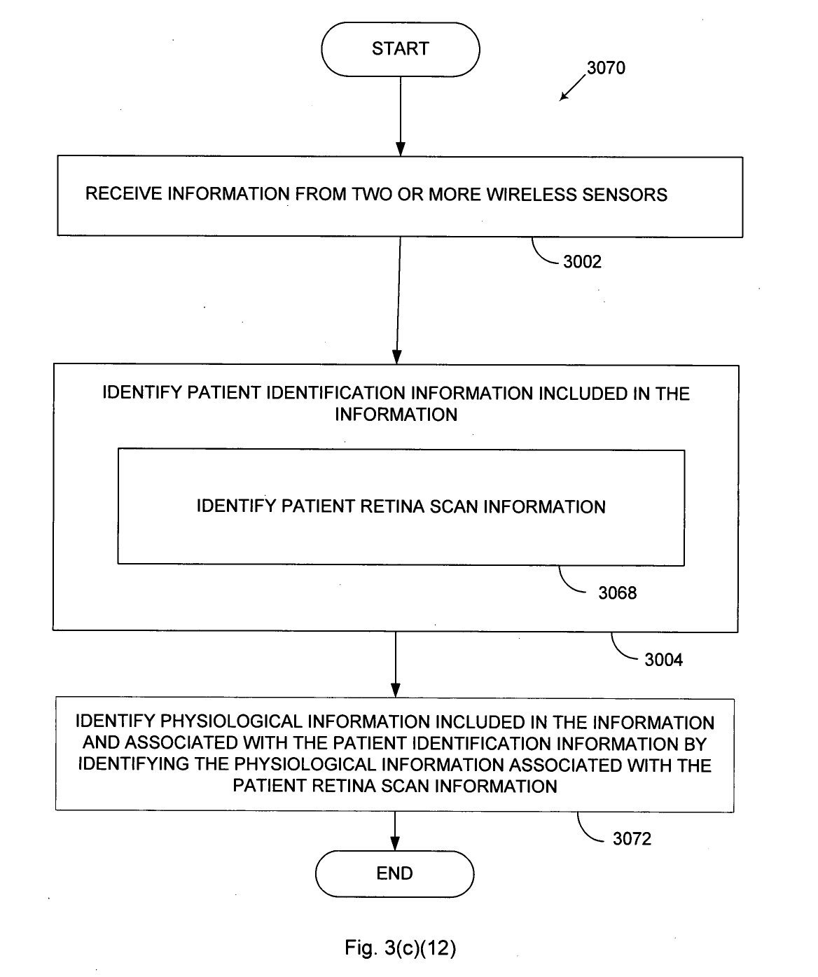

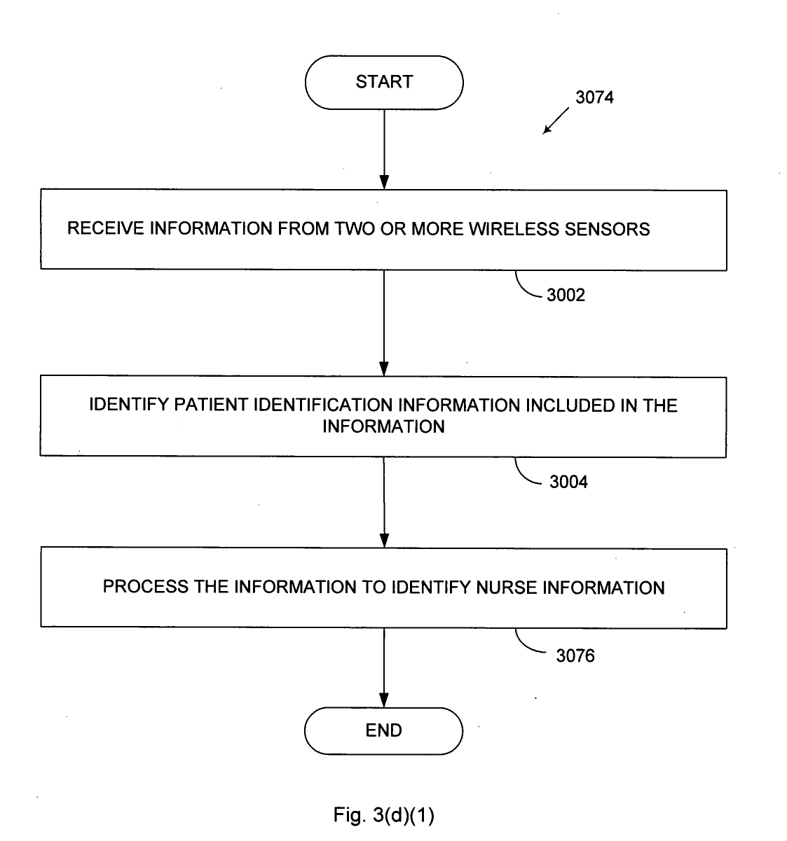

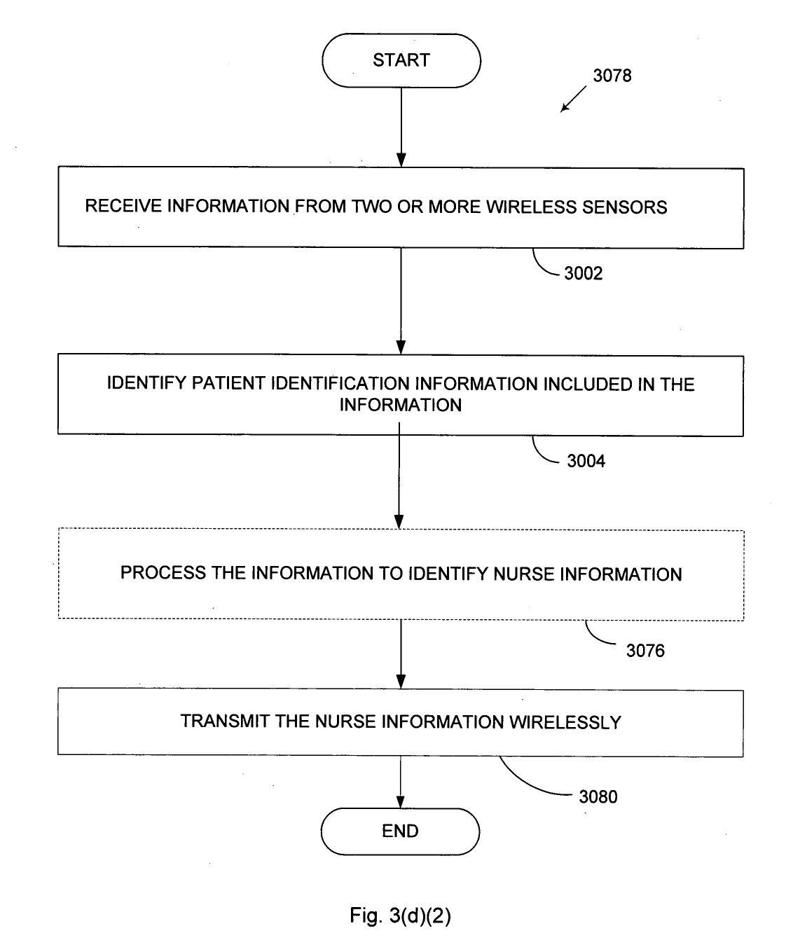

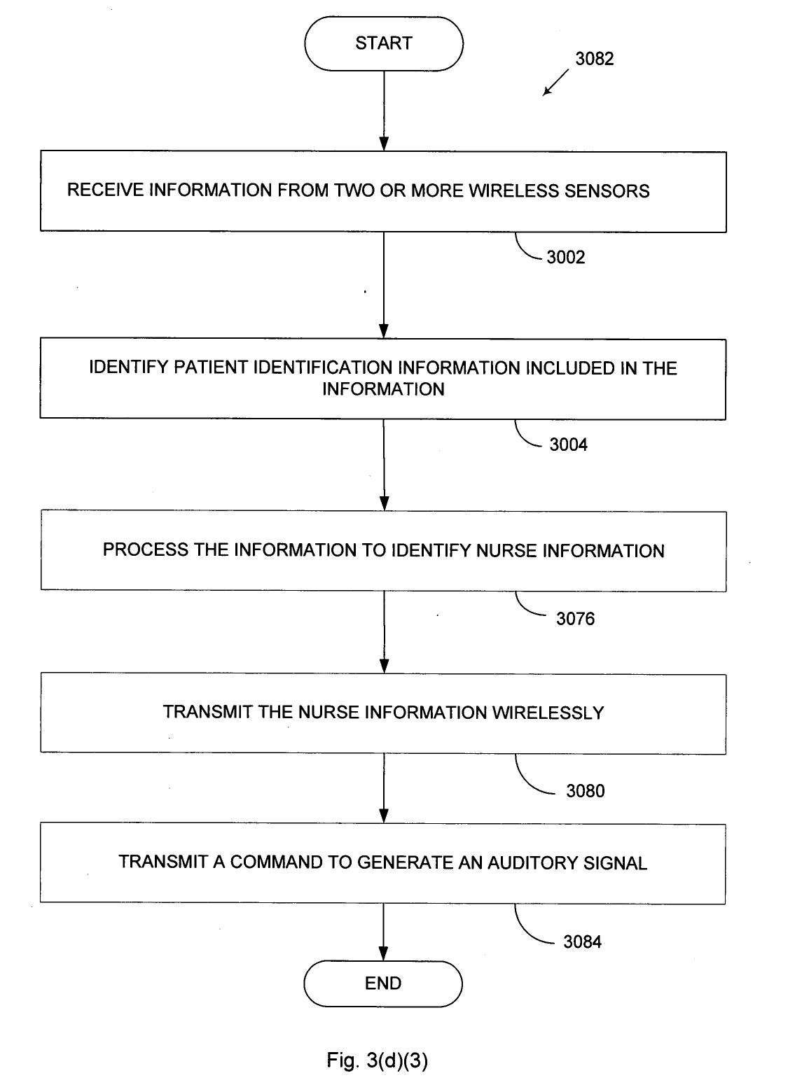

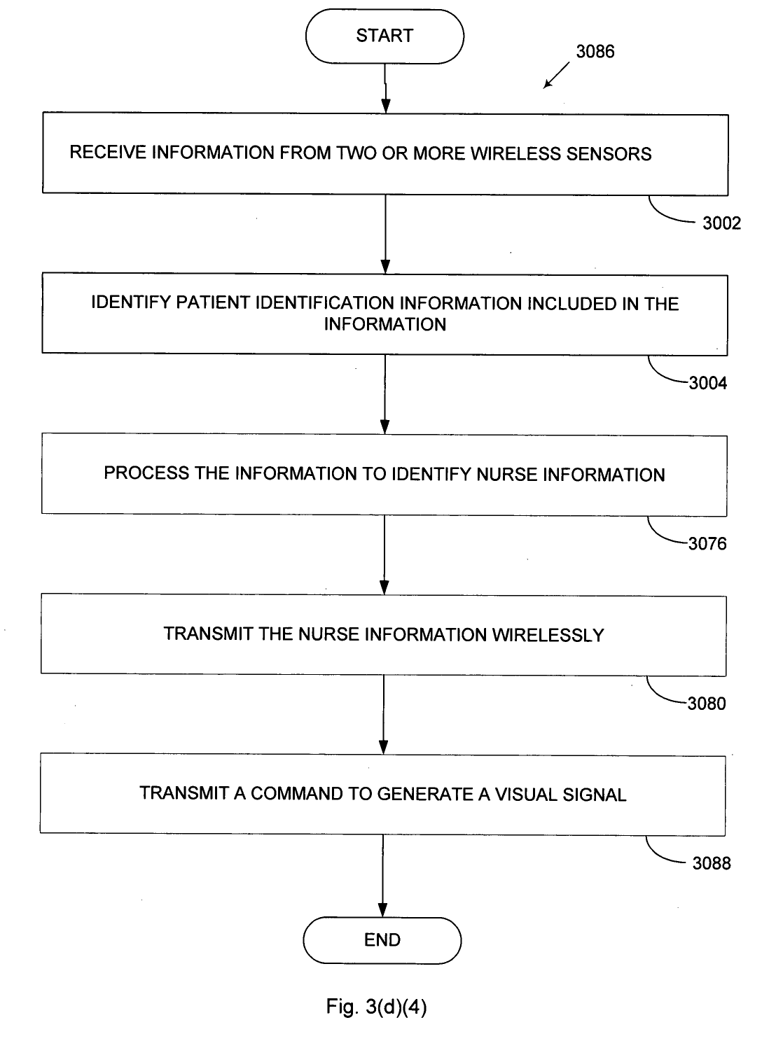

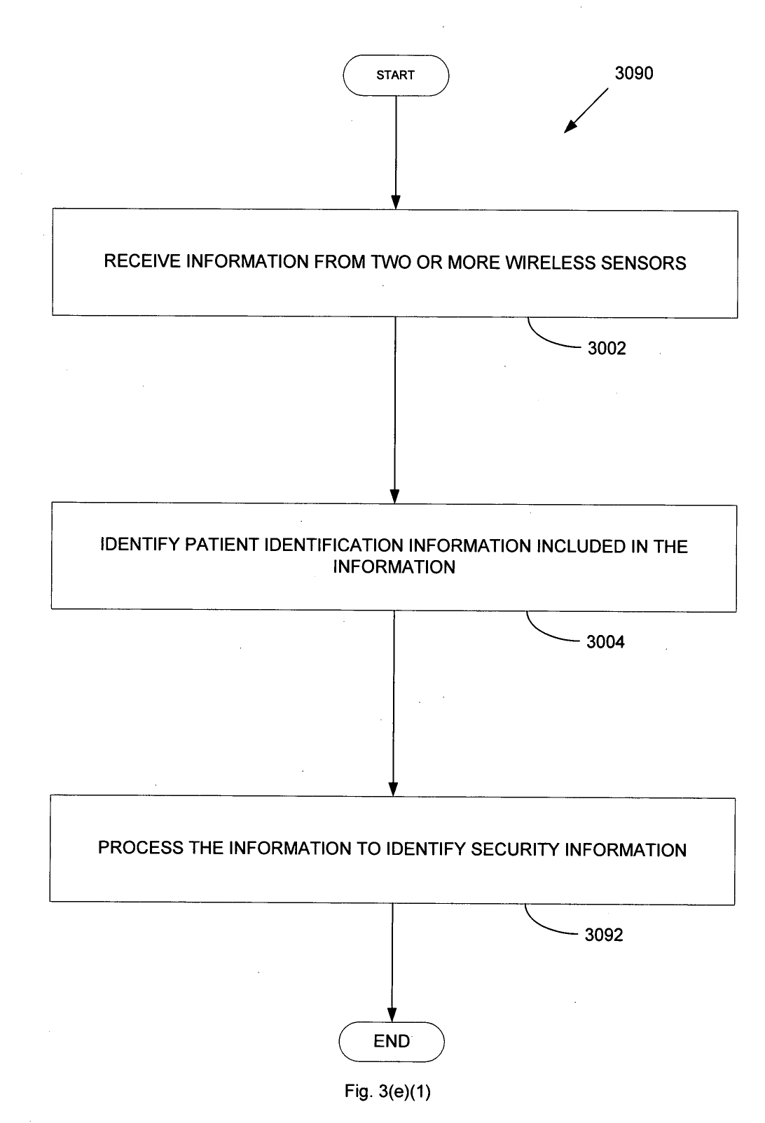

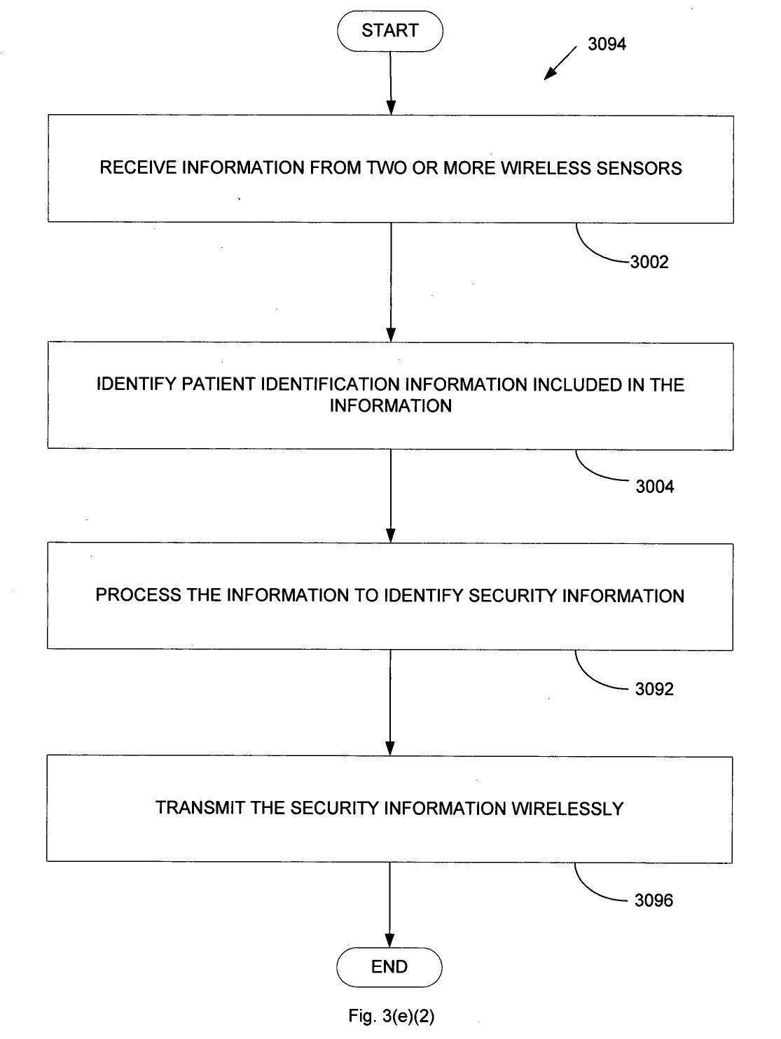

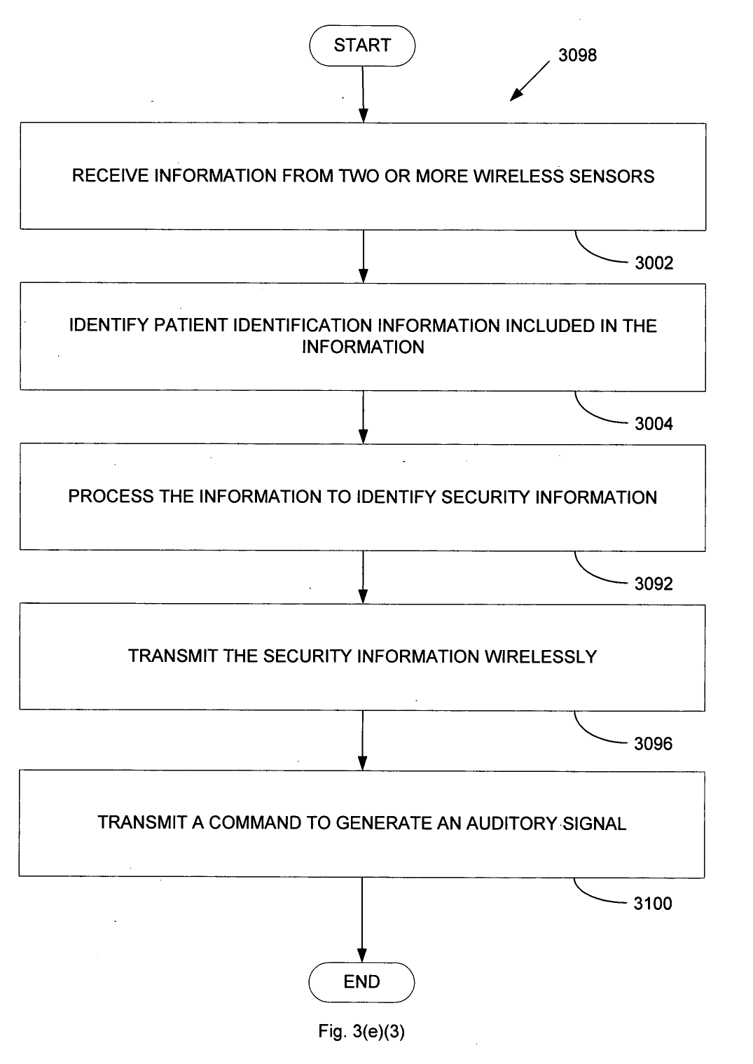

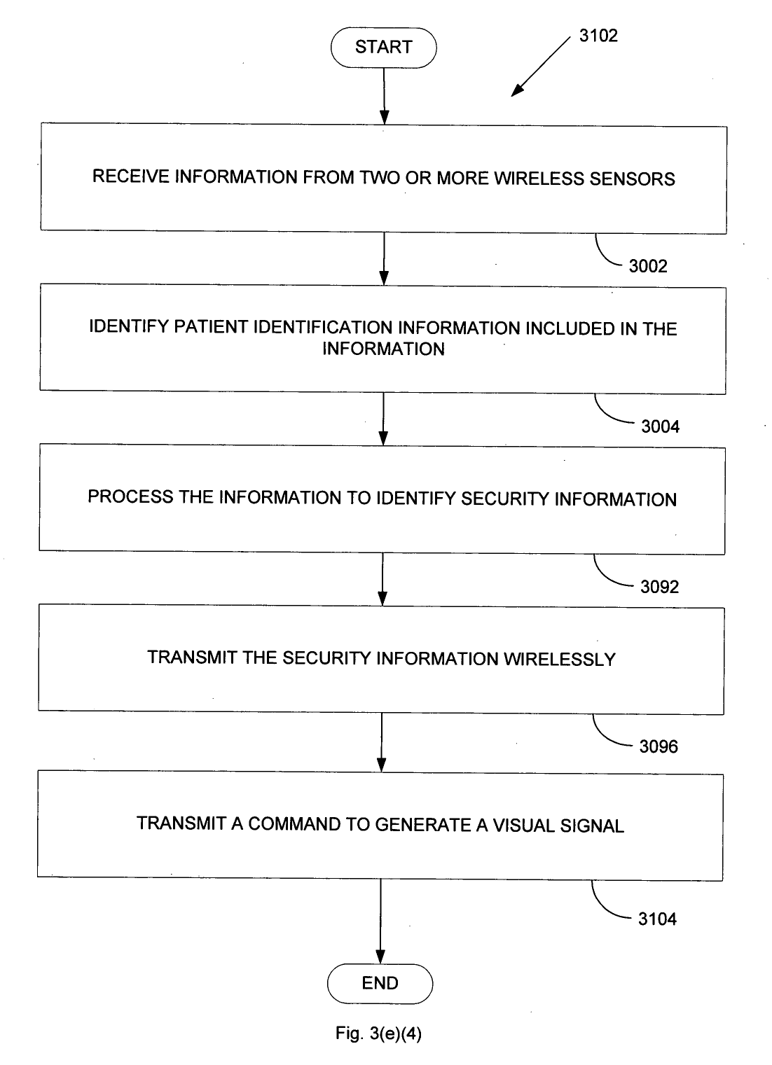

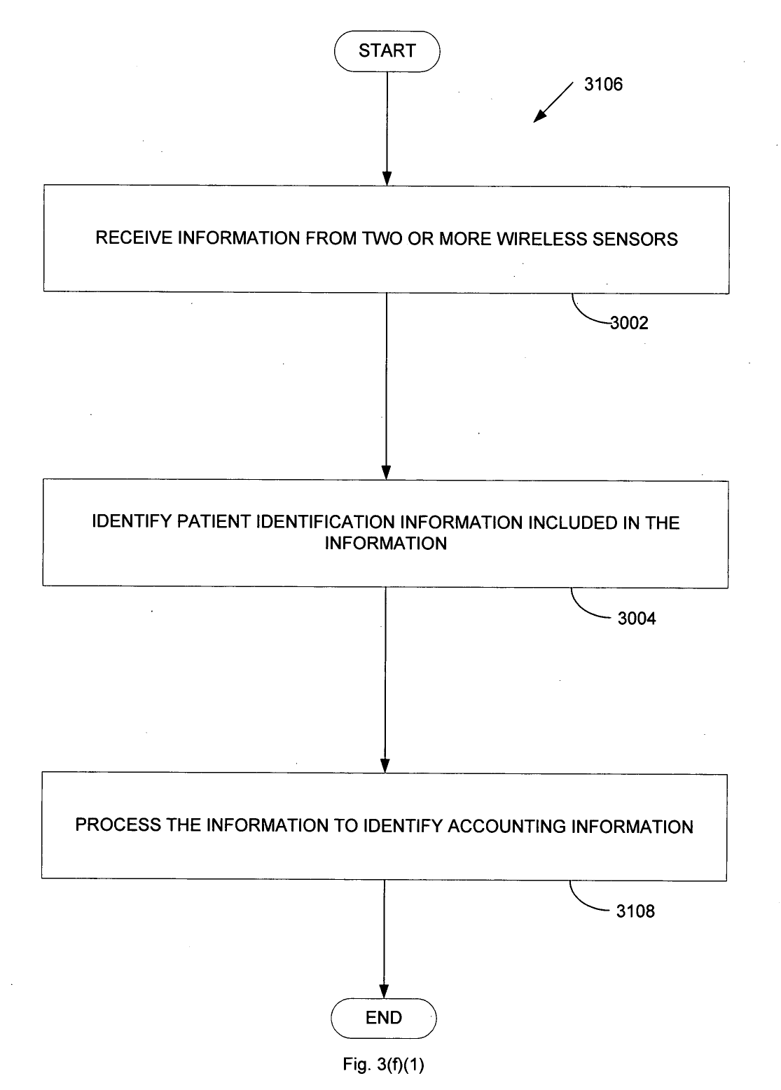

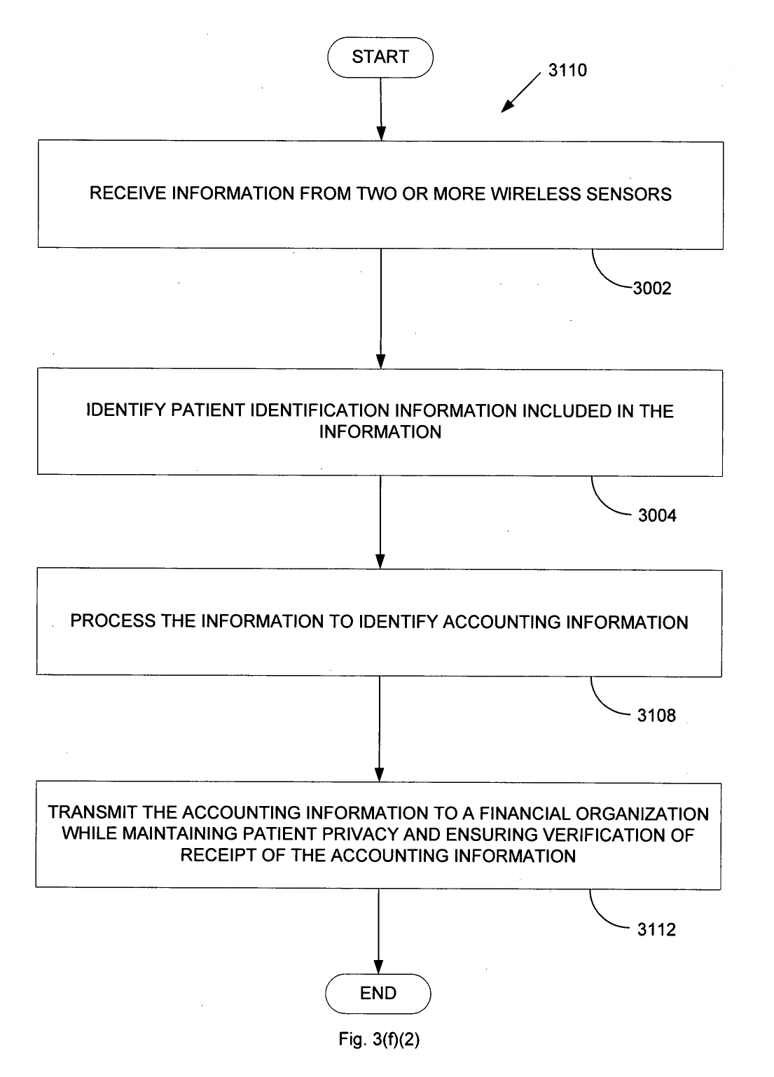

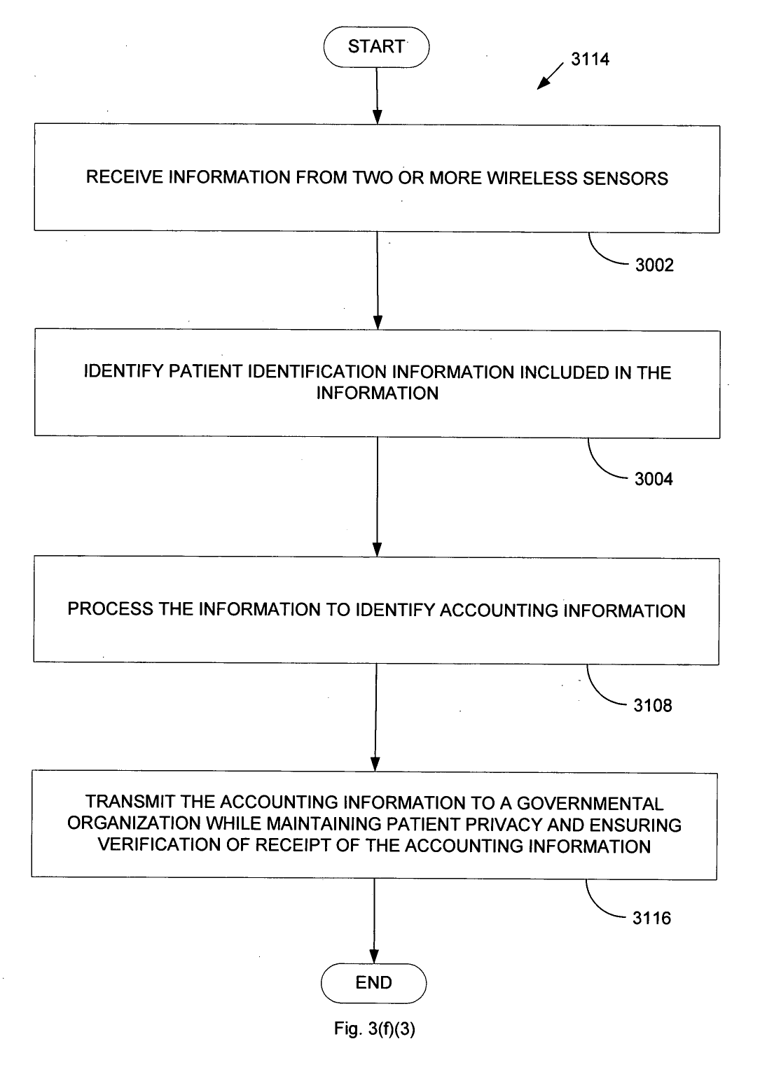

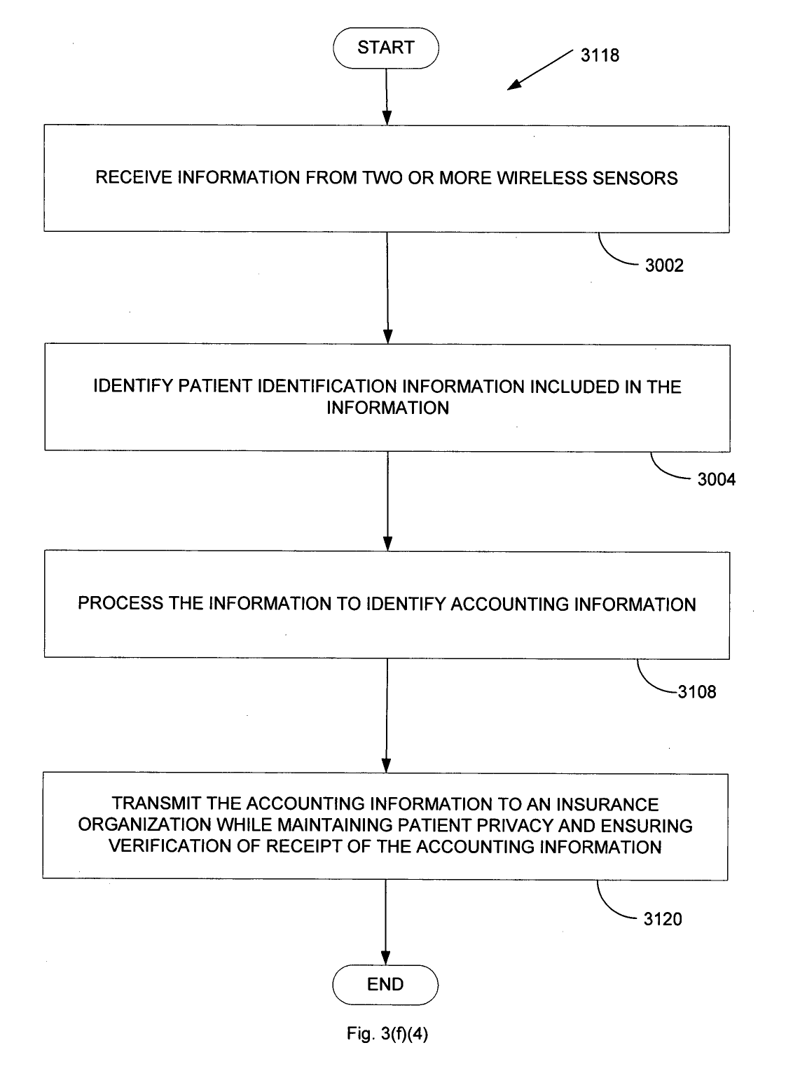

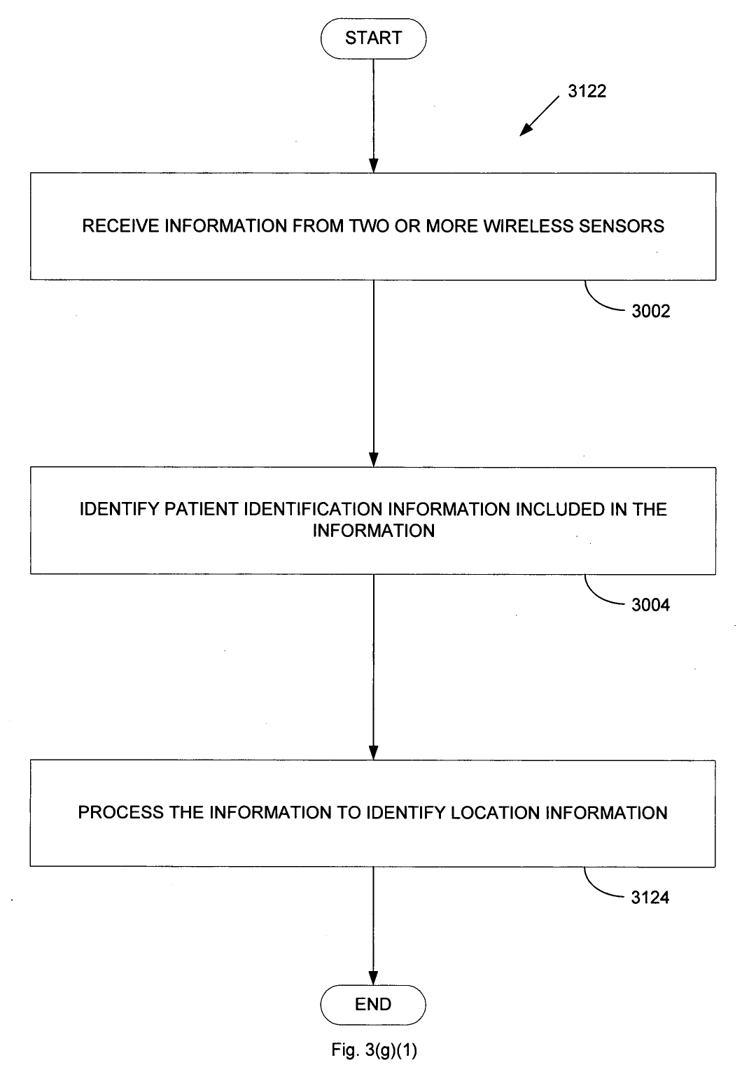

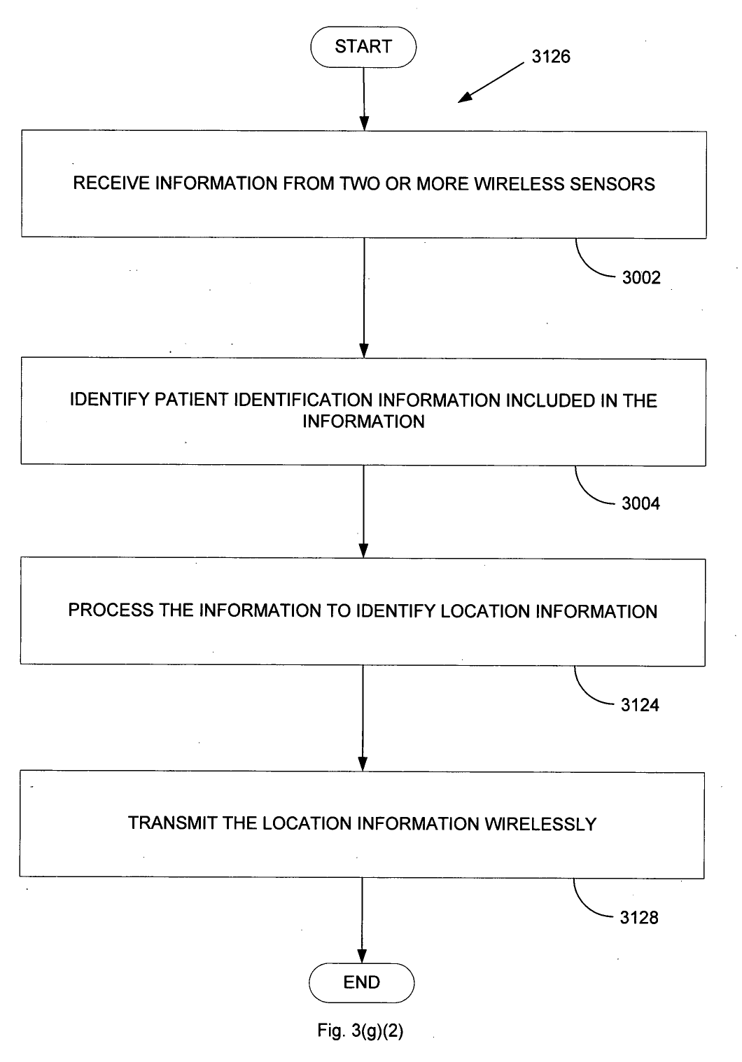

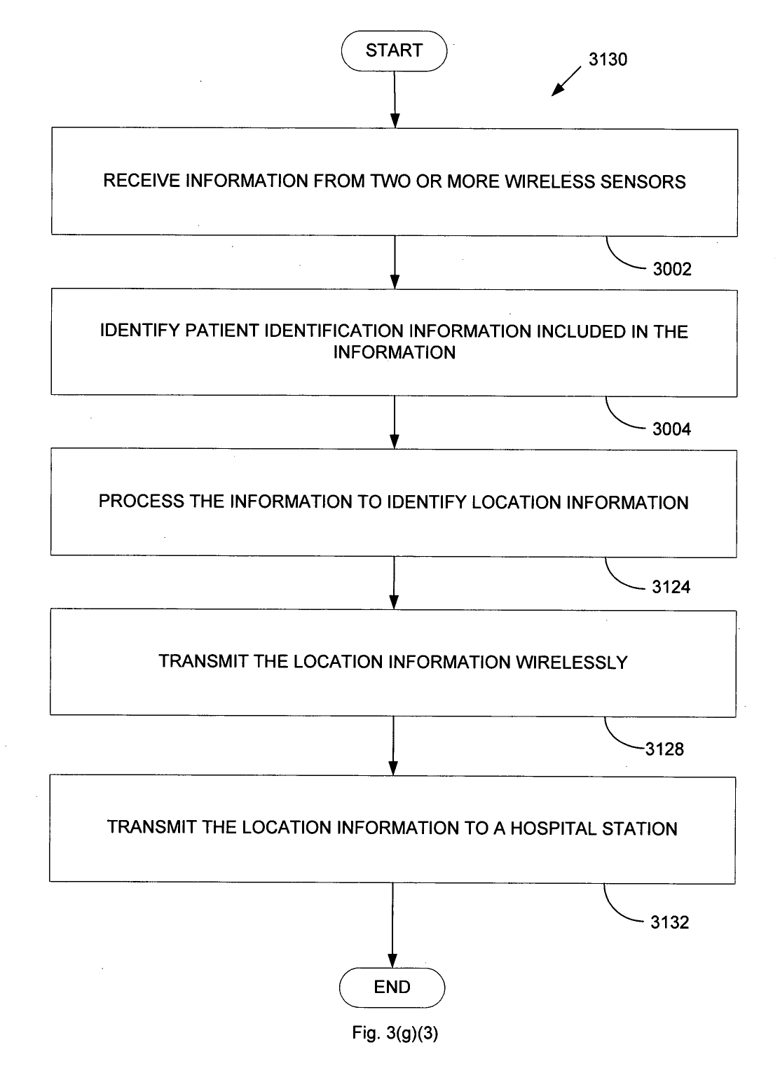

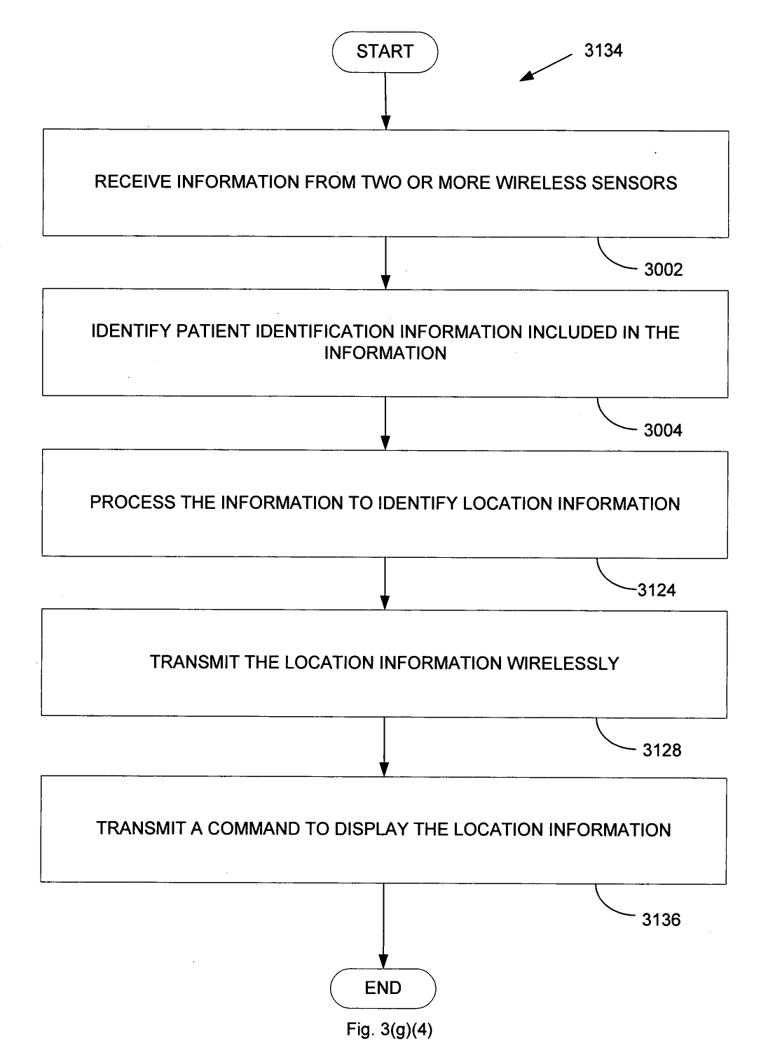

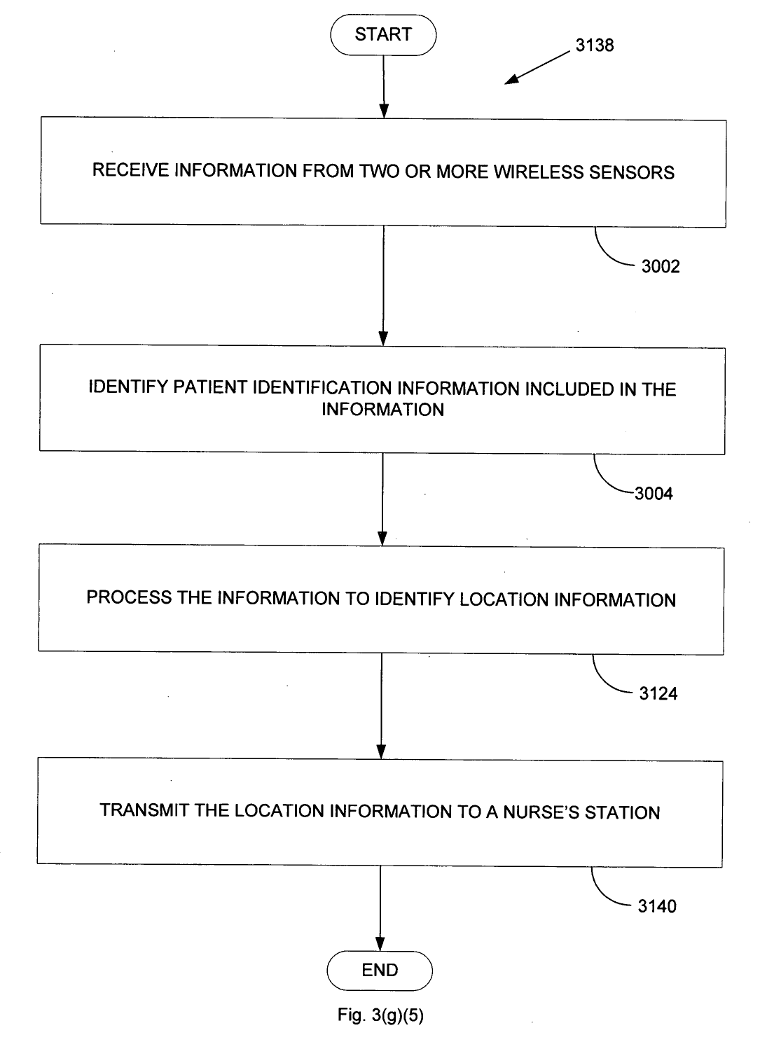

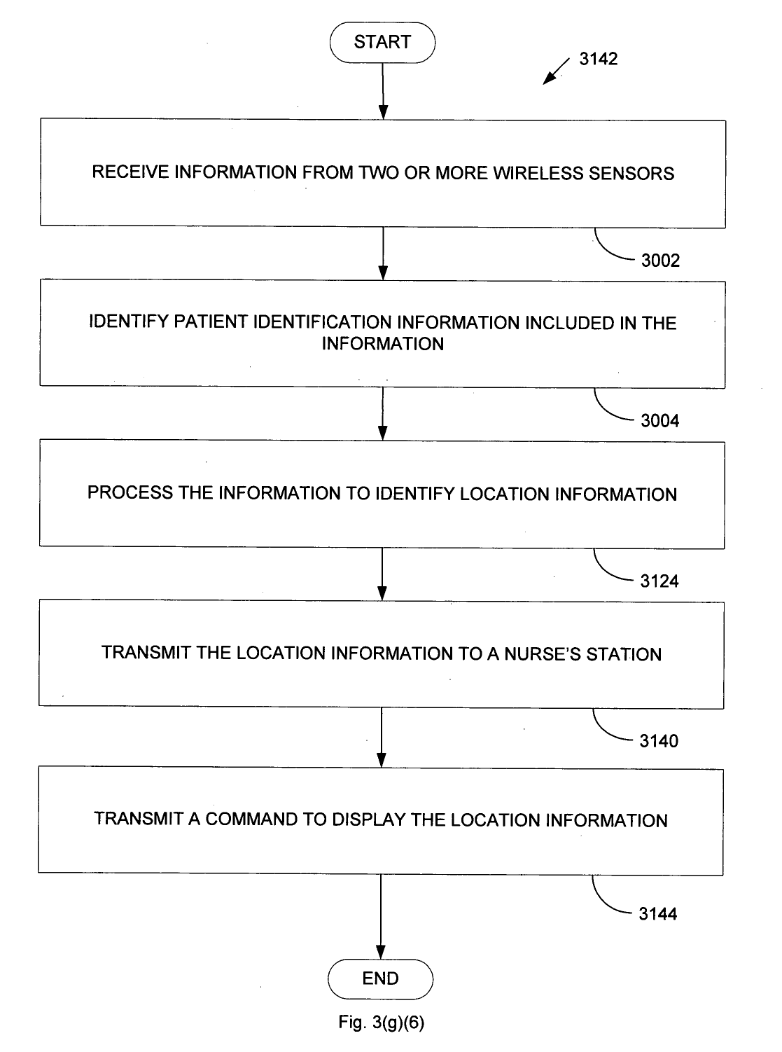

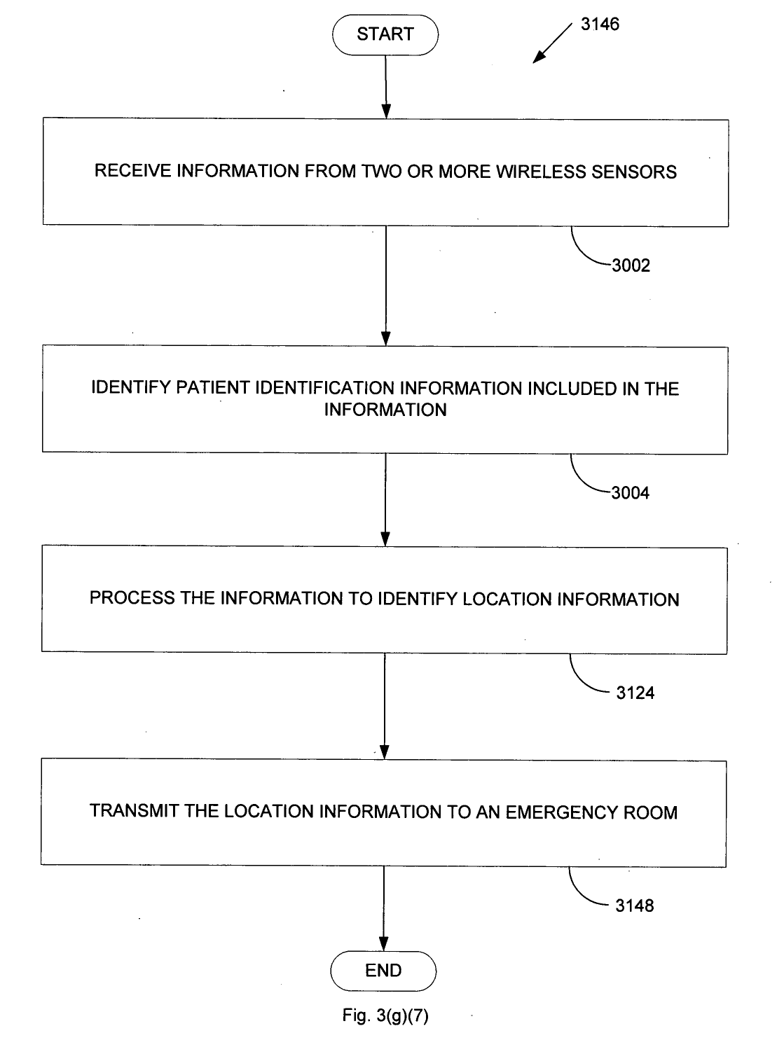

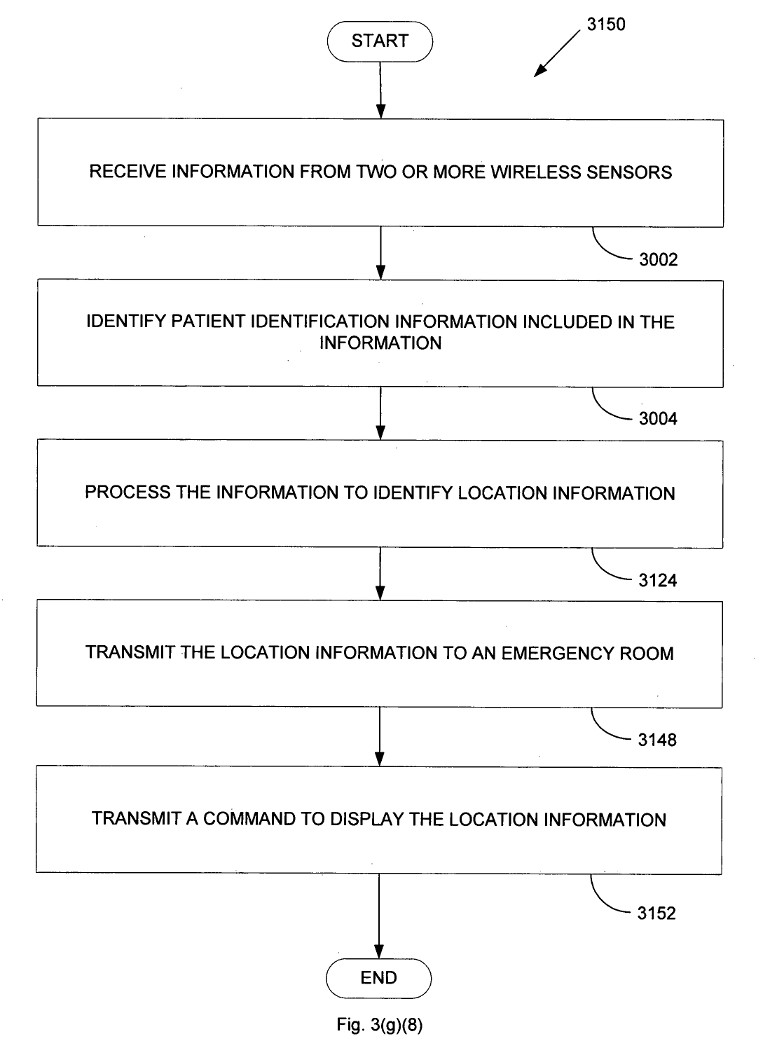

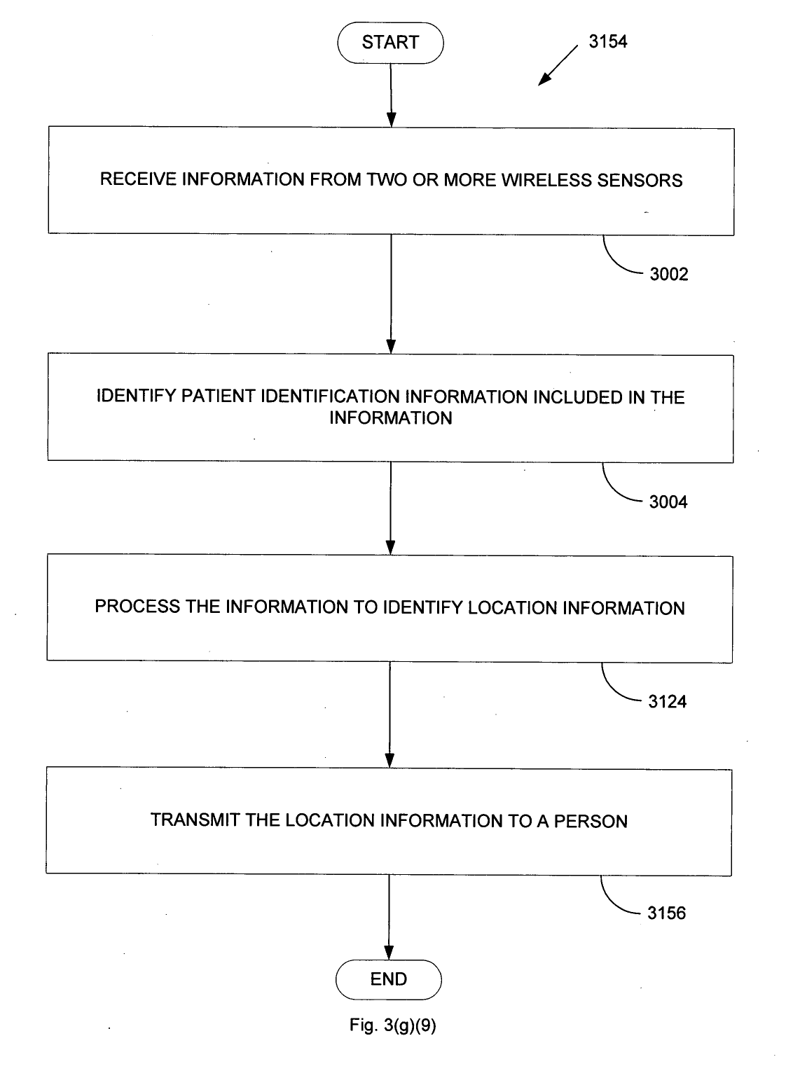

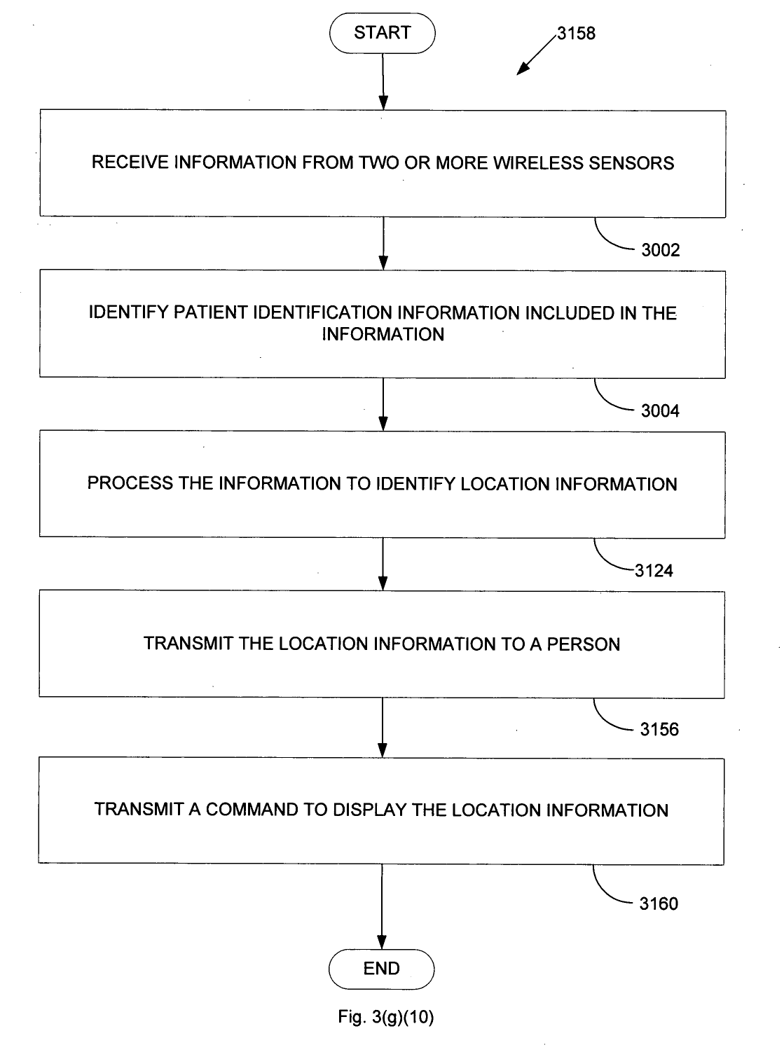

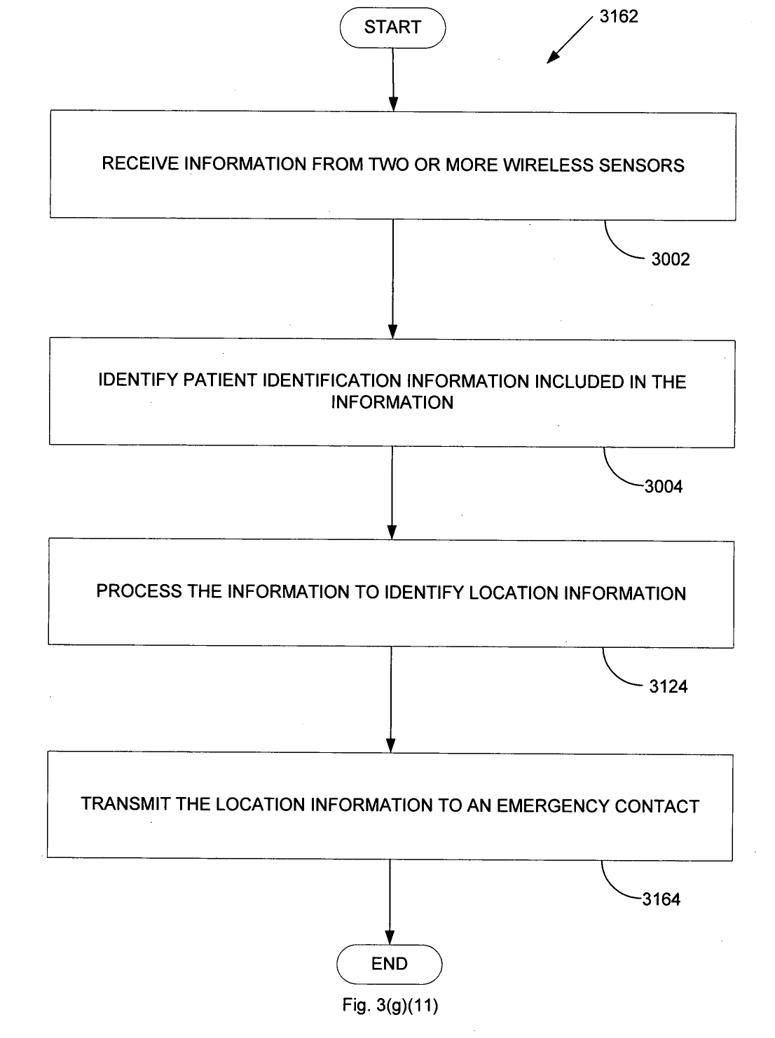

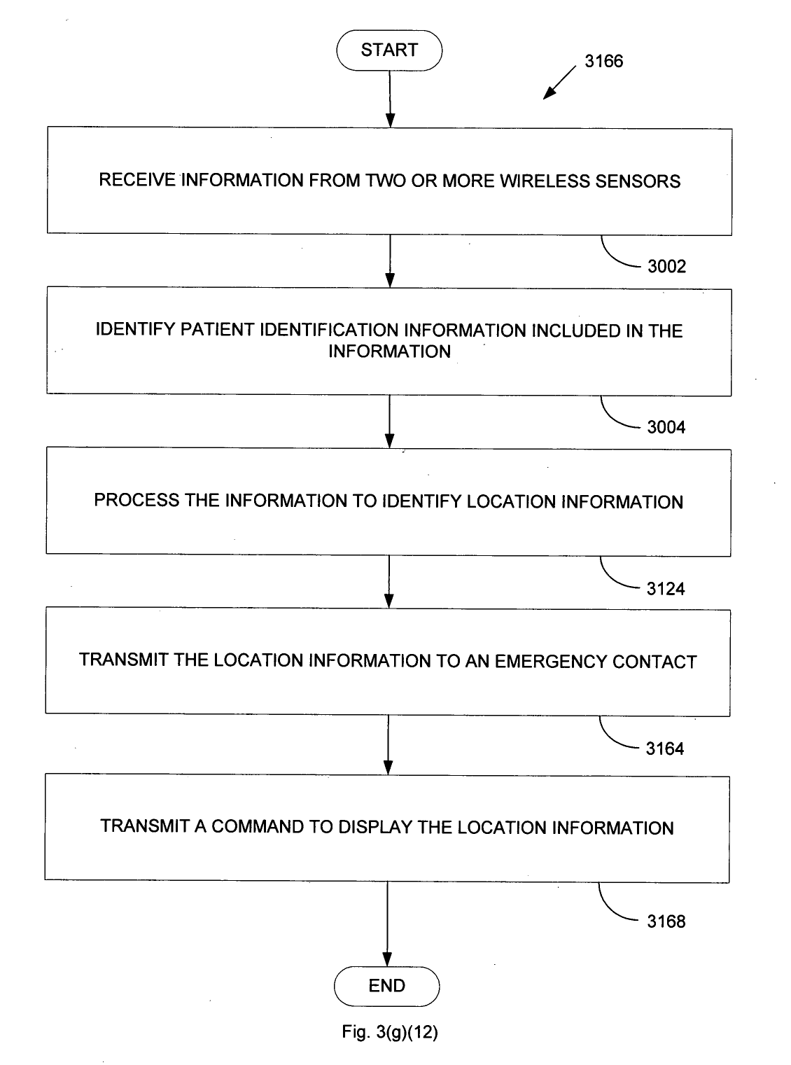

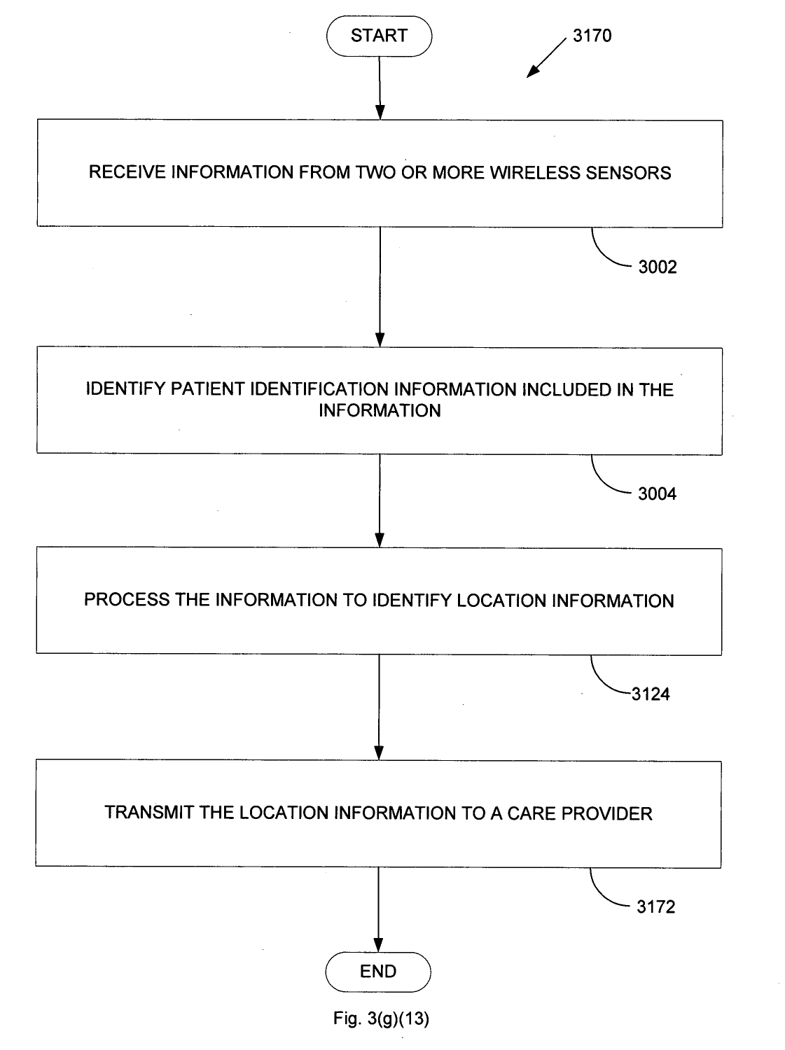

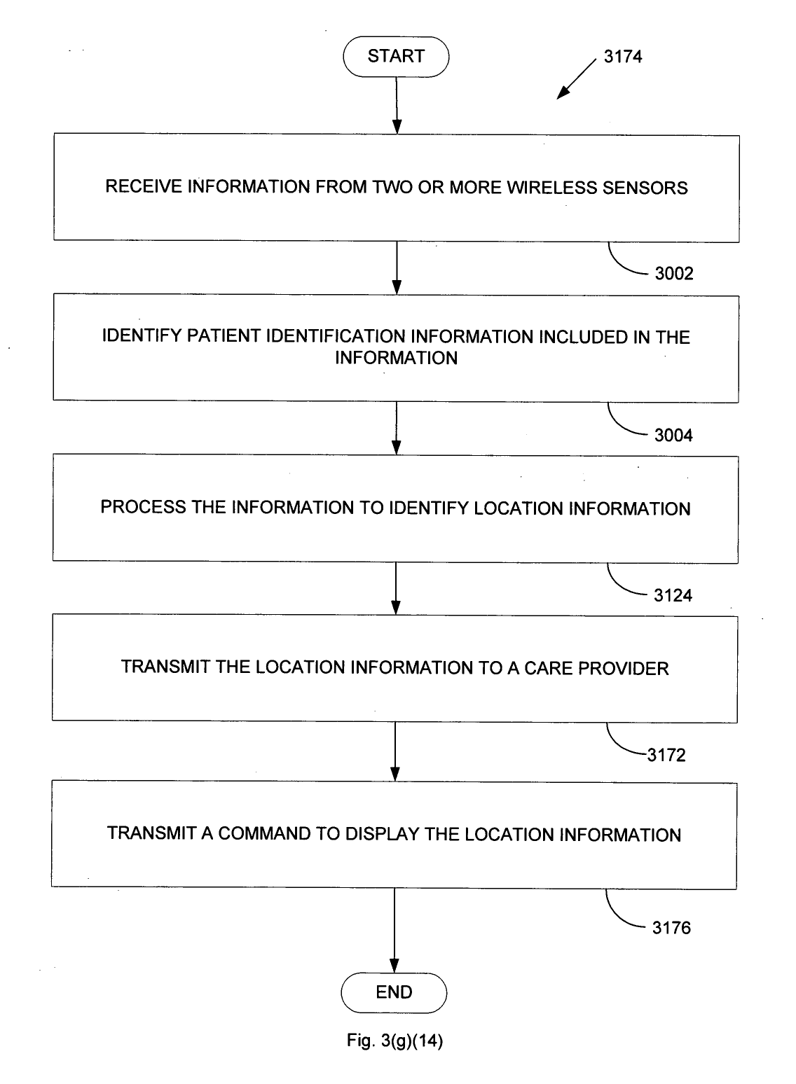

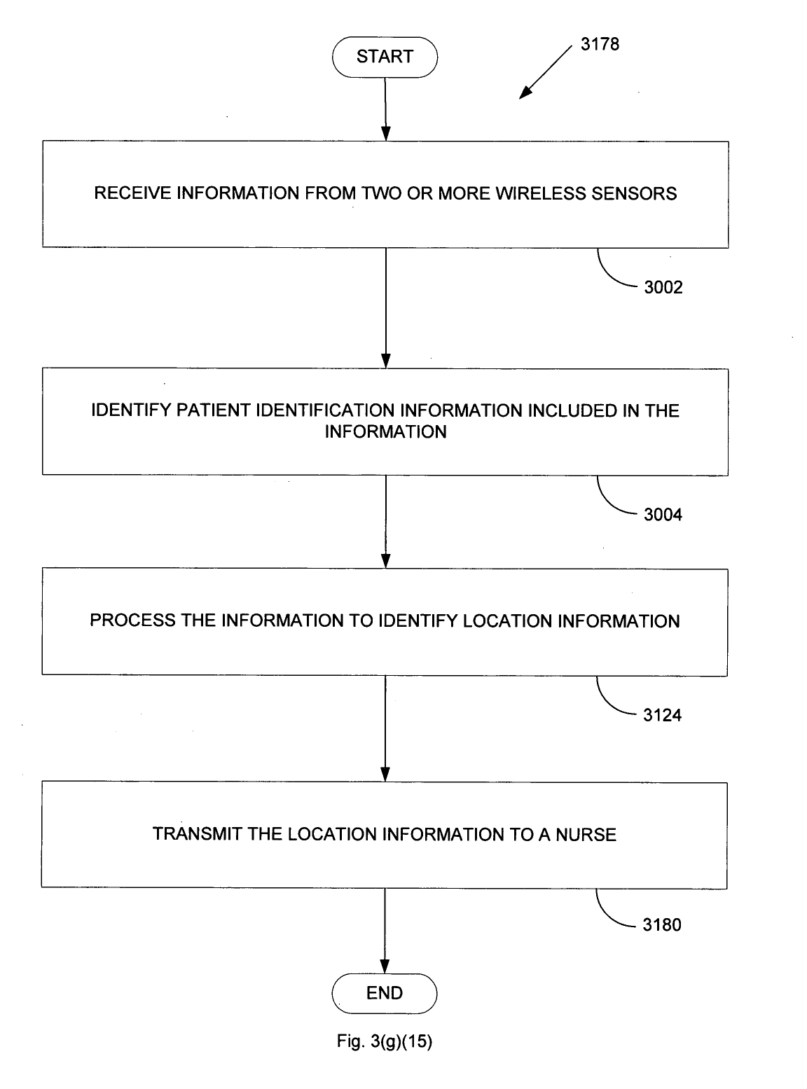

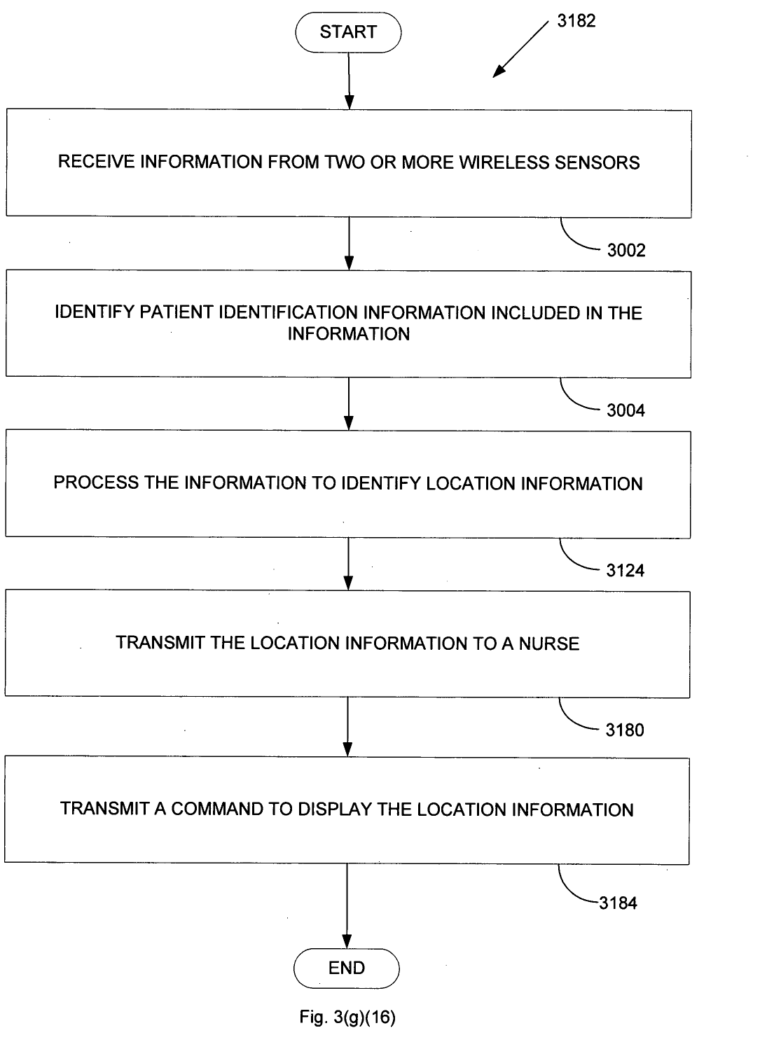

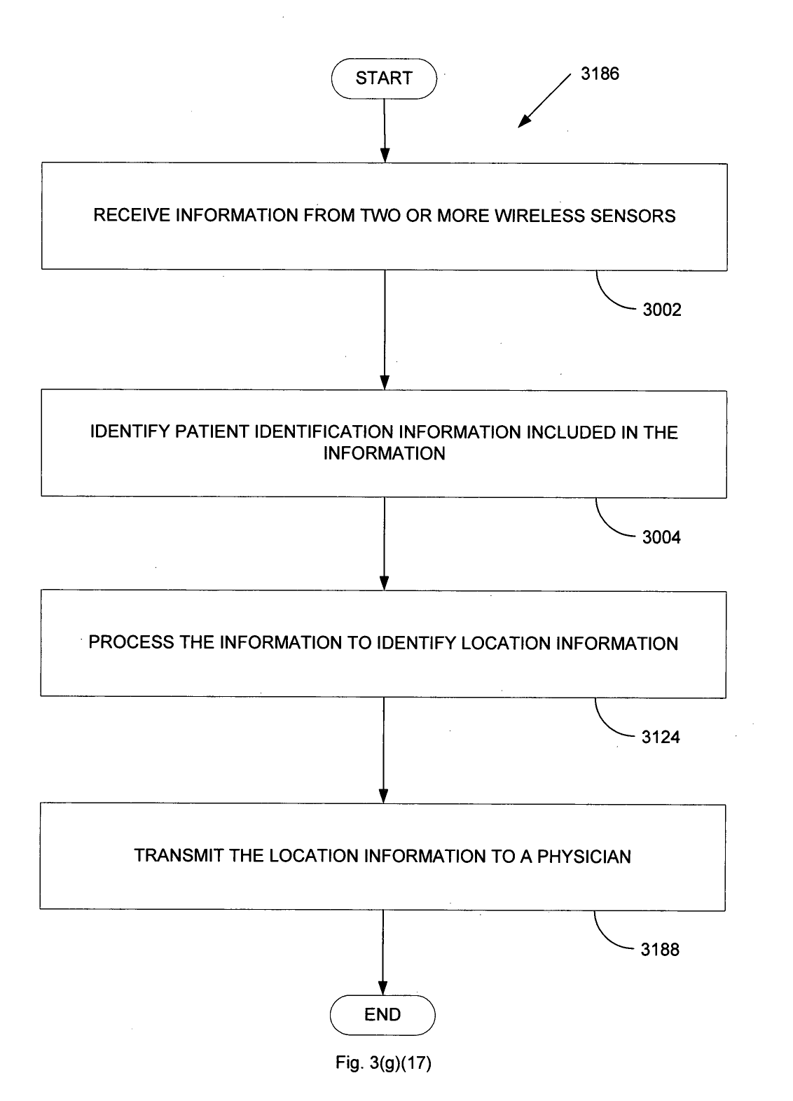

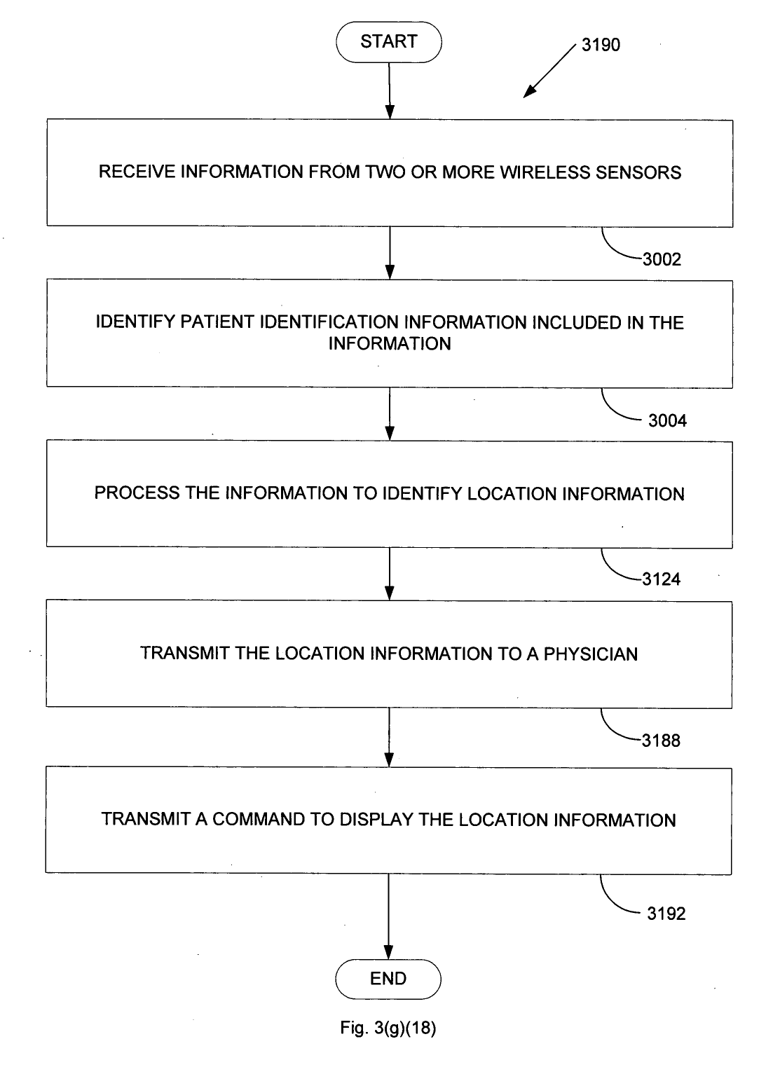

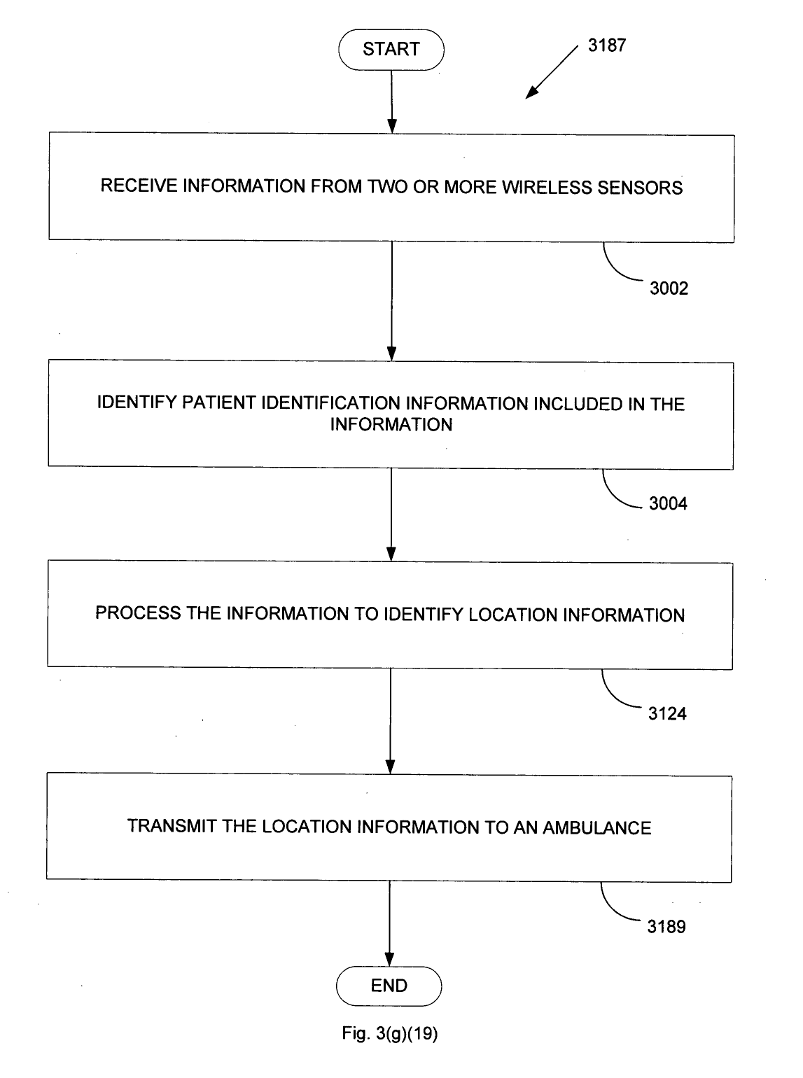

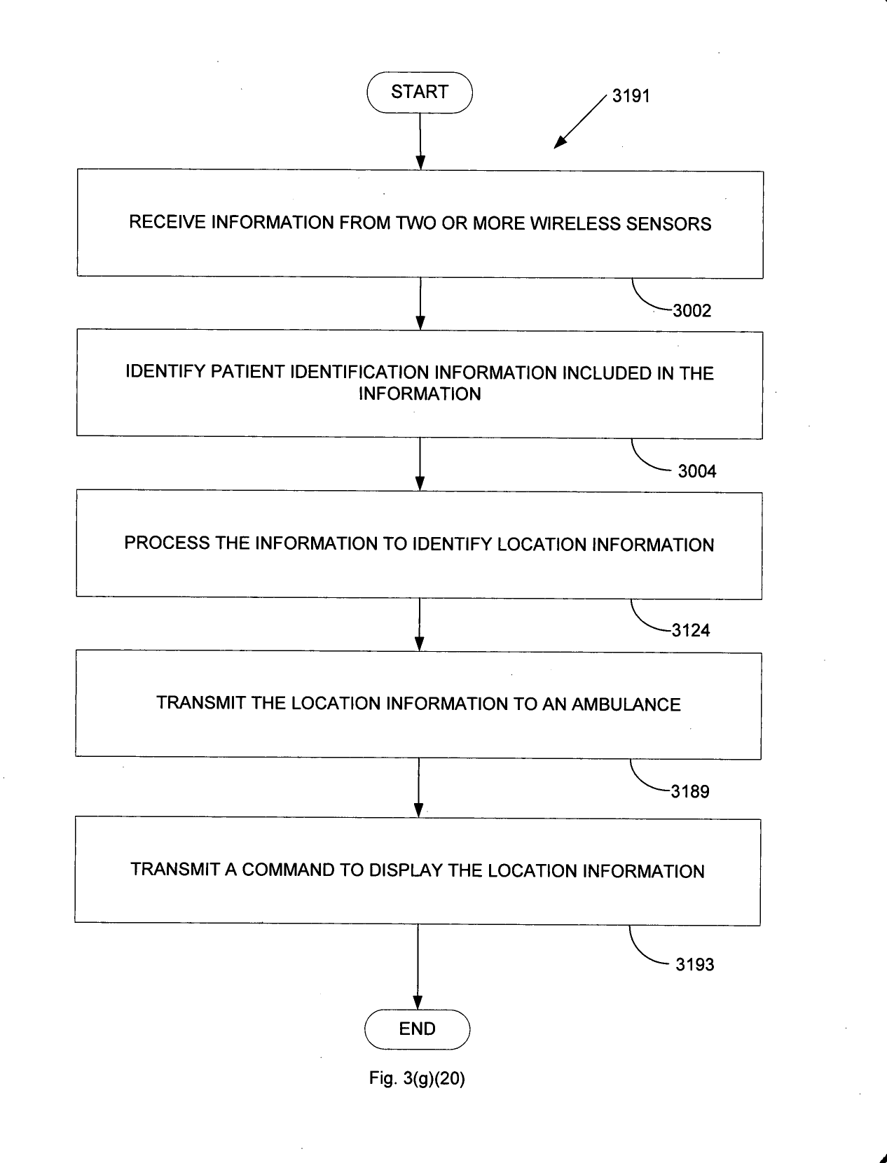

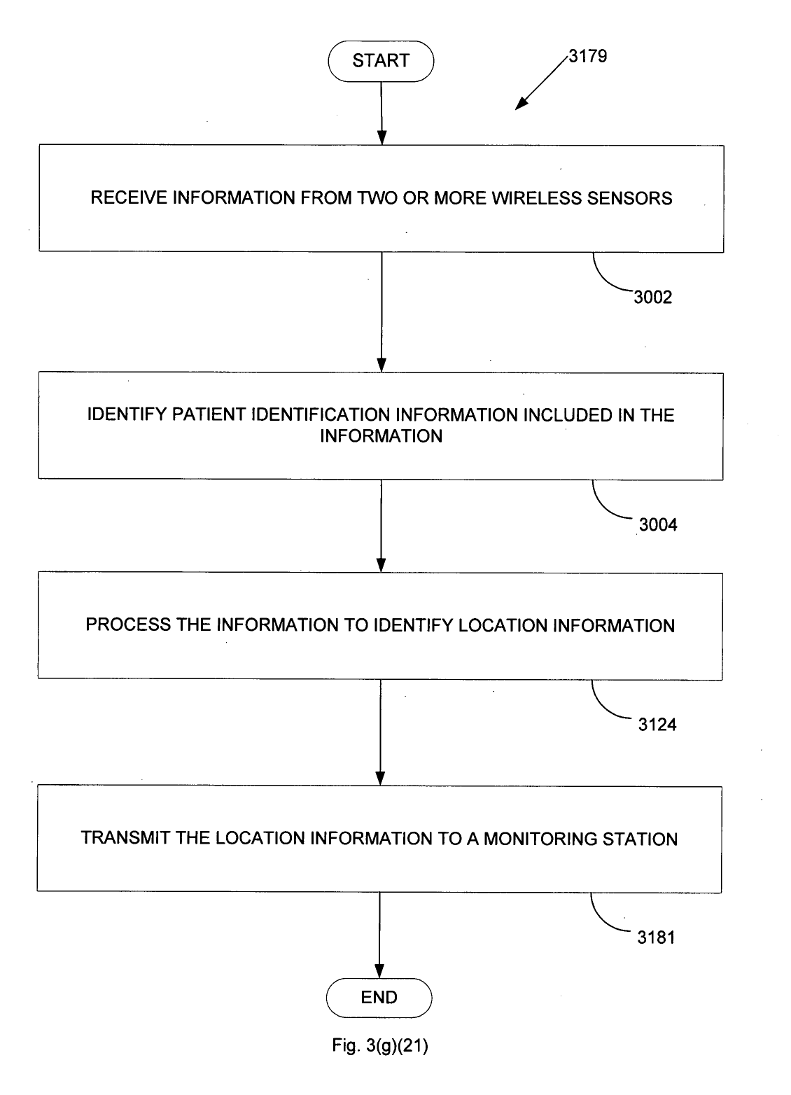

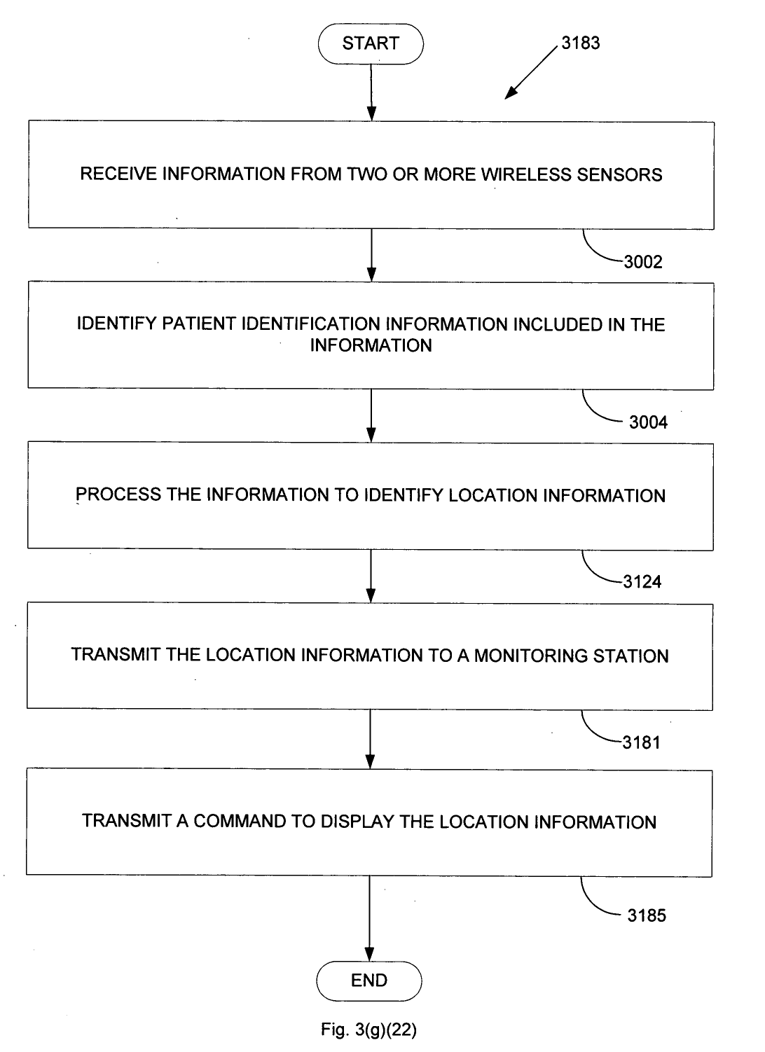

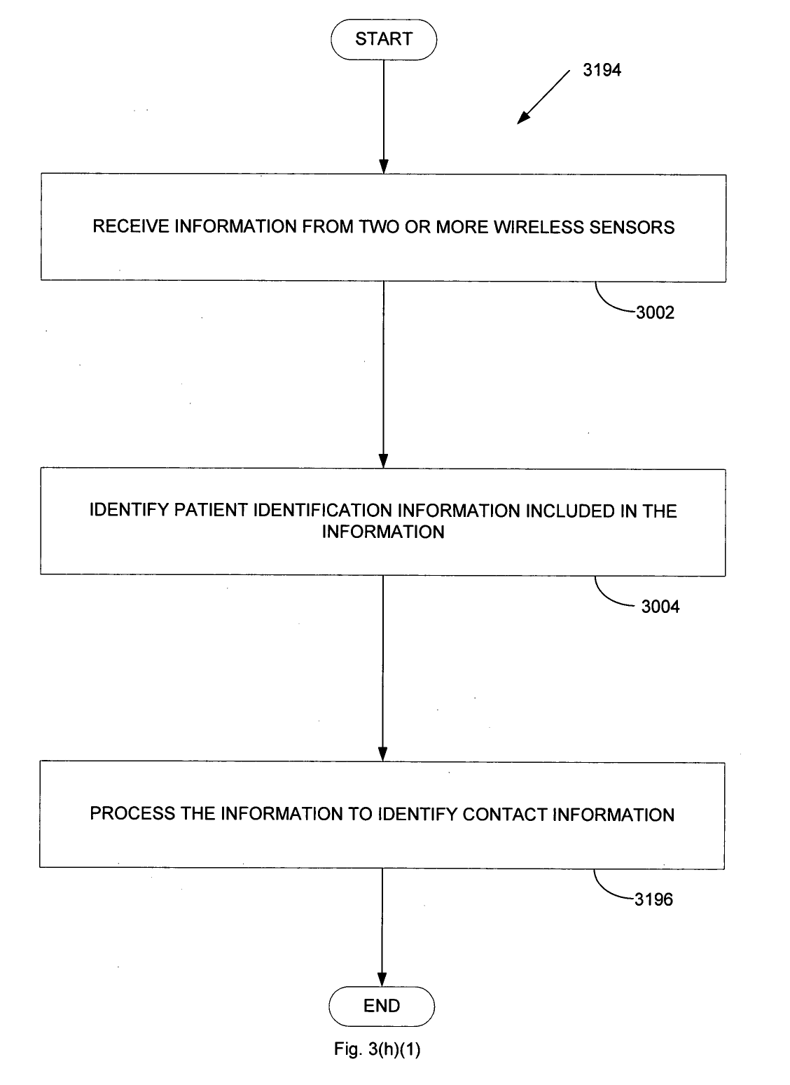

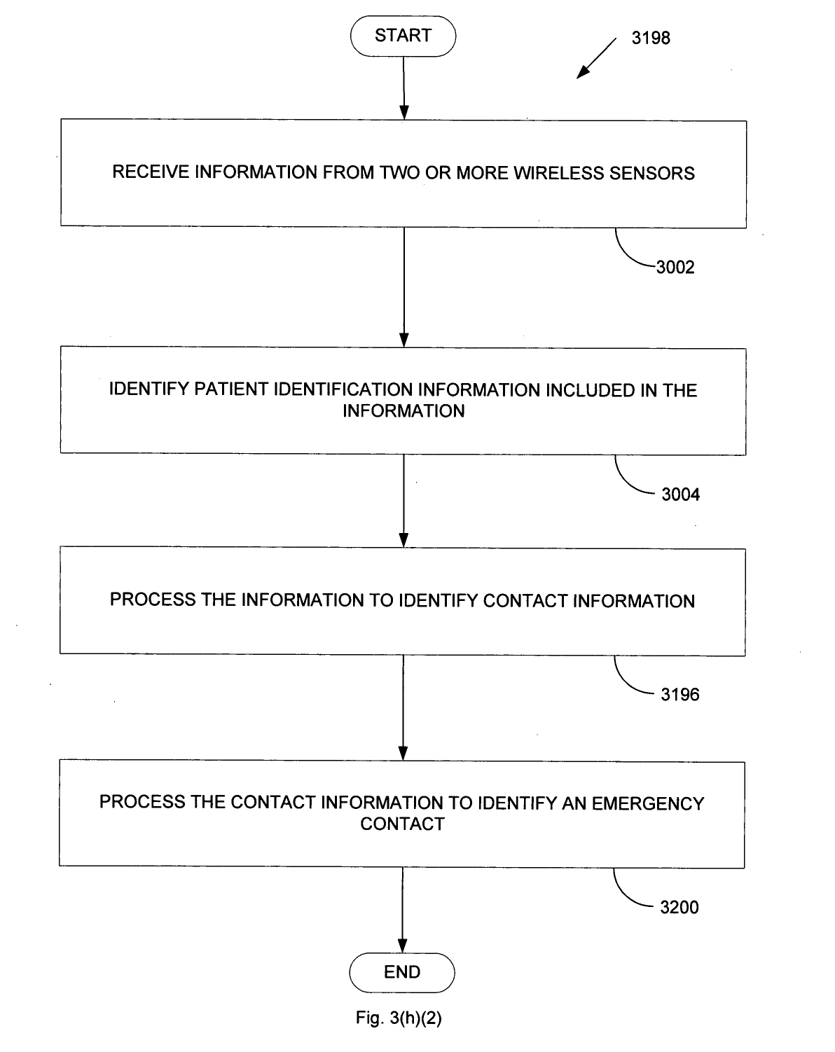

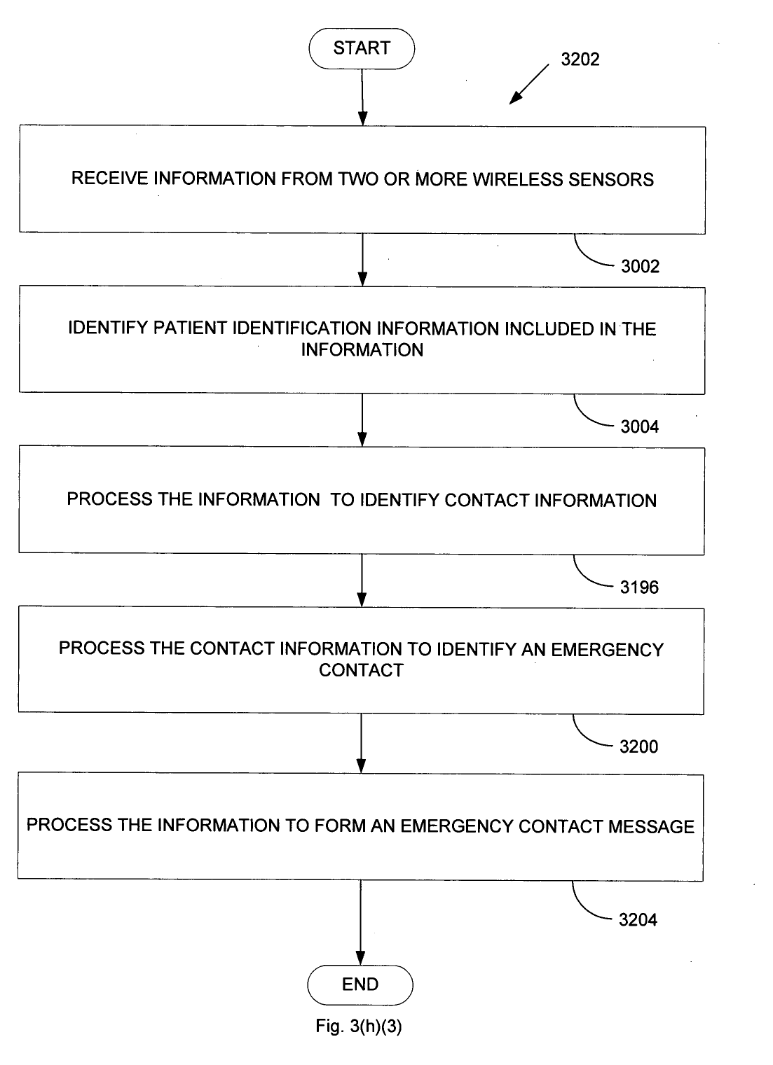

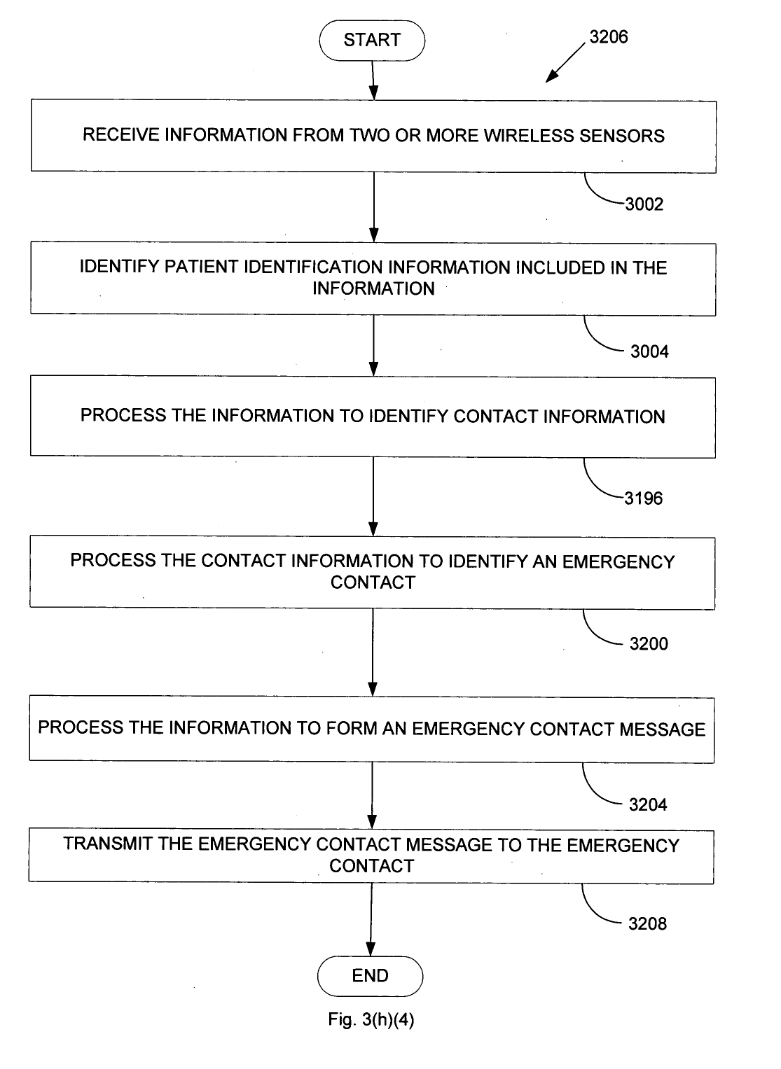

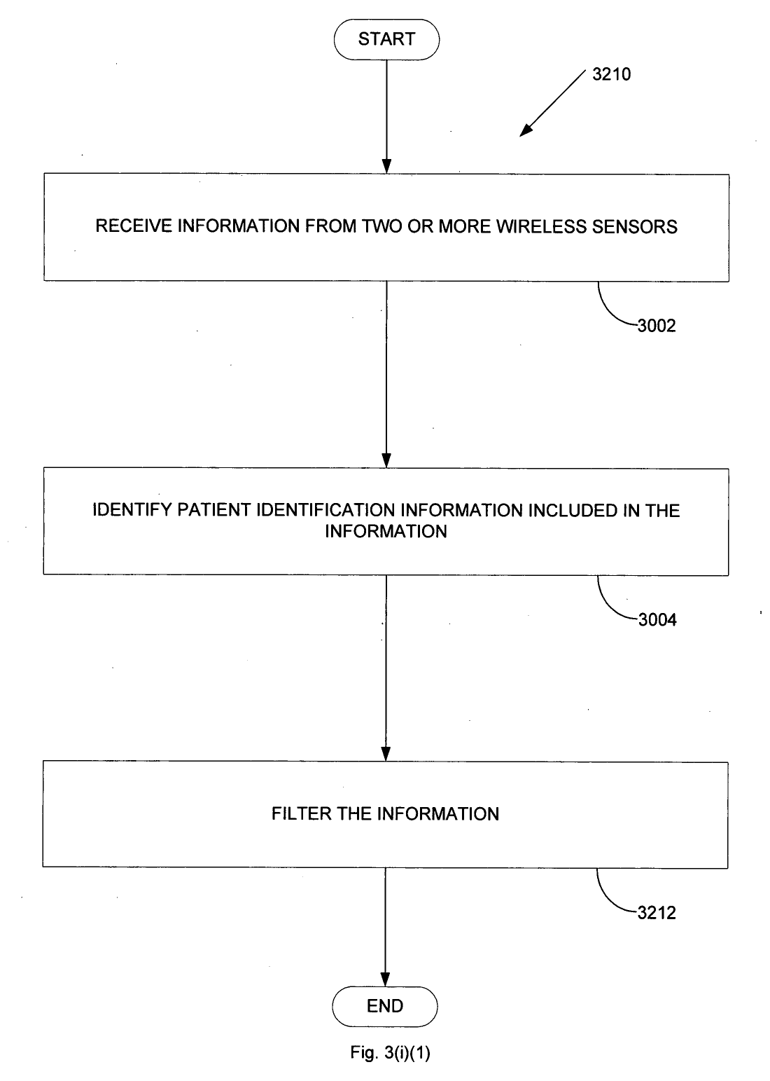

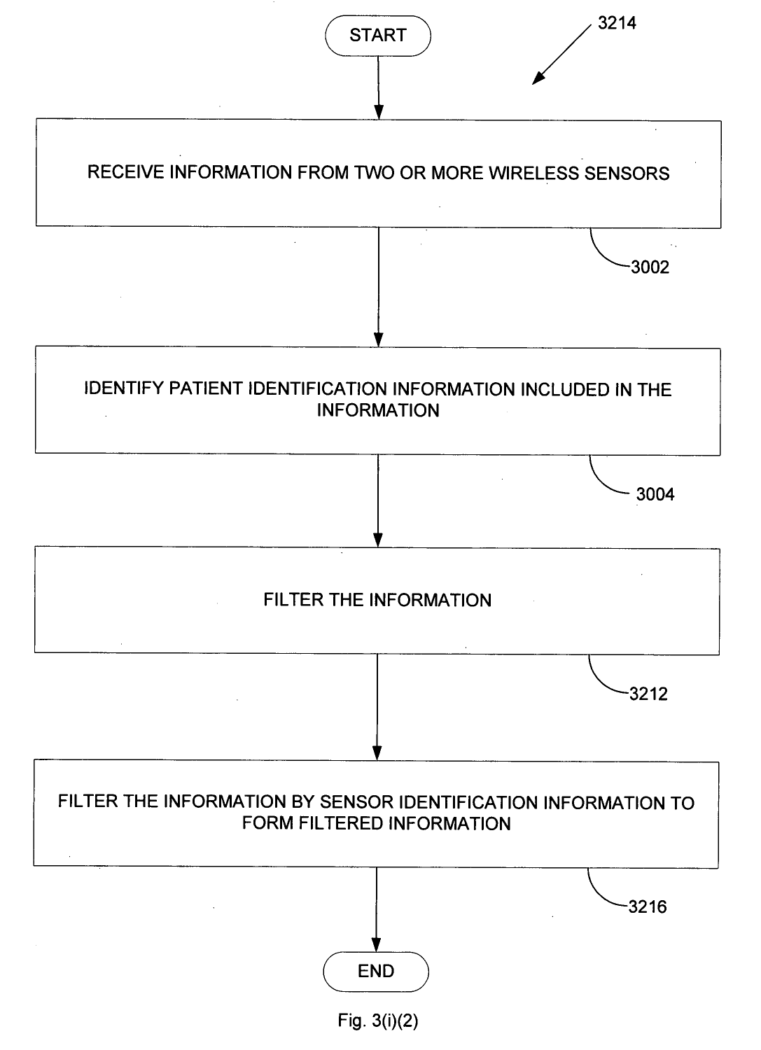

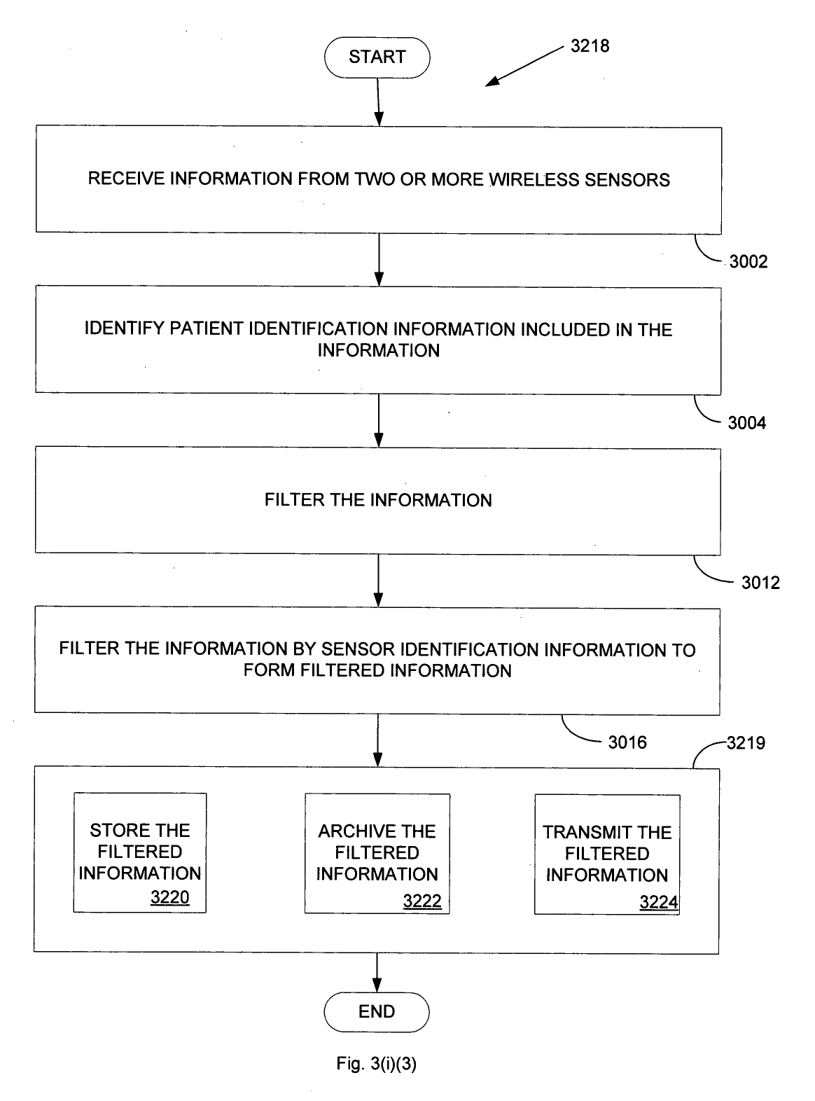

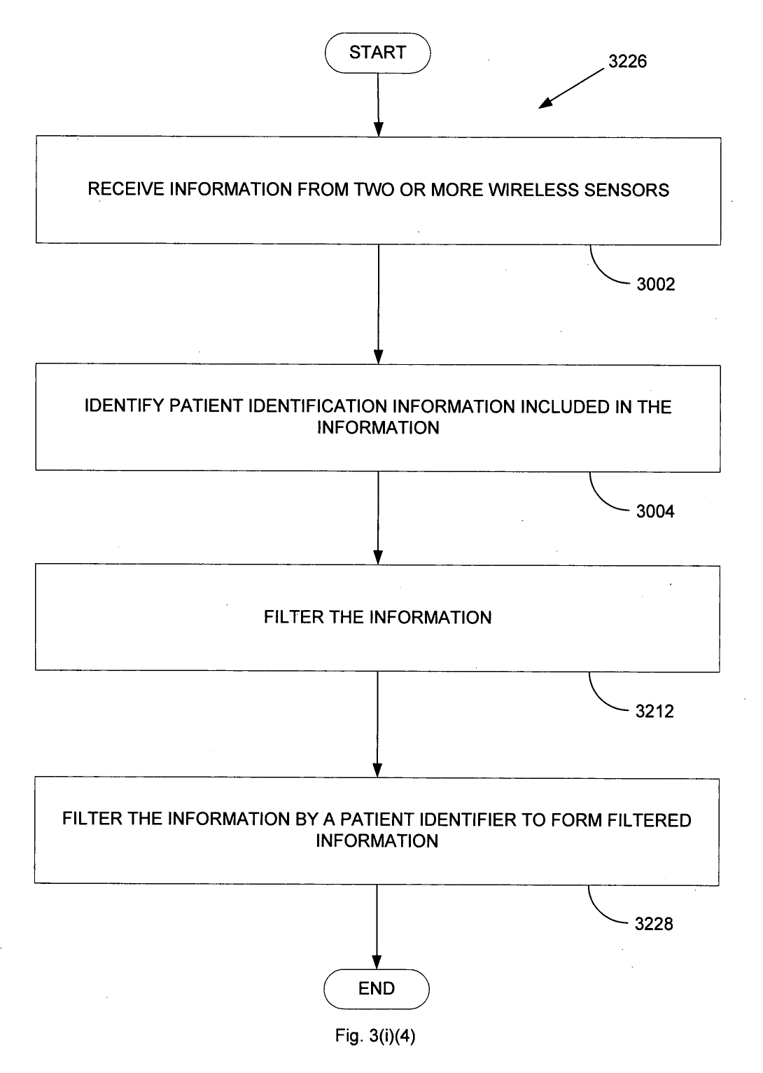

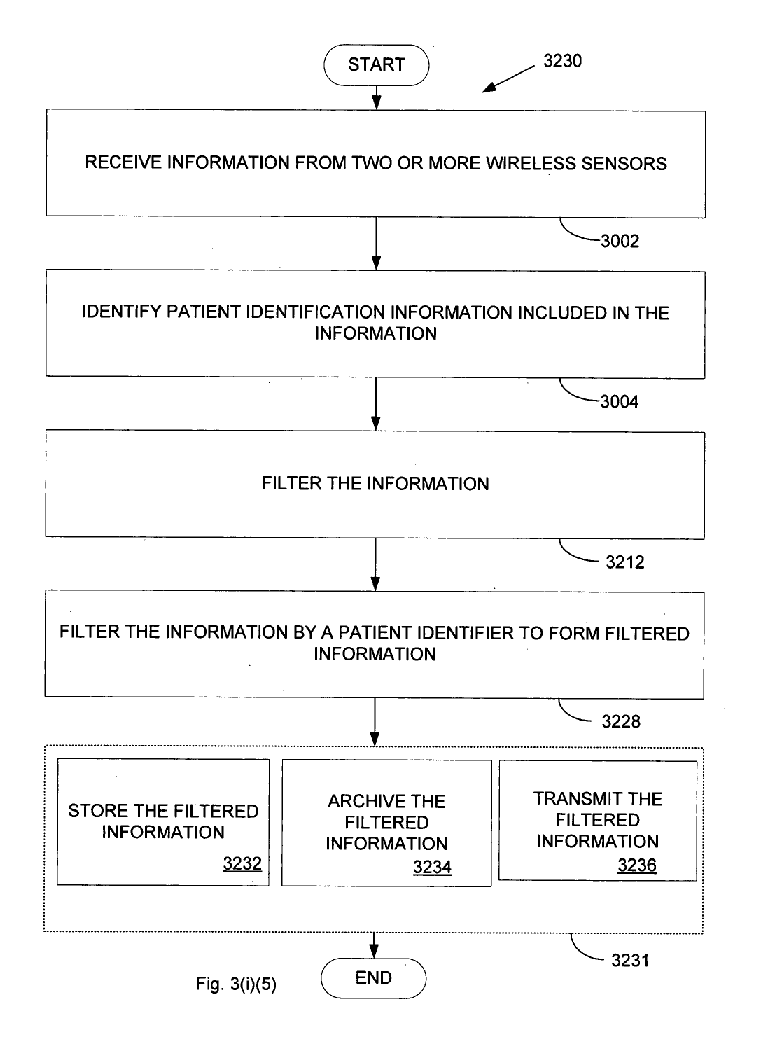

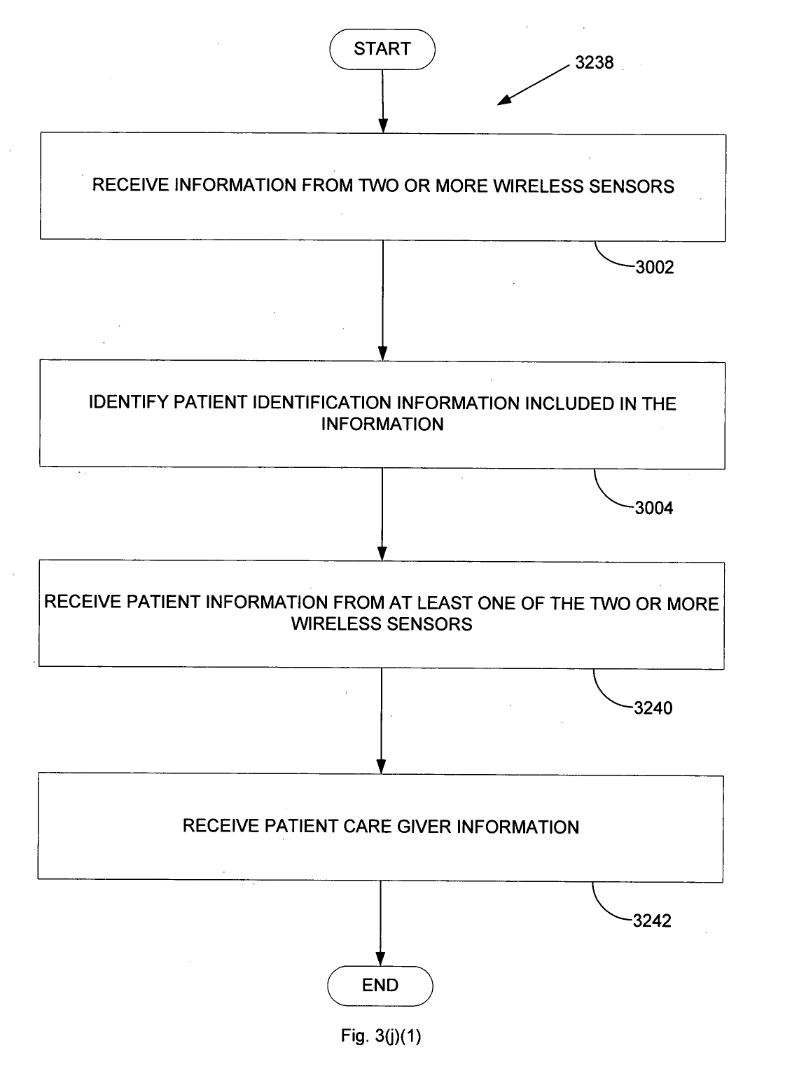

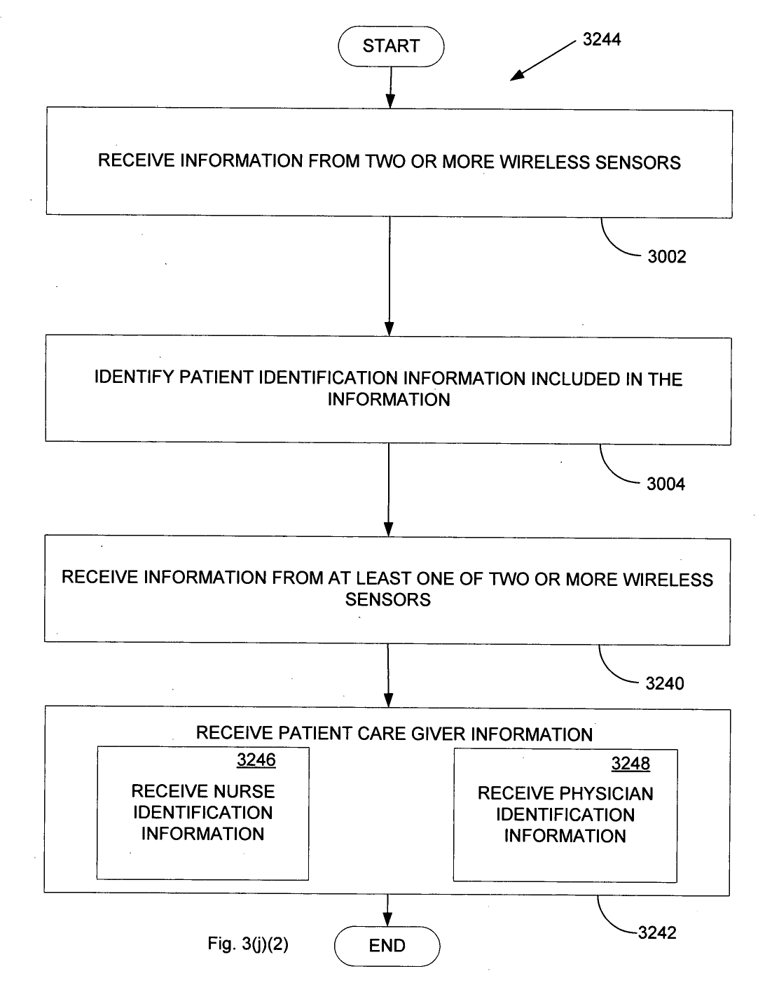

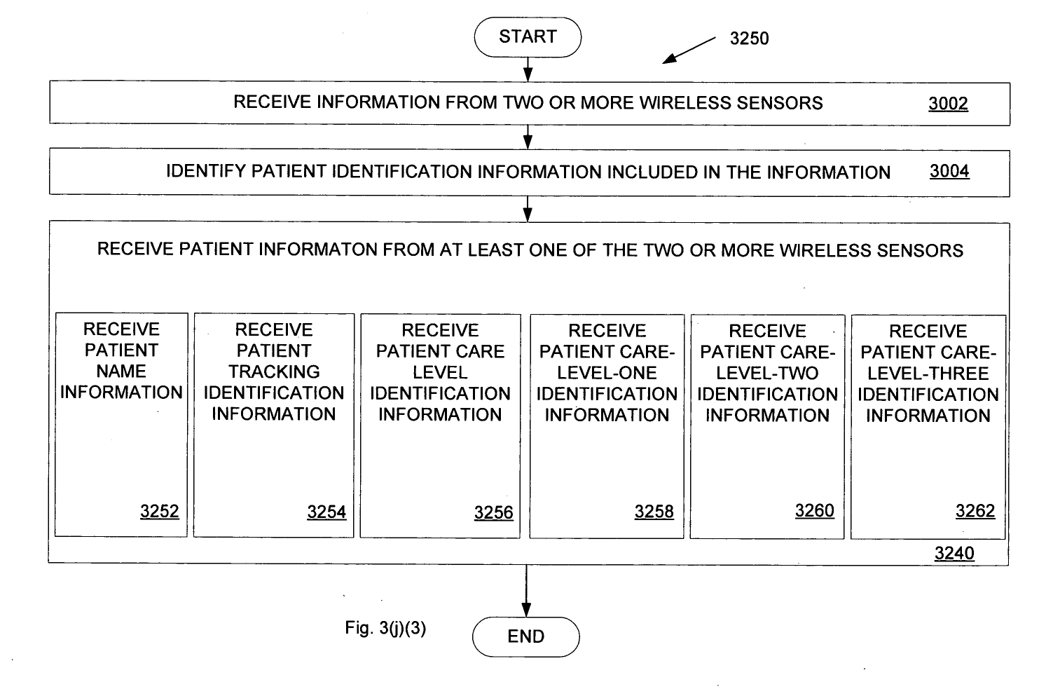

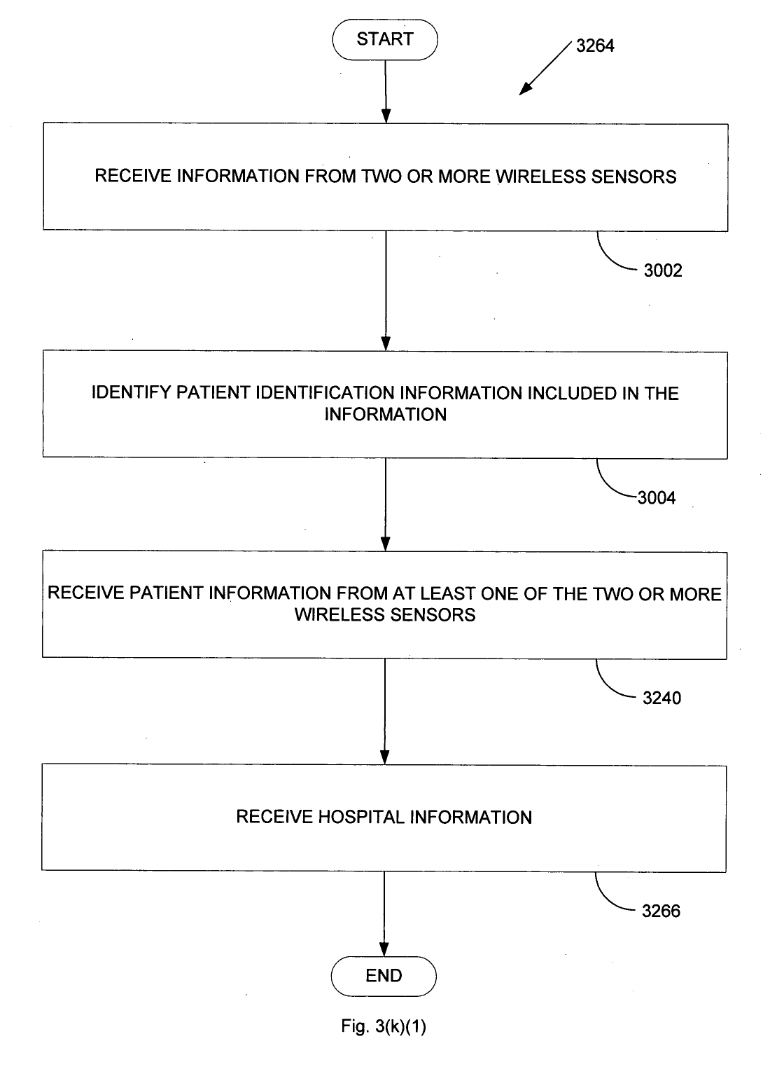

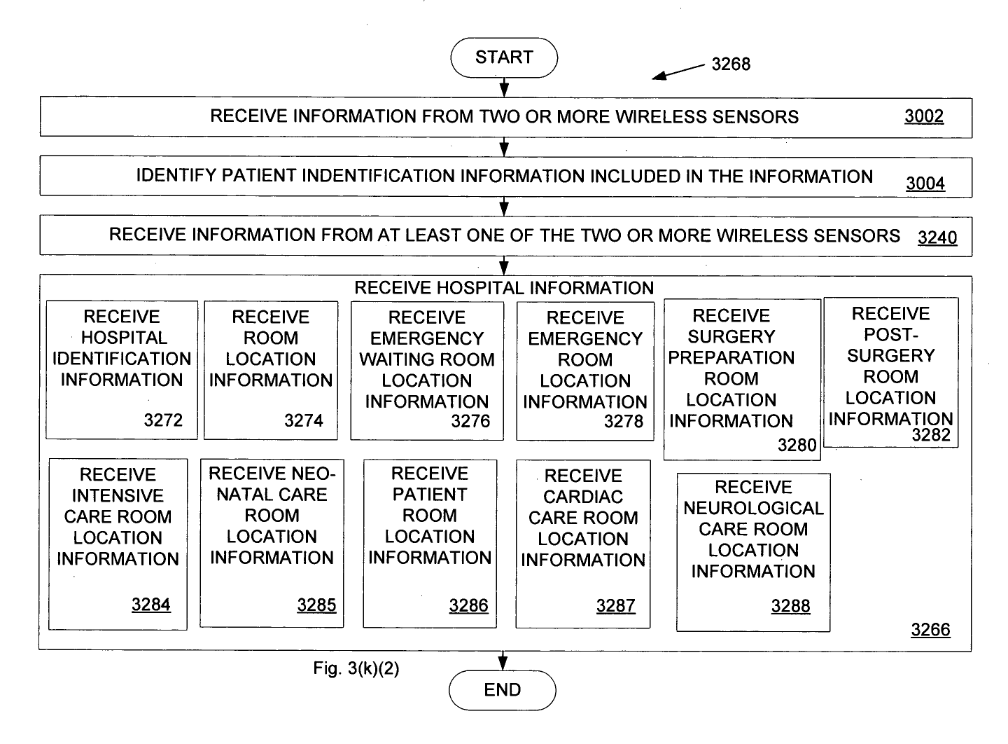

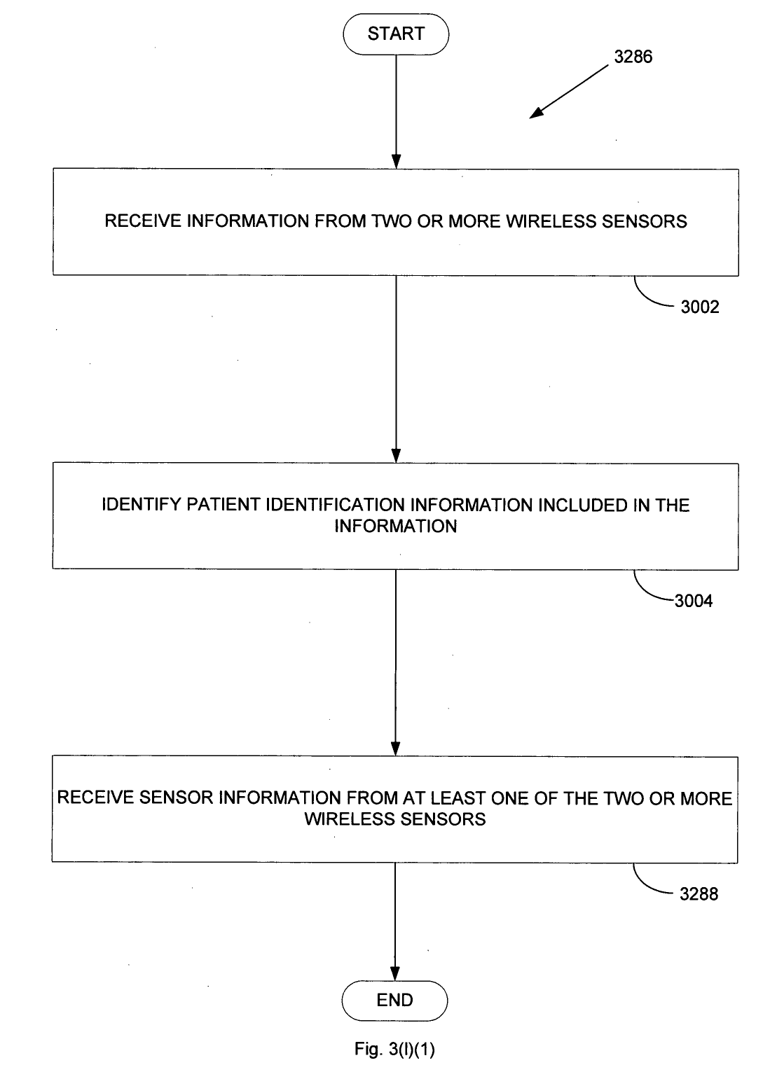

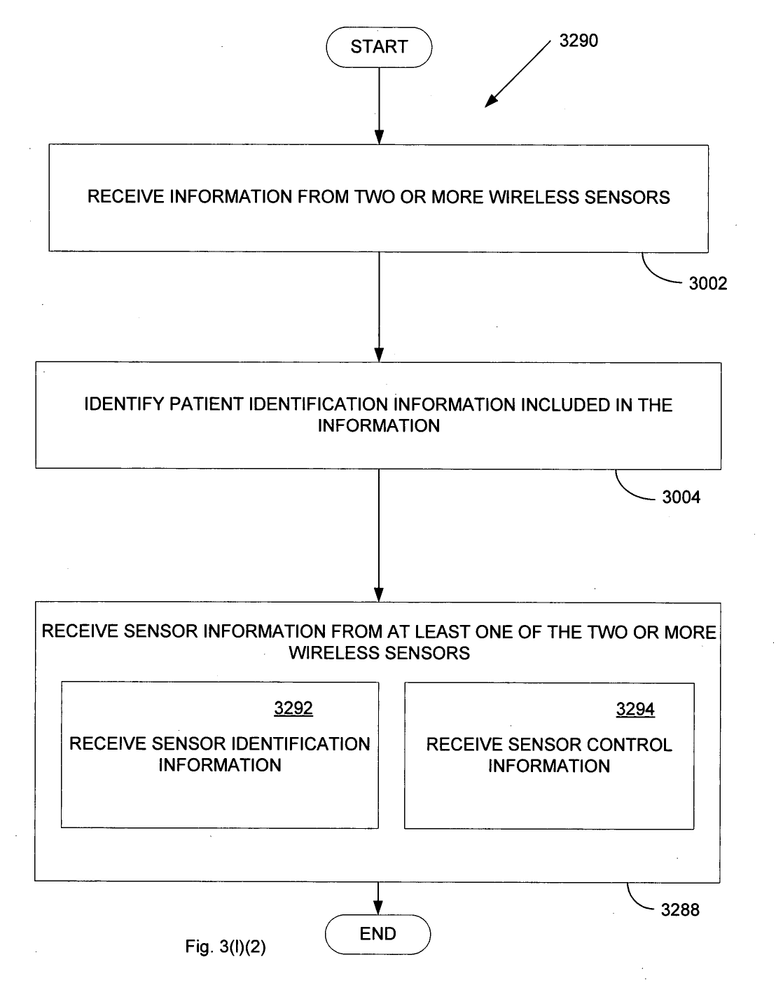

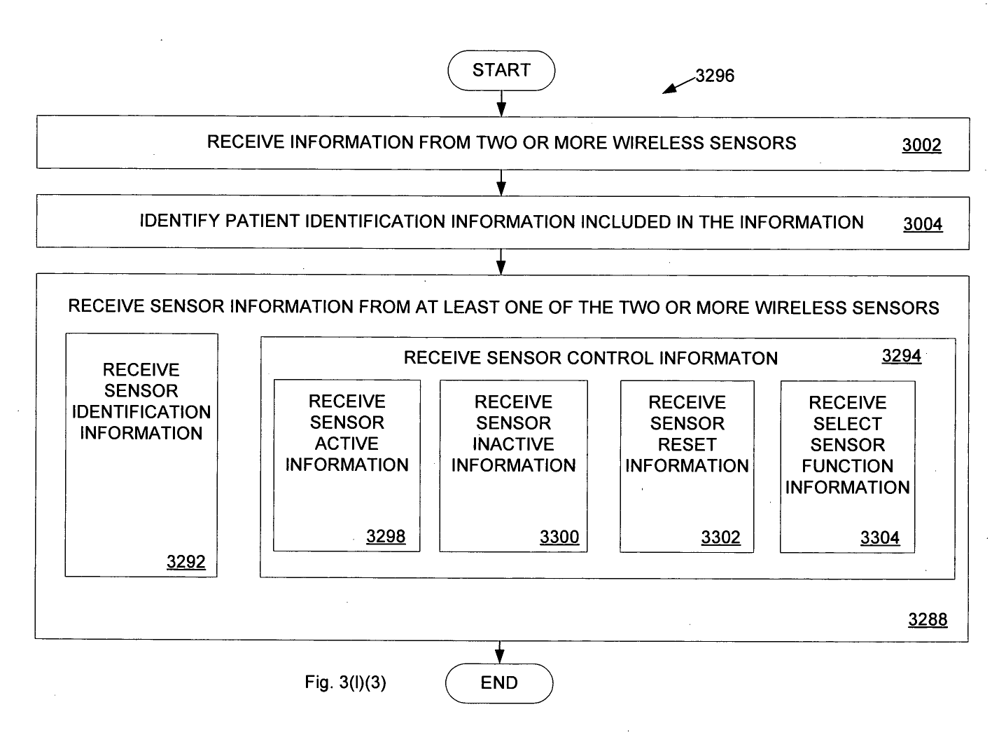

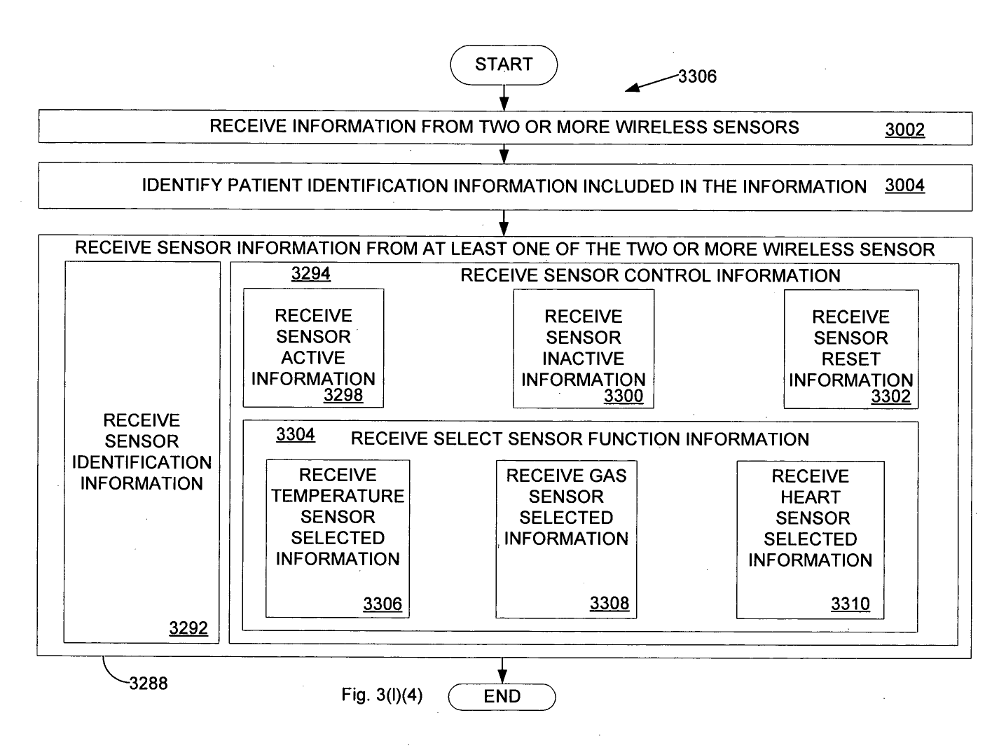

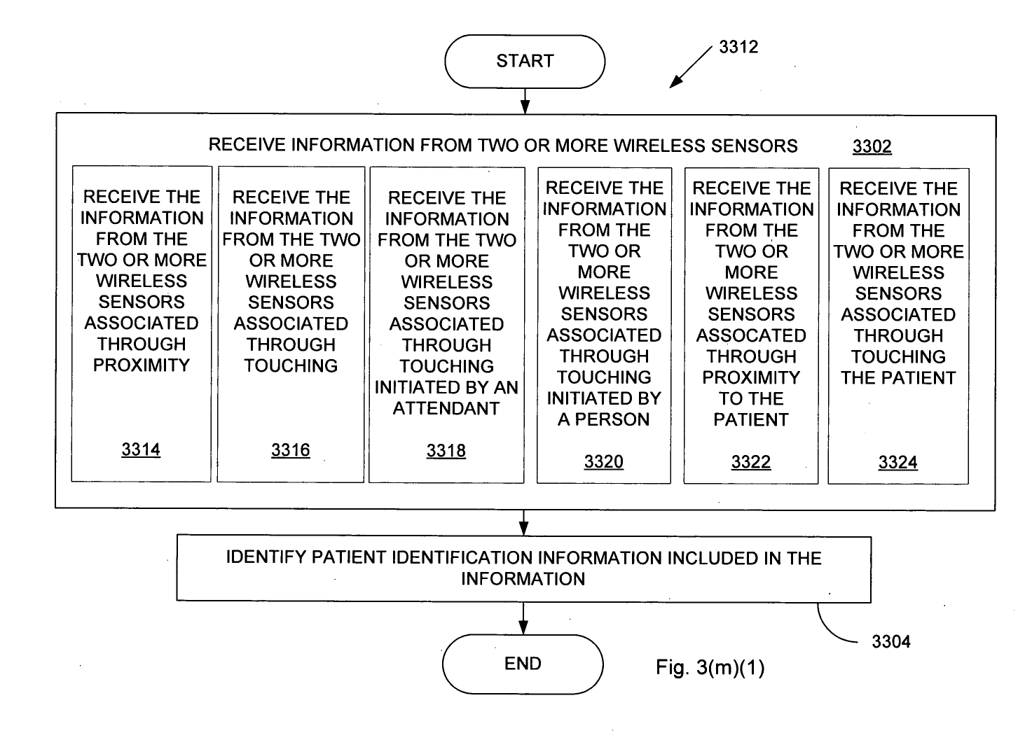

FIG. 3(a)(1) shows a flow diagram of a method 3000 suitable for use in connection with the processing apparatus 1004, shown in FIG. 1(a), in accordance with some embodiments. The method 3000 may include receiving information from two or more wireless sensors (operation 3002), and identifying patient identification information included in the information (operation 3004). Referring again to FIG. 1(a)(1), in some embodiments, the processing apparatus 1004 receives information from the two or more wireless sensors 1008 and identifies patient identification information included in the information. In some embodiments, the identifying hardware/software/firmware 1030 of the processing apparatus 1004 identifies the patient identification information. The identification of patient identification information may include the identification of patient identification information that does not include confidential patient information, such as the patient name or social security number information. More specifically, identifying patient identification information, as used herein, is intended to include “uniquely specifying” a patient while keeping the patient technically anonymous. Patient identification information enables selection of other patient information received at the processing apparatus 1004 and related to the patient of interest. Further processing related to identifying patient identification information included in the information, such as the operations and methods shown in FIG. 3(b)(1), FIG. 3(b)(2), FIG. 3(b)(3), FIG. 3(b)(4), and FIG. 3(b)(5) and described below may be performed in the identifying hardware/software/firmware 1030 of the processing apparatus 1004, shown in FIG. 1(a)(1).

### Identifying Patient Information from More than One Patient

FIG. 3(b)(1) shows a flow diagram of a method 3006 illustrated within the context of the method 3000, shown in FIG. 3(a)(1), wherein identifying patient identification information included in the information (operation 3004) may include a method 3008 that may include identifying the patient identification information associated with a first patient (operation 3010) and identifying the patient identification information associated with a second patient (operation 3012) in accordance with some embodiments. Referring again to FIG. 1(a)(1), in some embodiments, the identifying hardware/software/firmware 1030, may identify the patient identification information associated with a first patient (operation 3010) and may identify the patient identification information associated with a second patient (operation 3012). The method 3008 enables the identification of information associated with a particular patient included in a stream of information that may include information associated with two or more patients.

FIG. 3(b)(2) shows a flow diagram of a method 3014 illustrated within the context of the method 3006, shown in FIG. 3(b)(1), wherein identifying the patient identification information associated with a first patient (operation 3010) may include identifying patient name information associated with the first patient (operation 3016) and wherein identifying the patient identification information associated with a second patient (operation 3012) may include identifying patient social security information associated with the second patient (operation 3018) in accordance with some embodiments. Referring again to FIG. 1(a)(1), in some embodiments, the identifying hardware/software/firmware 1030, may identify patient name information associated with the first patient (operation 3016), and may identify patient social security information associated with the second patient (operation 3018). Patient name information may include a patient's name. Patient social security information may include a patient's social security number.

FIG. 3(b)(3) shows a flow diagram of a method 3020 illustrated within the context of the method 3006, shown in FIG. 3(b)(1), wherein identifying the patient identification information associated with a first patient (operation 3010) may include identifying patient unique tracking identification information associated with the first patient (operation 3022) and identifying the patient identification information associated with a second patient (operation 3012) may include identifying patient medical record number information associated with the second patient (operation 3024) in accordance with some embodiments. Referring again to FIG. 1(a)(1), in some embodiments, the identifying hardware/software/firmware 1030, may identify patient unique tracking identification information associated with the first patient (operation 3022) and may identify patient medical record number information associated with the second patient (operation 3024). Patient unique tracking identification information may include information that is assigned to a patient for tracking purposes, such as a unique number that has not been assigned to another patient. A medical record number may include a number associated with a patient's medical record.

FIG. 3(b)(4) shows a flow diagram of a method 3009 illustrated within the context of the method 3006, shown in FIG. 3(b)(1), wherein identifying the patient identification information associated with a first patient (operation 3010) may include identifying patient unique tracking identification information associated with the first patient (operation 3022). The operation 3022 may include identifying information indicating a corridor, such as a corridor in a hospital, in which the first patient is located (operation 3011). The operation 3011 may include identifying a position in the corridor, such as the left side of the corridor, where the first patient is located (operation 3013). The operation 3022 may include identifying descriptive information that identifies the first patient (operation 3015). The operation 3015 may include identifying a color on a wrist identification tag of the first patient (operation 3017). The operation 3022 may include identifying a physician treating the first patient (operation 3019), in accordance with some embodiments. Referring again to FIG. 1(a)(1), in some embodiments, the identifying hardware/software/firmware 1030, may identify patient unique tracking identification information associated with the first patient (operation 3022), may identify information indicating a corridor, such as a corridor in a hospital, in which the first patient is located (operation 3011), may identify a position in the corridor, such as the left side of the corridor, where the first patient is located (operation 3013), may identify descriptive information that identifies the first patient (operation 3015), may identify a color on a wrist identification tag of the first patient (operation 3017), and may identify a physician treating the first patient (operation 3019).

FIG. 3(b)(5) shows a flow diagram of a method 3021 illustrated within the context of the method 3000, shown in FIG. 3(a)(1), wherein identifying patient identification information included in the information (operation 3004) may include identifying non-identifying patient tracking information (operation 3023) in accordance with some embodiments. Referring again to FIG. 1(a)(1), in some embodiments, the identifying hardware/software/firmware 1030, may identify non-identifying patient tracking information (operation 3023). Non-identifying patient tracking information may include information that is used to anonymously identify a patient. In some embodiments, non-identifying patient tracking information may include encoded or encrypted non-identifying patient tracking information. The use of non-identifying patient tracking information may improve patient privacy.

### Patient Identifying Information and Associated Physiological Information

The methods shown in FIG. 3(c)(1), FIG. 3(c)(2), FIG. 3(c)(3), FIG. 3(c)(4), FIG. 3(c)(5), FIG. 3(c)(6), FIG. 3(c)(7), FIG. 3(c)(8), FIG. 3(c)(9), FIG. 3(c)(10), FIG. 3(c)(1), and FIG. 3(c)(12) are illustrated within the context of the method 3000, shown in FIG. 3(a)(1), for identifying patient identification information, such as finger print information, patient name information, patient social security number information, patient unique tracking identification information, substantially unique biometric patient information, and patient retina scan information, included in a received information and identifying physiological information associated with the patient identification information. Referring again to FIG. 1(a)(1), in some embodiments, the information, such as the patient identification information that may be included in the methods shown in FIG. 3(c)(1), FIG. 3(c)(2), FIG. 3(c)(3), FIG. 3(c)(4), FIG. 3(c)(5), FIG. 3(c)(6), FIG. 3(c)(7), FIG. 3(c)(8), FIG. 3(c)(9), FIG. 3(c)(10), FIG. 3(c)(1), and FIG. 3(c)(12), from the two or more wireless sensors 1008 may be received at the processing apparatus 1004. After the receiving hardware/software/firmware 1028 receives the information, the identifying hardware/software/firmware 1030 may identify the identifying patient identification information, such as finger print information, patient name information, patient social security number information, patient unique tracking identification information, substantially unique biometric patient information, and/or patient retina scan information, and/or the physiological information associated with the patient identification information.

FIG. 3(c)(1) shows a flow diagram of a method 3026 illustrated within the context of the method 3000, shown in FIG. 3(a)(1), wherein identifying patient identification information included in the information (operation 3004) may include identifying patient finger print information (operation 3028) in accordance with some embodiments.

FIG. 3(c)(2) shows a flow diagram of a method 3030 illustrated within the context of the method 3026, shown in FIG. 3(c)(1), and further including identifying physiological information included in the information associated with the patient identification information by identifying the physiological information associated with the patient fingerprint information (operation 3032) in accordance with some embodiments.

FIG. 3(c)(3) shows a flow diagram of a method 3034 illustrated within the context of the method 3000, shown in FIG. 3(a)(1), wherein identifying patient identification information included in the information (operation 3004) may include identifying patient name information (operation 3036) in accordance with some embodiments.

FIG. 3(c)(4) shows a flow diagram of a method 3038 illustrated within the context of the method 3034, shown in FIG. 3(c)(3), and further including identifying physiological information included in the information and associated with the patient identification information by identifying the physiological information associated with the patient name information (operation 3040) in accordance with some embodiments.

FIG. 3(c)(5) shows a flow diagram of a method 3042 illustrated within the context of the method 3000, shown in FIG. 3(a)(1), wherein identifying patient identification information included in the information (operation 3004) may include identifying patient social security number information (operation 3044) in accordance with some embodiments.

FIG. 3(c)(6) shows a flow diagram of a method 3046 illustrated within the context of the method 3042, shown in FIG. 3(c)(5), and further including identifying physiological information included in the information and associated with the patient identification information by identifying the physiological information associated with the patient social security number information (operation 3048) in accordance with some embodiments.

FIG. 3(c)(7) shows a flow diagram of a method 3050 illustrated within the context of the method 3000, shown in FIG. 3(a)(1), wherein identifying patient identification information included in the information (operation 3004) may include identifying patient unique tracking identification information (operation 3052) in accordance with some embodiments.

FIG. 3(c)(8) shows a flow diagram of a method 3054 illustrated within the context of the method 3050, shown in FIG. 3(c)(7), and further including identifying physiological information included in the information and associated with the patient identification information by identifying the physiological information associated with the patient unique tracking identification information (operation 3056) in accordance with some embodiments.

FIG. 3(c)(9) shows a flow diagram of a method 3058 illustrated within the context of the method 3000, shown in FIG. 3(a)(1), wherein identifying patient identification information included in the information (operation 3004) may include identifying substantially unique biometric patient information (operation 3060) in accordance with some embodiments.

FIG. 3(c)(10) shows a flow diagram of a method 3062 illustrated within the context of the method 3058, shown in FIG. 3(c)(9), and further including identifying physiological information included in the information and associated with the patient identification information by identifying the physiological information associated with the substantially unique biometric patient information (operation 3064) in accordance with some embodiments.

FIG. 3(c)(11) shows a flow diagram of a method 3066 illustrated within the context of the method 3000, shown in FIG. 3(a)(1), wherein identifying patient identification information included in the information (operation 3004) may include identifying patient retina scan information (operation 3068) in accordance with some embodiments.

FIG. 3(c)(12) shows a flow diagram of a method 3070 illustrated within the context of the method 3066, shown in FIG. 3(c)(11), and further including identifying physiological information included in the information and associated with the patient identification information by identifying the physiological information associated with the patient retina scan information (operation 3072) in accordance with some embodiments.

### Identifying Nurse Information

The methods shown in FIG. 3(d)(1), FIG. 3(d)(2), FIG. 3(d)(3), and FIG. 3(d)(4) provide for processing information to identify nurse information, transmitting the nurse information wirelessly, and transmitting a command to generate an auditory signal or a visual command to alert a nurse. Referring again to FIG. 1(a)(1), the processing apparatus 1004, in some embodiments, transmits information, such as nurse information and commands to generate an auditory or visual signal at, for example, a nurse's station to alert a nurse. Exemplary auditory signals include beeping signals. Exemplary visual signals include flashing signals.

FIG. 3(d)(1) shows a flow diagram of a method 3074 illustrated within the context of the method 3000, shown in FIG. 3(a)(1), and further including processing the information to identify nurse information (operation 3076) in accordance with some embodiments. Referring again to FIG. 1(a)(1), in some embodiments, the identifying hardware/software/firmware 1030, may process the information to identify nurse information (operation 3076), as shown in FIG. 3(d)(1). Nurse information, for example, may include attending nurse identification information such as nurse station, nurse name, and other information associating a nurse with one or more patients. Nurse information may also include information intended for nurse review.

FIG. 3(d)(2) shows a flow diagram of a method 3078 illustrated within the context of the method 3074, shown in FIG. 3(d)(1), and further including transmitting the nurse information wirelessly (operation 3080) in accordance with some embodiments. Referring again to FIG. 1(a)(1), in some embodiments, the transmitting hardware/software/firmware 1031 may transmit the nurse information wirelessly (operation 3080), as shown in FIG. 3(d)(2).

FIG. 3(d)(3) shows a flow diagram of a method 3082 illustrated within the context of the method 3078, shown in FIG. 3(d)(2), and further including transmitting a command to generate an auditory signal (operation 3084) in accordance with some embodiments. Referring again to FIG. 1(a)(1), in some embodiments, the transmitting hardware/software/firmware 1031 may transmit a command to generate an auditory signal (operation 3084), as shown in FIG. 3(d)(3). Exemplary auditory signals may include beeping signals.

FIG. 3(d)(4) shows a flow diagram of a method 3086 illustrated within the context of the method 3078, shown in FIG. 3(d)(2), and further including transmitting a command to generate a visual signal (operation 3088) in accordance with some embodiments. Referring to FIG. 1(a)(1), in some embodiments, the transmitting hardware/software/firmware 1031 may transmit a command to generate a visual signal (operation 3088), as shown in FIG. 3(d)(4). Exemplary visual signals may include flashing signals.

### Identifying Security Information

The methods shown in FIG. 3(e)(1), FIG. 3(e)(2), FIG. 3(e)(3), and FIG. 3(e)(4) provide for processing information to identify security information, transmitting the security information wirelessly, and transmitting a command to generate an auditory signal or a visual command to alert a security person.

FIG. 3(e)(1) shows a flow diagram of a method 3090 illustrated within the context of the method 3000, shown in FIG. 3(a), and further including processing the information to identify security information (operation 3092) in accordance with some embodiments. Referring again to FIG. 1(a)(1), in some embodiments, the identifying hardware/software/firmware 1030, may process the information to identify security information (operation 3092), as shown in FIG. 3(e)(1). Security information may include alert information indicating security is needed to assist with a patient.

FIG. 3(e)(2) shows a flow diagram of a method 3094 illustrated within the context of the method 3090, shown in FIG. 3(e)(1) and further including transmitting the security information wirelessly (operation 3096) in accordance with some embodiments. Referring again to FIG. 1(a)(1), in some embodiments, the transmitting hardware/software/firmware 1031 may transmit the security information wirelessly (operation 3096), as shown in FIG. 3(e)(2).

FIG. 3(e)(3) shows a flow diagram of a method 3098 illustrated within the context of the method 3094, shown in FIG. 3(e)(2) and further including transmitting a command to generate an auditory signal (operation 3100) in accordance with some embodiments. As a result, an auditory signal may be generated at a security station. Referring again to FIG. 1(a)(1), in some embodiments, the transmitting hardware/software/firmware 1031 may transmit a command to generate an auditory signal (operation 3100), as shown in FIG. 3(e)(3). Exemplary auditory signals may include beeping signals.

FIG. 3(e)(4) shows a flow diagram of a method 3102 illustrated within the context of the method 3098, shown in FIG. 3(e)(2), and further including transmitting a command to generate a visual signal (operation 3104) in accordance with some embodiments. The visual signal may be displayed at a security station. Referring to FIG. 1(a)(1), in some embodiments, the transmitting hardware/software/firmware 1031 may transmit a command to generate a visual signal (operation 3104), as shown in FIG. 3(e)(4). Exemplary visual signals may include flashing signals.

### Identifying Accounting Information

The methods shown in FIG. 3(f)(1), FIG. 3(f)(2), FIG. 3(f)(3), and FIG. 3(f)(4) provide for processing information to identify accounting information and transmitting the accounting information to a financial organization, governmental organization, or an insurance organization, while maintaining patient privacy and ensuring verification of receipt of the accounting information.

FIG. 3(f)(1) shows a flow diagram of a method 3106 illustrated within the context of the method 3000, shown in FIG. 3(a)(1), and further including processing the information to identify accounting information (operation 3108) in accordance with some embodiments. Referring again to FIG. 1(a)(1), in some embodiments, the identifying hardware/software/firmware 1030, may identify accounting information (operation 3108), as shown in FIG. 3(f)(1). Accounting information may include patient billing information.

FIG. 3(f)(2) shows a flow diagram of a method 3110 illustrated within the context of the method 3106, shown in FIG. 3(f)(1), and further including transmitting the accounting information to a financial organization (operation 3112) while maintaining patient privacy and ensuring verification of receipt of the accounting information in accordance with some embodiments. Referring again to FIG. 1(a)(1), in some embodiments, the transmitting hardware/software/firmware 1031 may transmit the accounting information to a financial organization while maintaining patient privacy and ensuring verification of receipt of the accounting information (operation 3112), as shown in FIG. 3(f)(2).

FIG. 3(f)(3) shows a flow diagram of a method 3114 illustrated within the context of the method 3110, shown in FIG. 3(f)(2), and further including transmitting the accounting information to a governmental organization (operation 3116) while maintaining patient privacy and ensuring verification of receipt of the accounting information in accordance with some embodiments. Referring again to FIG. 1(a)(1), in some embodiments, the transmitting hardware/software/firmware 1031 may transmit the accounting information to a governmental organization while maintaining patient privacy and ensuring verification of receipt of the accounting information (operation 3116), as shown in FIG. 3(f)(2). Exemplary governmental organizations include the social security administration and the department of health.

FIG. 3(f)(4) shows a flow diagram of a method 3118 illustrated within the context of the method 3110, shown in FIG. 3(f)(2), and further including transmitting the accounting information to an insurance organization (operation 3120) while maintaining patient privacy and ensuring verification of receipt of the accounting information in accordance with some embodiments. Referring to FIG. 1(a)(1), in some embodiments, the transmitting hardware/software/firmware 1031 may transmit the accounting information to an insurance organization while maintaining patient privacy and ensuring verification of receipt of the accounting information (operation 3120), as shown in FIG. 3(f)(4).

### Identifying Location Information

The methods show in FIG. 3(g)(1), FIG. 3(g)(2), FIG. 3(g)(3), FIG. 3(g)(4), FIG. 3(g)(5), FIG. 3(g)(6), FIG. 3(g)(7), FIG. 3(g)(8), FIG. 3(g)(9), FIG. 3(g)(10), FIG. 3(g)(11), FIG. 3(g)(12), FIG. 3(g)(13), FIG. 3(g)(14), FIG. 3(g)(15), FIG. 3(g)(16), FIG. 3(g)(17), FIG. 3(g)(18), FIG. 3(g)(19), FIG. 3(g)(20), FIG. 3(g)(21), and FIG. 3(g)(22) provide for processing information to identify a patient's location information, transmitting the location information to a hospital station, a nurse's station, an emergency room, a person, an emergency contact, a care provider, a nurse, a physician, an ambulance, and a monitoring station, and transmitting a command to display the location information.

FIG. 3(g)(1) shows a flow diagram of a method 3122 illustrated within the context of the method 3000, shown in FIG. 3(a)(1), and further including processing the information to identify location information (operation 3124) in accordance with some embodiments. Referring again to FIG. 1(a)(1), in some embodiments, the identifying hardware/software/firmware 1030, may process the information to identify location information (operation 3124), as shown in FIG. 3(g)(1). The location information may define the location of a patient within a hospital or within a region of the country, such as a city.

FIG. 3(g)(2) shows a flow diagram of a method 3126 illustrated within the context of the method 3122, shown in FIG. 3(g)(1), and further including transmitting the location information wirelessly (operation 3128) in accordance with some embodiments. Referring again to FIG. 1(a)(1), in some embodiments, the transmitting hardware/software/firmware 1031 may transmit the location information wirelessly (operation 3128), as shown in FIG. 3(g)(2). Wireless transmission may include any transmission in which the channel for the transmission is not a wire. For example, a radio transmission, such as a frequency modulated or amplitude modulated radio transmission is a wireless transmission.

FIG. 3(g)(3) shows a flow diagram of a method 3130 illustrated within the context of the method 3126, shown in FIG. 3(g)(2), and further including transmitting the location information to a hospital station (operation 3132) in accordance with some embodiments. Referring again to FIG. 1(a)(1), in some embodiments, the transmitting hardware/software/firmware 1031 may transmit the location information to a hospital station (operation 3132), as shown in FIG. 3(g)(3).

FIG. 3(g)(4) shows a flow diagram of a method 3134 illustrated within the context of the method 3126, shown in FIG. 3(g)(2), and further including transmitting a command to display the location information (operation 3136) in accordance with some embodiments. Referring again to FIG. 1(a)(1), in some embodiments, the transmitting hardware/software/firmware 1031 may transmit a command to display the location information (operation 3136), as shown in FIG. 3(g)(4).

FIG. 3(g)(5) shows a flow diagram of a method 3138 illustrated within the context of the method 3122, shown in FIG. 3(g)(1), and further including transmitting the location information to a nurse's station (3140) in accordance with some embodiments. Referring again to FIG. 1(a)(1), in some embodiments, the transmitting hardware/software/firmware 1031 may transmit the location information to a nurse's station (operation 3140), as shown in FIG. 3(g)(5). FIG. 3(g)(6) shows a flow diagram of a method 3142 illustrated within the context of the method 3138, shown in FIG. 3(g)(5), and further including transmitting a command to display the location information (operation 3144) in accordance with some embodiments. Referring again to FIG. 1(a)(1), in some embodiments, the transmitting hardware/software/firmware 1031 may transmit a command to display the location information (operation 3144), as shown in FIG. 3(g)(5).

FIG. 3(g)(7) shows a flow diagram of a method 3146 illustrated within the context of the method 3122, shown in FIG. 3(g)(1), and further including transmitting the location information to an emergency room (operation 3148) in accordance with some embodiments. Referring again to FIG. 1(a)(1), in some embodiments, the transmitting hardware/software/firmware 1031 may transmit the location information to an emergency room (operation 3148), as shown in FIG. 3(g)(7). FIG. 3(g)(8) shows a flow diagram of a method 3150 illustrated within the context of the method 3146, shown in FIG. 3(g)(7), and further including transmitting a command to display the location information (operation 3152) in accordance with some embodiments. Referring again to FIG. 1(a)(1), in some embodiments, the transmitting hardware/software/firmware 1031 may transmit a command to display the location information (operation 3152), as shown in FIG. 3(g)(8).

FIG. 3(g)(9) shows a flow diagram of a method 3154 illustrated within the context of the method 3122, shown in FIG. 3(g)(1), and further including transmitting the location information to a person (operation 3156) in accordance with some embodiments. Referring again to FIG. 1(a)(1), in some embodiments, the transmitting hardware/software/firmware 1031 may transmit the location information to a person (operation 3156), as shown in FIG. 3(g)(9). FIG. 3(g)(10) shows a flow diagram of a method 3158 illustrated within the context of the method 3154, shown in FIG. 3(g)(9), and further including transmitting a command to display the location information (operation 3160) in accordance with some embodiments. Referring again to FIG. 1(a)(1), in some embodiments, the transmitting hardware/software/firmware 1031 may transmit a command to display the location information (operation 3160), as shown in FIG. 3(g)(10).

FIG. 3(g)(11) shows a flow diagram of a method 3162 illustrated within the context of the method 3122, shown in FIG. 3(g)(1), and further including transmitting the location information to an emergency contact (operation 3164) in accordance with some embodiments. Referring again to FIG. 1(a)(1), in some embodiments, the transmitting hardware/software/firmware 1031 may transmit the location information to an emergency contact (operation 3164), as shown in FIG. 3(g)(11). FIG. 3(g)(12) shows a flow diagram of a method 3166 illustrated within the context of the method 3162, shown in FIG. 3(g)(11), and further including transmitting a command to display the location information (operation 3168) in accordance with some embodiments. Referring again to FIG. 1(a)(1), in some embodiments, the transmitting hardware/software/firmware 1031 may transmit a command to display the location information (operation 3168), as shown in FIG. 3(g)(12).

FIG. 3(g)(13) shows a flow diagram of a method 3170 illustrated within the context of the method 3122, shown in FIG. 3(g)(1), and further including transmitting the location information to a care provider (operation 3172) in accordance with some embodiments. Referring again to FIG. 1(a)(1), in some embodiments, the transmitting hardware/software/firmware 1031 may transmit the location information to a care provider (operation 3172), as shown in FIG. 3(g)(13). FIG. 3(g)(14) shows a flow diagram of a method 3174 illustrated within the context of the method 3170, shown in FIG. 3(g)(13), and further including transmitting a command to display the location information (operation 3176) in accordance with some embodiments. Referring again to FIG. 1(a)(1), in some embodiments, the transmitting hardware/software/firmware 1031 may transmit a command to display the location information (operation 3176), as shown in FIG. 3(g)(14).

FIG. 3(g)(15) shows a flow diagram of a method 3178 illustrated within the context of the method 3122, shown in FIG. 3(g)(1), and further including transmitting the location information to a nurse (operation 3180) in accordance with some embodiments. Referring again to FIG. 1(a)(1), in some embodiments, the transmitting hardware/software/firmware 1031 may transmit the location information to a nurse (operation 3180), as shown in FIG. 3(g)(15). FIG. 3(g)(16) shows a flow diagram of a method 3182 illustrated within the context of the method 3178, shown in FIG. 3(g)(15), and further including transmitting a command to display the location information (operation 3184) in accordance with some embodiments. Referring again to FIG. 1(a)(1), in some embodiments, the transmitting hardware/software/firmware 1031 may transmit a command to display the location information (operation 3184), as shown in FIG. 3(g)(16).

FIG. 3(g)(17) shows a flow diagram of a method 3186 illustrated within the context of the method 3122, shown in FIG. 3(g)(1), and further including transmitting the location information to a physician (operation 3188) in accordance with some embodiments. Referring again to FIG. 1(a)(1), in some embodiments, the transmitting hardware/software/firmware 1031 may transmit the location information to a physician (operation 3188), as shown in FIG. 3(g)(17). FIG. 3(g)(18) shows a flow diagram of a method 3190 illustrated within the context of the method 3186, shown in FIG. 3(g)(17), and further including transmitting a command to display the location information (operation 3192) in accordance with some embodiments. Referring again to FIG. 1(a)(1), in some embodiments, the transmitting hardware/software/firmware 1031 may transmit a command to display the location information (operation 3192), as shown in FIG. 3(g)(18).

FIG. 3(g)(19) shows a flow diagram of a method 3187 illustrated within the context of the method 3122, shown in FIG. 3(g)(1), and further including transmitting the location information to an ambulance (operation 3189) in accordance with some embodiments. Referring again to FIG. 1(a)(1), in some embodiments, the transmitting hardware/software/firmware 1031 may transmit the location information to an ambulance (operation 3189), as shown in FIG. 3(g)(19). FIG. 3(g)(20) shows a flow diagram of a method 3191 illustrated within the context of the method 3187, shown in FIG. 3(g)(19), and further including transmitting a command to display the location information (operation 3193) in accordance with some embodiments. Referring again to FIG. 1(a)(1), in some embodiments, the transmitting hardware/software/firmware 1031 may transmit a command to display the location information (operation 3193), as shown in FIG. 3(g)(20).

FIG. 3(g)(21) shows a flow diagram of a method 3179 illustrated within the context of the method 3122, shown in FIG. 3(g)(1), and further including transmitting the location information to a monitoring station (operation 3181) in accordance with some embodiments. Referring again to FIG. 1(a)(1), in some embodiments, the transmitting hardware/software/firmware 1031 may transmit the location information to a monitoring station (operation 3181), as shown in FIG. 3(g)(21). FIG. 3(g)(22) shows a flow diagram of a method 3183 illustrated within the context of the method 3179, shown in FIG. 3(g)(21), and further including transmitting a command to display the location information (operation 3185) in accordance with some embodiments. Referring again to FIG. 1(a)(1), in some embodiments, the transmitting hardware/software/firmware 1031 may transmit a command to display the location information (operation 3185), as shown in FIG. 3(g)(22).

### Identifying Contact Information

The methods shown in FIG. 3(h)(1), FIG. 3(h)(2), FIG. 3(h)(3), and FIG. 3(h)(4) illustrated within the context of the method 3000, shown in FIG. 3(a)(1), further provide for processing the information to identify contact information, processing the contact information to identify an emergency contact, processing the information to form an emergency contact message, and transmitting the emergency contact message to the emergency contact.

FIG. 3(h)(1) shows a flow diagram of a method 3194 illustrated within the context of the method 3000, shown in FIG. 3(a)(1), and further including processing the information to identify contact information (operation 3196) in accordance with some embodiments. Referring again to FIG. 1(a)(1), in some embodiments, the identifying hardware/software/firmware 1030, may process the information to identify contact information (operation 3196), as shown in FIG. 3(h)(1). Contact information may include emergency contact information, such as the name of a relative, guardian, or legal representative.

FIG. 3(h)(2) shows a flow diagram of a method 3198 illustrated within the context of the method 3194, shown in FIG. 3(h)(1), and further including processing the contact information to identify an emergency contact (operation 3200) in accordance with some embodiments. Referring again to FIG. 1(a)(1), in some embodiments, the identifying hardware/software/firmware 1030, may process the contact information to identify an emergency contact (operation 3200), as shown in FIG. 3(h)(2). An emergency contact, in some embodiments, is a person designated by a patient as the person to contact in the event that the patient is considered in an emergency situation.

FIG. 3(h)(3) shows a flow diagram of a method 3202 illustrated within the context of the method 3198, shown in FIG. 3(h)(2), and further including processing the information to form an emergency contact message (operation 3204) in accordance with some embodiments. Referring again to FIG. 1(a)(1), in some embodiments, the identifying hardware/software/firmware 1030, may process the information to form an emergency contact message (operation 3204), as shown in FIG. 3(h)(3). In some embodiments, emergency contact messages alert the emergency contact to the location of a patient.

FIG. 3(h)(4) shows a flow diagram of a method 3206 illustrated within the context of the method 3202, shown in FIG. 3(h)(3), and further including transmitting the emergency contact message to the emergency contact (operation 3208) in accordance with some embodiments. Referring again to FIG. 1(a)(1), in some embodiments, the transmitting hardware/software/firmware 1031 may transmit the emergency contact message to the emergency contact (operation 3208), as shown in FIG. 3(h)(4).

### Filtering Information

The methods shown in FIG. 3(i)(1), FIG. 3(i)(2), FIG. 3(i)(3), and FIG. 3(i)(4) and FIG. 3(i)(5) illustrated in the context of the method 3000, shown in FIG. 3(a)(1), further provide for filtering information, filtering information by sensor identification information to form filtered information, filtering information by patient identifier to form filtered information, and storing, archiving or transmitting the filtered information.

FIG. 3(i)(1) shows a flow diagram of a method 3210 illustrated within the context of the method 3000, shown in FIG. 3(a)(1), and further including filtering the information (operation 3212) in accordance with some embodiments. Referring again to FIG. 1(a)(1), in some embodiments, the filtering/hardware/software/firmware 1029 may filter the information (operation 3212), as shown in FIG. 3(i)(1). Filtering may include selecting information according to some criteria. The method 3210 is not limited to a particular method of filtering or a particular criteria.

FIG. 3(i)(2) shows a flow diagram of a method 3214 illustrated within the context of the method 3210, shown in FIG. 3(i)(1), and further including filtering the information by sensor identification information to form filtered information (operation 3216) in accordance with some embodiments. Referring again to FIG. 1(a)(1), in some embodiments, the filtering/hardware/software/firmware 1029 may filter the information by sensor identification information to form filtered information (operation 3216), as shown in FIG. 3(i)(2). Filtering by sensor identification enables the identification of information associated with individual patients in a data stream that may include information associated with two or more patients.

FIG. 3(i)(3) shows a flow diagram of a method 3218 illustrated within the context of the method 3214, shown in FIG. 3(i)(2), and further including any of the operations (operation 3219) including storing the filtered information (operation 3220), archiving the filtered information (operation 3222), and transmitting the filtered information (operation 3224) in accordance with some embodiments. Referring again to FIG. 1(a)(1), in some embodiments, the filtering/hardware/software/firmware 1029 may store the filtered information (operation 3220), or archive the filtered information (operation 3222), as shown in FIG. 3(i)(3). Referring again to FIG. 1(a)(1), in some embodiments, the receiving hardware/software/firmware 1028 may transmit the filtered information (operation 3224), as shown in FIG. 3(i)(3). Exemplary data storage systems include magnetic recording systems and holographic systems. Exemplary archiving systems include optical compact disc systems and magnetic tape systems.

FIG. 3(i)(4) shows a flow diagram of a method 3226 illustrated within the context of the method 3210, shown in FIG. 3(i)(1), and further including filtering the information by a patient identifier to form filtered information (operation 3228) in accordance with some embodiments. Referring again to FIG. 1(a)(1), in some embodiments, the filtering/hardware/software/firmware 1029 may filter the information by a patient identifier to form filtered information (operation 3228), as shown in FIG. 3(i)(4).

FIG. 3(i)(5) shows a flow diagram of a method 3230 illustrated within the context of the method 3226, shown in FIG. 3(i)(4), and further including any of the operations (3231) including storing the filtered information (operation 3232), archiving the filtered information (operation 3234), and transmitting the filtered information (operation 3236) in accordance with some embodiments. Referring again to FIG. 1(a)(1), in some embodiments, the filtering/hardware/software/firmware 1029 may store the filtered information (operation 3232), or archive the filtered information (operation 3234), as shown in FIG. 3(i)(5). Referring again to FIG. 1(a)(1), in some embodiments, the receiving hardware/software/firmware 1028 may transmit the filtered information (operation 3236), as shown in FIG. 3(i)(5).

### Receiving Patient Information

The methods show in FIG. 3(j)(1), FIG. 3(j)(2), and FIG. 3(j)(3) provide for the operations of the method 3000, shown in FIG. 3(a)(1), and further provide for receiving patient care giver information, receiving nurse identification information, receiving physician identification information, receiving patient name information, tracking identification information, receiving care level identification information, receiving care-level-one identification information, receiving care-level-two identification information, and receiving care-level-three identification information.

FIG. 3(j)(1) shows a flow diagram of a method 3238 illustrated within the context of the method 3000, shown in FIG. 3(a)(1), and further including receiving patient information from at least one of the two or more wireless sensors (operation 3240), and receiving patient care giver information (operation 3242) in accordance with some embodiments. Referring again to FIG. 1(a)(1), in some embodiments, the receiving hardware/software/firmware 1028 may receive patient information from at least one of the two or more wireless sensors (operation 3240), and receive patient care giver information (operation 3242), as shown in FIG. 3(j)(1). Exemplary patient care givers include nurses, physicians, and staff attendants.

FIG. 3(j)(2) shows a flow diagram of a method 3244 illustrated within the context of the method 3238, shown in FIG. 3(j)(1), and further including any of the operations of receiving nurse identification information (operation 3246) and receiving physician identification information (operation 3248) in accordance with some embodiments. Referring again to FIG. 1(a)(1), in some embodiments, the receiving hardware/software/firmware 1028 may receive nurse identification information (operation 3246) and receive physician identification information (operation 3248), as shown in FIG. 3(j)(2). Exemplary physician or nurse identification information may include names or employee numbers.

FIG. 3(j)(3) shows a flow diagram of a method 3250 illustrated within the context of the method 3000, shown in FIG. 3(a)(1), and further including receiving patient information from at least one of two or more wireless sensors (operation 3240) wherein receiving information from at least one of two or more wireless sensors may include any of the operations of receiving patient name information (operation 3252), receiving patient tracking identification information (operation 3254), receiving patient care level identification information (operation 3256), receiving patient care-level-one identification information (operation 3258), receiving patient care-level-two identification information (operation 3260), and receiving patient care-level-three identification information (3262) in accordance with some embodiments. Referring again to FIG. 1(a)(1), in some embodiments, the receiving hardware/software/firmware 1028 may receive patient information from at least one of the two or more wireless sensors (operation 3240), may receive patient name information (operation 3252), may receive patient tracking identification information (operation 3254), may receive patient care level identification information (operation 3256), may receive patient care-level-one identification information (operation 3258), may receive patient care-level-two identification information (operation 3260), and may receive patient care-level-three identification information (3262), as shown in FIG. 3(j)(3). The care-levels may be associated with speed to which care should be delivered. For example, emergency or care-level-one may provide more rapid response to a problem alert than care-level-three.

### Receiving Hospital Information

The methods shown in FIG. 3(k)(1) and FIG. 3(k)(2) illustrated within the context of the method 3000, shown in FIG. 3(a)(1), may further include receiving patient information from at least one of two or more wireless sensors, and receiving patient hospital information including receiving hospital identification information, receiving room location information, receiving emergency waiting room location information, receiving emergency room location information, receiving surgery preparation room location information, receiving post-surgery room location information, receiving intensive care room location information, receiving neo-natal care room location information, receiving patient room location information, receiving cardiac care room location information, receiving neurological care room location information.

FIG. 3(k)(1) shows a flow diagram of a method 3264 illustrated within the context of the method 3000, shown in FIG. 3(a)(1), and further including receiving patient information from at least one of the two or more wireless sensors (operation 3240), and receiving hospital information (operation 3266) in accordance with some embodiments. Referring again to FIG. 1(a)(1), in some embodiments, the receiving hardware/software/firmware 1028 may receive patient information from at least one of the two or more wireless sensors (operation 3240), and may receive hospital information (operation 3266), as shown in FIG. 3(k)(1). Hospital information may include any information related to the hospital including but not limited to the location of services within the hospital.

FIG. 3(k)(2) shows a flow diagram of a method 3268 illustrated within the context of the method 3264, shown in FIG. 3(k)(1), wherein receiving hospital information (operation 3266) may include any of the operations of receiving hospital identification information (operation 3272), receiving room location information (operation 3274), receiving emergency waiting room location information (3276), receiving emergency room location information (operation 3278), receiving surgery preparation room location information (operation 3280), receiving post-surgery room location information (operation 3282), receiving intensive care room location information (operation 3284), receiving neo-natal care room location information (operation 3285), receiving patient room location information (operation 3286), receiving cardiac care room location information (3287), and receiving neurological care room location information (operation 3288) in accordance with some embodiments. Referring again to FIG. 1(a)(1), in some embodiments, the receiving hardware/software/firmware 1028 may receive hospital information (operation 3266) may receive hospital identification information (operation 3272), may receive room location information (operation 3274), may receive emergency waiting room location information (3276), may receive emergency room location information (operation 3278), may receive surgery preparation room location information (operation 3280), may receive post-surgery room location information (operation 3282), may receive intensive care room location information (operation 3284), may receive neo-natal care room location information (operation 3285), may receive patient room location information (operation 3286), may receive cardiac care room location information (3287), and may receive neurological care room location information (operation 3288), as shown in FIG. 3(k)(2).

### Receiving Sensor Information

FIG. 3(l)(1) shows a flow diagram of a method 3286 illustrated within the context of the method 3000, shown in FIG. 3(a)(1), and further including receiving sensor information from at least one of the two or more wireless sensors (operation 3288) in accordance with some embodiments. Referring again to FIG. 1(a)(1), in some embodiments, the receiving hardware/software/firmware 1028 may receive sensor information from at least one of the two or more wireless sensors (operation 3288), as shown in FIG. 3(l)(1). Receiving sensor information enables the monitoring and replacement of defective or degraded sensors.

FIG. 3(l)(2) shows a flow diagram of a method 3290 illustrated within the context of the method 3286, shown in FIG. 3(l)(1), wherein receiving sensor information from at least one of the two or more wireless sensors (operation 3288) may include any of the operations of receiving sensor identification information (operation 3292), and receiving sensor control information (operation 3294) in accordance with some embodiments. Referring again to FIG. 1(a)(1), in some embodiments, the receiving hardware/software/firmware 1028 may receive sensor identification information (operation 3292), and may receive sensor control information (operation 3294), as shown in FIG. 3(l)(2).

FIG. 3(l)(3) shows a flow diagram of a method 3296 illustrated within the context of the method 3290, shown in FIG. 3(l)(2), wherein receiving sensor control information (operation 3294) may include any of the operations of receiving sensor active information (operation 3298), receiving sensor inactive information (operation 3300), receiving sensor reset information (operation 3302), and receiving select sensor function information (operation 3304) in accordance with some embodiments. Referring again to FIG. 1(a)(1), in some embodiments, the receiving hardware/software/firmware 1028 may receive sensor control information (operation 3294), may receive sensor active information (operation 3298), may receive sensor inactive information (operation 3300), may receive sensor reset information (operation 3302), and may receive select sensor function information (operation 3304), as shown in FIG. 3(l)(3). Sensor function information provides information on the sensor functions available at the sensor.

FIG. 3(l)(4) shows a flow diagram of a method 3306 illustrated within the context of the method 3296, shown in FIG. 3(l)(3), wherein receiving select sensor function information (operation 3304) may include any of the operations of receiving temperature sensor selected information (operation 3306), receiving gas sensor selected information (operation 3308), and receiving heart sensor selected information (operation 3310) in accordance with some embodiments. Referring again to FIG. 1(a)(1), in some embodiments, the receiving hardware/software/firmware 1028 may receive select sensor function information (operation 3304), may receive temperature sensor selected information (operation 3306), may receive gas sensor selected information (operation 3308), and may receive heart sensor selected information (operation 3310), as shown in FIG. 3(l)(4). Other exemplary sensors suitable for use in connection with the method 3306 include neurological sensors, pulmonary sensors, gene expression sensors, and cytokine sensors. Exemplary neurological sensors include electroencephalogram sensors and intracranial pressure monitors.

### Associating Sensors

FIG. 3(m)(1) shows a flow diagram of a method 3312 illustrated within the context of the method 3000, shown in FIG. 3(a)(1), wherein receiving information from two or more wireless sensors (operation 3002) may include any of the operations of receiving the information from the two or more wireless sensors associated through proximity (operation 3314), receiving the information from the two or more wireless sensors associated through touching (operation 3316), receiving the information from the two or more wireless sensors associated through touching initiated by an attendant (operation 3318), receiving the information from the two or more wireless sensors associated through touching initiated by a person (operation 3320), receiving the information from the two or more wireless sensors associated through proximity to the patient (operation 3322), and receiving the information from the two or more wireless sensors associated through touching the patient (operation 3324) in accordance with some embodiments. Referring again to FIG. 1(a)(1), the receiving hardware/software/firmware 1028 in the processing apparatus 1004, in some embodiments, performs the receiving operations shown in FIG. 3(m)(1).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g. as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

1. A method comprising:
receiving information from two or more wireless sensors; and
identifying patient identification information included in the information.

2.-18. (canceled)

19. The method of claim 1, wherein the identifying patient identification information included in the information comprises:
identifying substantially unique biometric patient information.

20. The method of claim 19, further comprising:
identifying physiological information included in the information and associated with the patient identification information by identifying the physiological information associated with the substantially unique biometric patient information.

21.-24. (canceled)

25. The method of claim 1, further comprising:
processing the information to identify nurse information.

26. The method of claim 25, further comprising:
transmitting the nurse information wirelessly.

27. The method of claim 26, further comprising:
transmitting a command to generate an auditory signal.

28.-36. (canceled)

37. The method of claim 1, further comprising:
processing the information to identify location information.

38. The method of claim 37, further comprising:
transmitting the location information wirelessly.

39. (canceled)

40. The method of claim 38, further comprising:
transmitting a command to display the location information.

41.-62. (canceled)

63. The method of claim 1, further comprising:
filtering the information.

64. The method of claim 63, further comprising:
filtering the information by a patient identifier to form filtered information.

65. (canceled)

66. The method of claim 64, further comprising:
archiving the filtered information.

67.-104. (canceled)

105. The method of claim 1, wherein the receiving information from two or more wireless sensors comprises:
receiving the information from the two or more wireless sensors associated through touching.

106. (canceled)

107. The method of claim 1, wherein the receiving information from two or more wireless sensors comprises:
receiving the information from the two or more wireless sensors associated through touching initiated by a person.

108.-109. (canceled)

110. A method comprising:
associating two or more wireless sensors with a patient;
sensing physiological information with one or more of the two or more wireless sensors; and
transmitting the physiological information.

111. The method of claim 110, wherein the associating two or more wireless sensors with a patient comprises:
transmitting sensor identification information;
receiving a retransmission of the sensor identification information at one or more of the two or more wireless sensors; and
receiving information associated with the patient.

112. The method of claim 110, wherein the associating two or more wireless sensors with a patient comprises:
receiving information to personalize one or more of the two or more wireless sensors.

113.-153. (canceled)

154. The method of claim 110, further comprising:
receiving current location information; and transmitting the current location information.

155.-157. (canceled)

158. The method of claim 110, further comprising:
transmitting sensor information.

159.-161. (canceled)

162. The method of claim 158, wherein the transmitting sensor information comprises:
transmitting sensor status information.

163. The method of claim 162, wherein the transmitting sensor status information comprises:
transmitting sensor error rate information.

164. (canceled)

165. The method of claim 162, wherein the transmitting sensor status information comprises:
transmitting sensor out of service information.

166.-167. (canceled)

168. An apparatus comprising:
means for associating two or more wireless sensors with a patient;
means for sensing physiological information with one or more of the two or more wireless sensors; and
means for transmitting the physiological information.

169. The apparatus of claim 168, wherein the means for associating two or more wireless sensors with a patient comprises:
means for transmitting sensor identification information;
means for receiving a retransmission of the sensor identification information at the one or more of the two or more wireless sensors; and
means for receiving information associated with the patient.

170. The apparatus of claim 168, wherein the means for associating two or more wireless sensors with a patient comprises:
means for receiving information to personalize one or more of the two or more wireless sensors.

171. The apparatus of claim 170, wherein the means for receiving information to personalize one or more of the two or more wireless sensors comprises:
means for receiving information to enable a particular sensor function for the patient.

172. The apparatus of claim 168, wherein the means for transmitting the physiological information comprises:
means for transmitting the physiological information substantially continuously.

173.-174. (canceled)
